(19) United States
(12) Patent Application Publication
(10) Pub. No.: US 2007/0174041 A1
(43) Pub. Date: Jul. 26, 2007

(54) Method and system for concept generation and management

(76) Inventor: Ryan Yeske, Vancover, British Columbia (CA)

Correspondence Address: Robert E Krebs;Thelen Reid & Priest, P O Box 640640, San Jose, CA, 95164-0640, US

(21) Appl. No.: 10/555,126

(22) PCT Filed: Apr. 30, 2004
(86) PCT No.: PCT/CA04/00645

§ 371 Date: Jan. 19, 2007

Related U.S. Application Data
(60) Provisional application No. 60/466,778, filed on May 1, 2003.

(51) Int. Cl. G06F 17/28

(52) U.S. Cl. 704/3

(57) ABSTRACT

The present invention is in two parts. The first part is manual, semi-automatic, and automatic methods and a system for generating concepts. The second part is a method and system for the management of concepts. Such concepts (lower case c) are linguistics-based patterns or set of patterns. Each pattern comprises other patterns, concepts, and linguistic entities of various kinds, and operations on or between those patterns, concepts, and linguistic entities. The present invention improves upon the notion of Concepts as defined within the Concept Specification Language (CSL) of PCT Application No. WO 02/27524 by Fass et al. (2001). CSL Concepts are linguistics-based Patterns or set of Patterns. Each Pattern comprises other Patterns, Concepts, and linguistic entities of various kinds, and Operations on or between those Patterns, Concepts, and linguistic entities. Central to the first part of the invention are notions of a “User concept Description” (UcD), User Concept Description (UCD), “concept wizard,” and “Concept wizard.” UcDs and UCDs are representations of what is used to generate a concept or Concept, including, but not limited to, knowledge sources used as the basis of generation, the data model used to control generation, and instructions (Directives) governing generation. The concept wizards and Concept wizards are tools for navigating users through concept and Concept generation.

### CROSS-REFERENCE TO RELATED APPLICATIONS

This application claims the benefit of U.S. Provisional Patent Application No. 60/466,778 filed May 1, 2003 which is hereby incorporated by reference.

### BIBLIOGRAPHY

### U.S. Patent Documents

U.S. Pat. No. 5,796,926 8/1998 Huffman . . . 359/77

U.S. Pat. No 5,841,895 11/1998 Huffman . . . 382/15

### PCT Applications

Fass, Dan, Davide Turcato, Gordon Tisher, Devlan Nicholson, Milan Mosny, Fred Popowich, Janine Toole, Paul McFetridge, and Fred Kroon (2001). A Method and System for Describing and Identifying Concepts in Natural Language Text for Information Retrieval and Processing. Assignee: Axonwave Software (formerly Gavagai Technology Incorporated), Burnaby, B.C., Canada. PCT application filed 28 Sep. 2001. PCT Application No. WO 02/27524.

Turcato, Davide, Fred Popowich, Janine Toole, Dan Fass, Devlan Nicholson, and Gordon Tisher (2001). A Method and System for Adapting Synonym Resources to Specific Domains. Assignee: Axonwave Software (formerly Gavagai Technology Incorporated), Burnaby, B.C., Canada. PCT application filed 28 Sep. 2001. PCT Application No. WO 02/27538.

### Other Publications

Brill, E., “A Corpus-Based Approach to Language Learning,” PhD. Dissertation, Department of Computer and Information Science, University of Pennsylvania, Philadelphia, Pa. (1993a).

Brill, E., “Transformation-Based Error-Driven Parsing,” In Proceedings of the Third International Workshop on Parsing Technologies. Tilburg, The Netherlands (1993b).

Daelemans, W., S. Buchholz, and J. Veenstra, “Memory-Based Shallow Parsing,” In Proceedings of the Computational Natural Language Learning (CoNLL-99) Workshop, Bergen, Norway, 12 Jun. 1999 (1999).

Gavagai Technology, “Gavagai Content Intelligence System Version 2.0 Developer's Guide.” Gavagai Technology Inc., Burnaby, BC, Canada, November 2002 (2002).

van Harmelen, F., and A. Bundy, “Explanation-Based Generalization=Partial Evaluation (Research Note),” Artificial Intelligence, 36, pp. 401-412 (1988).

Joachims, T., “Text Categorization with Support Vector Machines: Learning with Many Relevant Features,” In Proceedings of the European Conference on Machine Learning, pp. 137-142 (1998).

Kim, J.-T., and D. I. Moldovan, “Acquisition of Linguistic Patterns for Knowledge-Based Information Extraction,” IEEE Transactions on Knowledge and Data Engineering, 7 (5), pp. 713-724 (October 1995).

Kwok, J. T., “Automated Text Categorization Using Support Vector Machine,” In Proceedings of the International Conference on Neural Information Processing (ICONIP), Kitakyushu, Japan, pp. 347-351 (October 1998).

Schlimmer, J. C., and P. Langley, “Learning, Machine,” In S. C. Shapiro (Ed.) Encyclopedia of Artificial Intelligence, 2^{nd} Edition. John Wiley & Sons, New York, N.Y., pp. 785-805 (1992).

Weston, J., and C. Watkins, “Support Vector Machines for Multi-Class Pattern Recognition,” In Proceedings of 7th European Symposium on Artificial Neural Networks (ESANN '99), Bruges, Belgium (1999).

### BACKGROUND TO THE INVENTION

The first part of the invention is concerned with an aspect of the knowledge acquisition bottleneck for knowledge-based systems that process text. The concern of this part of the invention is one particular kind of knowledge that needs to be acquired: concepts and Concepts. Such concepts (lower case c) are linguistics-based patterns or set of patterns. Each pattern comprises other patterns, concepts, and linguistic entities of various kinds, and operations on or between those patterns, concepts, and linguistic entities.

The present invention improves upon the notion of Concepts as defined within the Concept Specification Language (CSL) of PCT Application No. WO 02/27524 by Fass et al. (2001), which is hereby incorporated by reference. CSL Concepts are linguistics-based Patterns or set of Patterns. Each Pattern comprises other Patterns, Concepts, and linguistic entities of various kinds, and Operations on or between those Patterns, Concepts, and linguistic entities.

The first part of the present invention is thus concerned with the field of machine learning/knowledge acquisition. A brief literature review of that field is provided below.

The present invention also addresses the problem of managing concepts. It is possible to employ ideas about editing and database management when managing concepts.

Both parts of the present invention make use of parts of PCT Application No. WO 02/27524 by Fass et al. (2001), for example, including but not limited to the parts on the identification of concepts and Concepts, which are hereby incorporated by reference.

1. Machine Learning/Knowledge Acquisition

Machine learning (ML) refers to the automated acquisition of knowledge, especially domain-specific knowledge (cf. Schlimmer & Langley, 1992, p. 785). In the context of the present invention, ML concerns learning concepts and Concepts.

One system related to the present invention is Riloff's (1993) AutoSlog, a knowledge acquisition tool that uses a training corpus to generate proposed extraction patterns for the CIRCUS extraction system. A user either verifies or rejects each proposed pattern (from Huffman, 1998, U.S. Pat. No. 5,841,895).

J.-T. Kim and D. Moldovan's (1995) PALKA system is a ML system that learns extraction patterns from example texts. The patterns are built using a fixed set of linguistic rules and relationships. Kim and Moldovan do not suggest how to learn syntactic relationships that can be used within extraction patterns learned from example texts (from Huffman, 1998, U.S. Pat. No. 5,841,895).

In Transformation-Based Error-Driven Learning (Brill, 1993a), the algorithm works by beginning in a naive state about the knowledge to be learned. For instance, in tagging, the initial state can be created by assigning each word its most likely tag, estimated by examining a tagged corpus, without regard to context. Then the results of tagging in the current state of knowledge are repeatedly compared to a manually tagged training corpus and a set of ordered transformations is learnt, which can be applied to reduce tagging errors. The learned transformations are drawn from a pre-defined list of allowable transformation templates. The approach has been applied to a number of other NLP tasks, most notably parsing (Brill, 1993b).

The Memory-Based Learning approach is “a classification based, supervised learning approach: a memory-based learning algorithm constructs a classifier for a task by storing a set of examples. Each example associates a feature vector (the problem description) with one of a finite number of classes (the solution). Given a new feature vector, the classifier extrapolates its class from those of the most similar feature vectors in memory” (Daelemans et al., 1999).

Explanation-Based Learning is “a technique to formulate general concepts on the basis of a specific training example” (van Harmelen & Bundy, 1988). A single training example is analyzed in terms of knowledge about the domain and the goal concept under study. The explanation of why the training example is an instance of the goal concept is then used as the basis for formulating the general concept definition by generalizing this explanation.

The patents by Huffman (1998, U.S. Pat. No. 5,796,926 and U.S. Pat. No. 5,841,895) describe methods for automatic learning of syntactic/grammatical patterns for an information extraction system. The present invention also describes methods for automatically learning linguistic information (including syntactic/grammatical information) as part of concept and Concept generation, but not in ways described by Huffman.

### SUMMARY OF THE INVENTION

The present invention is in two parts. Broadly, the first part relates to the generation of concepts, the second part relates to the management of concepts. Such concepts (lower case c) are linguistics-based patterns or set of patterns. Each pattern comprises other patterns, concepts, and linguistic entities of various kinds, and operations on or between those patterns, concepts, and linguistic entities.

PCT Application No. WO 02/27524 was filed in September 2001 (Fass et al., 2001) for a method and system for describing and identifying concepts in natural language text for information retrieval and other applications, which included a description of a particular kind of “concept” (lower case c), called a Concept (upper case C), which is part of a proprietary Concept Specification Language (CSL). The present invention improves upon the notion of CSL Concepts as defined in that PCT application.

The two parts of the present invention apply not only to the proprietary Concepts and CSL, but also to the more general idea of “concepts” as defined above (and elsewhere in this disclosure), as part of a “concept specification language” (defined elsewhere in this disclosure) that is more general than CSL.

Because CSL Concepts contain detailed linguistic information, they can provide more advanced linguistic analysis (and as such are capable of much higher precision and reliability) than approaches using less linguistic information. To demonstrate the superiority of the CSL approach, CSL Concepts can be specified for both car theft and theft from a car. Approaches using less linguistic information might be able to search for the words car and theft (possibly including synonyms of those words), but could not correctly identify the text fragment My vehicle was stolen as matching the former Concept, and the text fragment Somebody stole CDs from my car as matching the latter. However, the CSL approach can specify the different relationships between the words car and theft in the above fragments, correctly distinguishing the two cases.

The key to the generation of concepts and Concepts are the ideas of a User concept Description (UcD) and User Concept Description (UCD). UcDs and UCDs are representations of what is used to generate a concept or Concept respectively, including:
knowledge sources used as the basis of generation (learning);
the data model used to control generation; and
instructions or Directives governing the generation of the concept or Concept.

The knowledge sources include, but are not limited to, various forms of text, linguistic information (such as, but not limited to, syntactic and semantic information), elements of concept specification languages and CSL, and statistical information.

The data models put together information from the knowledge sources to produce concepts or Concepts. The data models include statistical models and rule-based models. Rule-based data models include linguistic and logical models.

The instructions or Directives governing generation include, but are not limited to:
whether matches of the concept or Concept against text should be “visible”;
the number of matches of a concept required in a document for those document to be returned;
the name of the concept or Concept that is generated;
the name of the file into which that concept or Concept is written; and

whether that file should be encrypted or not.

TABLE 1
Types of UcD and UCD.

| | | | |
|---|---|---|---|
| Basic | (1) | Basic UcD/UCD | Data structure used to define |
| | | | (2) and (3) |
| Unpopulated | (2) | Knowledge-source | Example: text-based UcD |
| types | | based UcD/UCD | (associated with various |
| | | | data models) |
| | (3) | Data-model based | Example: logical UCD |
| | | UcD/UCD | (associated with various |
| | | | knowledge sources) |
| Populated | (4) | Knowledge-source | Version of (2) with filled-in |
| types | | based UcD/UCD | information |
| | (5) | Data-model based | Version of (3) with filled-in |
| | | Ucd/UCD | information |

The present invention distinguishes a number of types of UcDs and UCDs. A first distinction, as shown in Table 1, is between (1) basic UcDs and UCDs, (2) and (3) unpopulated types of the basic UcDs and UCDs, and (4) and (5) populated versions of the unpopulated types. The basic UCD encapsulates functionality common to the various other types of UCD (the relationship between a basic UcD and its types is the same relationship as that between a basic UCD and its types).

The unpopulated types include, but are not limited to, knowledge-source based or data-model based types. Knowledge-source based types are based on various forms of text (e.g., vocabulary, text fragments, documents), linguistic information (e.g., grammar items, grammars, semantic entities), and elements of concept specification languages and CSL (e.g., Operators used in CSL, CSL Concepts). For example, knowledge-source based UcDs and UCDs include vocabulary-based UcDs and UCDs, text-based UcDs and UCDs, and document-based UcDs and UCDs. The text-based UCD, for example, uses text fragments (and key relevant words from those fragments) to generate a Concept.

The present method and system allows users to create their own concepts and Concepts using various methods. One such method is a knowledge-source based method, known as text-based concept or Concept generation (or creation), which generates concepts or Concepts from text fragments. For example, the CSL Concept of CarTheft can be defined by entering the text fragment Somebody stole his vehicle, highlighting the words stole and vehicle as relevant for the Concept, and offering the user the option of selecting synonyms (and other lexically related terms) of the relevant words.

The first part of the present method and system, therefore, is (1) a method and system for the generation of concepts (as part of a concept specification language) and (2) a method and system for the generation of Concepts (in CSL). The methods and systems include methods and systems for the input as well as the generation of concepts and Concepts, An element in input and generation is either (1) concepts and UcDs or (2) Concepts and UCDs. Also included on the input side is a concept wizard (and also a Concept wizard) for navigating users through concept and Concept generation.

The first part of the invention, then, is concerned with an aspect of the knowledge acquisition bottleneck for knowledge-based systems that process text, where one kind of knowledge that needs to be acquired is concepts and Concepts. The management of concepts and Concepts is a related issue that comes about when the knowledge acquisition bottleneck for concepts and Concepts is eased.

A further feature which is an element of the second part is that of a User concept Group (UcG) and, correspondingly, a User Concept Group (UCG). UcGs are a control structure that can group and name a set of concepts (UCGs do the same but for Concepts). Also available to users are hierarchies of concepts, hierarchies of Concepts, and also hierarchies of the following: UcDs, UCDs, UcGs, and UCGs. The hierarchy of UCDs, which receives special attention in the invention, is known as a UCD graph (the hierarchy of UcDs is known as a UcD graph).

The management of concepts and Concepts is, in fact, the management of
(1) concepts, UcDs, UcGs, and hierarchies of those three entities (concepts, UcDs, UcGs); and
(2) Concepts, UCDs, UCGs, and hierarchies of those three entities (Concepts, UCDs, UCGs).

Management devolves in turn into methods for keeping track of changes and enforcing integrity constraints and dependencies when new concepts, hierarchies, UcDs, UcGs, Concepts, UCDs, or UCGs are generated or when any of the preceding are revised. (Revision can occur when additional generation of concepts or Concepts is performed or when users do editing.)

The second part of the present system and method, then, is (1) a method and system for the management of concepts and associated representations (including, but not limited to, UcDs, UcGs, and hierarchies of those entities) optionally within a concept specification language and (2) a method and system for the management of Concepts and associated representations (in CSL).

### BRIEF DESCRIPTION OF THE DRAWINGS

FIG. 1 is a hardware client-server block diagram showing an apparatus according to the invention;

FIG. 2 is a hardware client-server farm block diagram showing an apparatus according to the invention;

FIG. 3 shows the Concept processing engine shown in FIGS. 1 and 2;

FIG. 4 shows a graph of UCDs;

FIG. 5 shows the syntactic structure of The dog barks loudly;

FIG. 6 shows the interaction between the Concept wizard display and graph of UCDs optionally stored in the Concept database;

FIG. 7 shows the entering of sentences or text fragments that contain a desired Concept;

FIG. 8 shows the selecting of relevant words from a sentence;

FIG. 9 shows the selecting of synonyms, hypernyms, and hyponyms for relevant words;

FIG. 10 shows the selecting of Concept generation Directives;

FIG. 11 shows the PressureIncrease Concept;

FIG. 12 shows the results returned by the example maker;

FIG. 13 shows the “New Rule [Pattern]” pop-up window with Create tab selected;

FIG. 14 shows the Create panel for new Team Rule;

FIG. 15 shows the Advanced pop-up window for synonyms of team;

FIG. 16 shows the Team Rule [Pattern] available for matching;

FIG. 17 shows the Learn tab for creating rule from The DragonNet team has recently finished testing;

FIG. 18 shows the Learn Wizard for words in The DragonNet team has recently finished testing;

FIG. 19 shows the Learn Wizard for synonyms of words in The DragonNet team has recently finished testing;

FIG. 20 shows the Learn Wizard Examples window;

FIG. 21 shows the Team2 Rule [Pattern] available for matching;

FIG. 22 shows the “New Rule [Pattern]” pop-up window;

FIG. 23 shows the “Insert Concept” pop-up window;

FIG. 24 shows the “Save Concept” pop-up window;

FIG. 25 shows the “Open Concept” pop-up window;

FIG. 26 shows the Synonyms tab of the “Refine Words, Phrases, and Concepts” pop-up window;

FIG. 27 shows the Negation/Tense/Role tab of the “Refine Words, Phrases, and Concepts” pop-up window; and

FIG. 28 shows the Multiple matches tab of the “Refine Words, Phrases, and Concepts” pop-up window.

### DESCRIPTION

The present invention is described in two sections. Two versions of a method for concept generation and management are described in Section 1. Two versions of a system for concept generation and management are described in Section 2. One system uses the first method of Section 1; the second system uses the second method. The preferred embodiment of the present invention is the second system.

Note that the lowercase terms (‘concepts’, ‘patterns’, and the like) describe the ideas and data structures that are part of the invention, and the preferred embodiment of the invention is implemented in CSL and is described using similar terms wherein such terms are capitalized (‘Concepts’, ‘Patterns’, and the like) when they represent these ideas and data structures implemented using CSL.

Note also that in this document the word ‘includes’ means “includes but not limited to”.

1. Method

Two methods for concept and Concept generation and management are described. The first method uses concepts in general within concept specification languages in general and text markup languages in general (though it can use concept specification languages on their own, without need for text markup languages). A concept specification language is any language for representing concepts. A text markup language is any language for representing text. Example markup languages include SGML and HTML.

The second method uses a specific, proprietary concept specification language called CSL and a type of text markup language called TML (short for Text Markup Language), (though it can use CSL on its own, without need for TML). CSL includes Concepts (upper case c, to distinguish them from the more general “concepts,” written with a lower case c). Both methods can be performed on a computer system or other systems or by other techniques or by other apparatus.

Note that the text in documents and other text-forms that is used to generate a Concept (or concept) is usually different from the text in documents and other text-forms used for Concept (or concept) identification with that same generated Concept (or concept). However, especially when testing a newly-generated Concept (or concept), the very same text may well be used for generating a Concept (or concept) as for Concept (or concept) identification with that very same, newly-generated Concept (or concept).

1.1. Method Using Concepts, Concept Specification Languages, and (Optionally) Text Markup Languages

The first method uses concepts in general within specification languages in general and text markup languages in general (though it can use concept specification languages on their own, without need for text markup languages). The method is for manually, semi-automatically, and automatically learning (generating) the concepts of the concept specification language, where the concepts to be generated contain elements (parts) including, but not limited to, patterns, other concepts, and linguistic entities of various kinds, and operations on or between those patterns, concepts, and linguistic entities of various kinds.

The method of the present disclosure is in two parts: a method for generating concepts and a method for managing concepts.

1.1.1. Method for Generating Concepts

The method for generating concepts uses User concept Descriptions (UcDs). UcDs are representations of what is used to generate a concept, including
knowledge sources used as the basis of generation (learning);
data model used to control generation; and
instructions governing the generation of the concept.

The knowledge sources include various forms of text, linguistic information (such as, but not limited to, syntactic and semantic information), elements of concept specification languages, and statistical information (including word frequency information).

The data models put together information from the knowledge sources to produce concepts. The data models include statistical models, rule-based models, and hybrid statistical/rule-based models. Rule-based data models include linguistic and logical models.

The instructions include whether successful matches of the concept against text are “visible”; the number of matches of a concept required in a document for that document to be returned; the name of the concept that is generated, the name of the file into which that concept is written, and whether or not that file is encrypted.

The present invention distinguishes a number of types of UcDs and UCDs. Table 1 shows a distinction between (1) basic UcDs, (2) and (3) unpopulated types of the basic UcDs, and (4) and (5) populated versions of the unpopulated ones. The basic UcD encapsulates functionality common to the various types of UcD.

The unpopulated types include knowledge-source based or data-model based types. Knowledge-source based types are based on, though not limited to, various forms of text (e.g., vocabulary, text fragments, documents), linguistic information (e.g., grammar items, grammars, semantic entities), elements of concept specification languages, and statistical information (such as word frequency). For example, Knowledge-source based UcDs include vocabulary-based UcDs, text-based UcDs, and document-based UcDs. The text-based UcD, for example, uses text fragments (and key relevant words from those fragments) to generate a concept.

The method includes methods for the input as well as the generation of concepts. An element in input and generation is concepts and UcDs. An original method on the input side is that of a concept wizard for navigating users through concept generation.

1.1.2. Method for Managing Concepts

The management of concepts is, in fact, the management of concepts, UcDs, UcGs, and hierarchies of those entities (concepts, UcDs, UcGs). Management devolves in turn into methods for keeping track of changes and enforcing integrity constraints and dependencies when new concepts, UcDs, UcGs, and hierarchies of those entities are generated or revised. Revision can occur when additional learning is performed or when users do editing.)

The method matches text in documents and other text-forms against descriptions of concepts; manually, semi-manually, and automatically generates descriptions of concepts; and manages concepts and changes to them (operations such as adding new concepts, and modifying and deleting existing ones). The method thus includes steps for:
(1) concept identification;
(2) concept generation; and
(3) concept management.

A separate step, not to do with the manipulation of concepts but used by steps (1) and (2), is:
(4) synonym processing.

Steps (2) and (3) have already been described in this section. Steps (1) and (4) will be described in more detail below.

1.1.3. Method for Identifying Concepts

Step (1), concept identification, takes as input various data models and knowledge sources. The data models put together information from the knowledge sources to produce concepts. The data models for concept identification include statistical models, rule-based models, and hybrid statistical/rule-based models. Rule-based data models include linguistic and logical models.

Step (1) comprises various substeps. If a linguistic data model is used, then these substeps include step (1.1) which is the identification of linguistic entities in the text of documents and other text-forms. The linguistic entities identified in step (1.1) include morphological, syntactic, and semantic entities. The identification of linguistic entities in step (1.1) includes identifying words and phrases, and establishing dependencies between words and phrases. The identification of linguistic entities is accomplished (in a linguistic data model) by methods including, but not limited to, one or more of the following: preprocessing, tagging, and parsing.

Step (1.2), which is independent of any particular data model, is the annotation of those identified linguistic entities from step (1.1) in, but not limited to, a text markup language, to produce linguistically annotated documents and other text-forms. The process of annotating the identified linguistic entities from step (1.1) is known as linguistic annotation.

Step (1.3), which is optional, is the storage of these linguistically annotated documents and other text-forms.

Step (1.4)—the central step—is the identification of concepts using linguistic information, where those concepts are represented in a concept specification language and the concepts-to-be-identified occur in one of the following forms:
text of documents and other text-forms in which linguistic entities have been identified as per step (1.1); or
the linguistically annotated documents and other text-forms of step (1.2); or
the stored linguistically annotated documents and other text-forms of step (1.3).

A concept specification language allows concepts to be defined for concepts in terms of a linguistics-based pattern or set of patterns. Each pattern comprises other patterns, concepts, and linguistic entities of various kinds (such as words, phrases, and synonyms), and operations on or between those patterns, concepts, and linguistic entities. For example, the concept HighWorkload is linguistically expressed by the phrase high workload. In a concept specification language, patterns can be written that look for the occurrence of high and workload in particular syntactic relations (e.g., workload as the subject of be high; or high and workload as elements of the nominal phrase, e.g., a high but not unmanageable workload). Expressions can also be written that seek not just the words high and workload, but also their synonyms. More will be said about concepts and concept specification languages in Section 1.1.5.

Such concepts are identified by matching linguistics-based patterns in a concept specification language against linguistically annotated texts. A linguistics-based pattern from a concept specification language is a partial representation of linguistic structure. Any time a linguistics-based pattern matches a linguistic structure in a linguistically annotated text, the portion of text covered by that linguistic structure is considered an instance of the concept.

Detailed methods for identifying concepts using a linguistic model are described in Fass et al. (2001).

Step (1.5), which is independent of any particular data model, is the annotation of the concepts identified in step (1.4), e.g., concepts like HighWorkload, to produce conceptually annotated documents and other text-forms. (These conceptually annotated documents are also sometimes referred to in this description as simply “annotated documents.”) The process of annotating the identified concepts from step (5) is known as conceptual annotation. As with step (1.2), conceptual annotation is in, but is not limited to, a text markup language.

Step (1.6), which is optional, like step (1.3), is the storage of these conceptually annotated documents and other text-forms.

1.1.4. Method for Synonym Processing with Concepts

A step that is independent of steps (1)-(3) is the step of (4) synonym processing. Synonym processing in turn comprises the substeps of (4.1) synonym processing and (4.2) synonym optimization is described in PCT Application No. WO 02/27538 by Turcato et al. (2001), which is hereby incorporated by reference. This synonym processing step produces a processed synonym resource, which is used as a knowledge source by the concept identification and concept generation steps (steps 1 and 2).

1.1.5. More on Concepts and Concept Specification Languages

The concept specification languages that are within the scope of this invention are those that comprise concepts, patterns, and instructions. A concept in these languages is used to represent any idea, or physical or abstract entity, or relationship between ideas and entities, or property of ideas or entities. The concepts contain patterns. Those patterns in various ways are matchable to zero or more “extents,” where each extent may in turn contain instances of one or more linguistic entities of various kinds. Linguistic entities include, but are not limited to: morphemes; words or phrases; synonyms, hypernyms, and hyponyms of those words or phrases; syntactic constituents and subconstituents; and any expression in a linguistic notation used to represent phonological, morphological, syntactic, semantic, or pragmatic-level descriptions of text.

These linguistic entities are identified in either the text of documents and other text-forms, or in knowledge resources (such as WordNet™ and repositories of concepts), or both. When identified in the text of documents and other text-forms, linguistic entities may be found before concept matching (for example, in producing a linguistically annotated text) or during concept matching (i.e., the concept matcher searches for linguistic entities on as as-needed basis). When a linguistic entity is identified from the aforementioned text of documents and other text-forms, then a record is made that the linguistic entity starts in one position within that text and ends in a second position.

Patterns can be of various types including, but not limited to, the following types. A first type comprises a description sufficiently constrained to be matchable to zero or more extents, where each of the extents comprises a set of zero or more items. Each of those items is an instance of a linguistic entity. Each of those instances of a linguistic entity is identified in either
a) text, or
b) a knowledge resource; or
c) both a) and b).

This first pattern is matchable to zero or more of the extents corresponding to the aforementioned description.

A second type of pattern comprises an operator and a list of zero or more arguments in which each of the arguments is a further pattern. This second pattern is matchable to extents that are the result of applying the operator to the extents that are matchable by the arguments in the list of zero or more arguments.

The operators express information including, but not limited to, linguistic information and concept match information. Linguistic information includes punctuation, morphology, syntax, semantics, logical (Boolean), and pragmatics information. The operators have from zero to an unlimited number of arguments.

The zero-argument operators express information including, but not limited to:
a) match information such as NIL,
b) syntax information such as punctuation, comma, beginning of phrase, end of phrase,
c) semantic information such as thing, person, organization, number, currency.

The one argument operators express information including, but not limited to:
a) match information such as smallest_extent(X), largest_extent(X), show_matches(X), hide_matches(X), number_of_matches_required(X),
b) tense such as past(X), present(X), future(X),
c) syntactic categories such as adjective (X) and noun_phrase(X),
d) Boolean relations such as Not(X),
e) lexical relations such as synonym(X), hyponym(X), hypernym(X), and
f) semantic categories such as object(X), does_not_contain(X).

The two argument operators express information including, but not limited to:
a) relationships within and across sentences such as in_same_sentence_with(X,Y),
b) syntactic relationships such as immediately_precedes(X,Y), immediately_dominates(X,Y), nonimmediately_precedes(X,Y), nonimmediately_dominates(X,Y),
c) syntactic relationships such as noun_verb(X,Y), subj_verb(X,Y), verb_obj(X,Y),
d) Boolean relations such as AND, OR, and
e) semantic relationships such as associated_with(X,Y), related(X,Y), modifies(X,Y), cause_and_effect(X,Y), commences(X,Y), terminates(X,Y), obtains(X,Y), thinks_or_says(X,Y).

Example three-argument operators include, but are not limited to, noun_verb_noun(X,Y,Z), subj_verb_obj(X,Y,Z), subj_passive_verb_obj(X,Y,Z).

Three of the two-argument operators are defined below. For the operator nonimmediately_dominates(X,Y):
a) X matches any extent;
b) Y matches any extent; and
c) the result is the extent matched by Y if each of the linguistic entities of Y's extent are a subconstituent of all linguistic entities of X's extent.

The operator nonimmediately dominates(X,Y) can be “wide-matched.” In that wide-matching
a) X matches any extent;
b) Y matches any extent; and
c) the result is the extent matched by X if all the linguistic entities of Y's extent are subconstituents of all the linguistic entities of X's extent.

For the operator nonimmediately_precedes(X,Y):
a) X matches any extent;
b) Y matches any extent, and
c) the result is an extent that covers the extent matched by Y and an extent matched by X if the extent matched by X precedes the extent matched by Y.

A third type of pattern includes, but is not limited to, two subtypes. One subtype comprises a reference to a further concept comprising a further pattern. This first subtype of the third pattern is matchable to extents that are matchable by that further pattern.

A second subtype of this pattern comprises
a) a reference to a further concept comprising a further pattern and
b) a list of zero or more arguments in which each of the arguments comprise a further pattern.

This second subtype of the third pattern is matchable to extents that are matchable by the further pattern in the further concept, where any parameters in that further concept are bound to those patterns that are part of the list of zero or more arguments.

A fourth type of pattern comprises a parameter that is matchable to extents matched by any pattern that is bound to that parameter. (Any pattern may be bound to a parameter.)

An instruction is a property of a concept. Instructions of concepts include, but are not limited to:
a) whether successful matches of the concept against text are “visible”;
b) the number of matches of a concept required in a document for that document to be returned;
c) the name of the concept that is being generated;
d) the name of the file into which that concept is written; or
e) whether or not that file is encrypted.

Combinations of instructions are also possible.

More about concepts and their elements (patterns and instructions, extents, linguistic entities, operators, etc.) can be learned by relating the description of CSL Concepts and their elements (patterns and instructions) in Section 3 to the description of concepts and their elements that has been provided here.

1.2 Method Using Concepts within CSL and (Optionally) TML

The second method uses a specific, proprietary concept specification language called CSL and a type of text markup language called TML (short for Text Markup Language), though it can use CSL on its own, without need for TML. That is to say, the method necessarily uses CSL, but does not necessarily require the use of TML.

CSL is a language for expressing linguistically-based patterns. CSL was described in Fass et al. (2001). It is summarized briefly here and described at some length in Section 3 because of improvements to CSL described herein.

CSL comprises Concepts, Patterns, and Directives. A Concept in CSL is used to represent any idea, or physical or abstract entity, or relationship between ideas and entities, or property of ideas or entities. Concepts contain Patterns (and other elements described in Section 3, but mentioned briefly below). Those Patterns are in various ways are matchable to zero or more “extents,” where each extent may in turn contain instances of one or more linguistic entities of various kinds (see Section 3 for more on the relationship between extents and linguistic entities). Linguistic entities include, but are not limited to: morphemes; words or phrases; synonyms, hypernyms, and hyponyms of those words or phrases; syntactic constituents and subconstituents; and any expression in a linguistic notation used to represent phonological, morphological, syntactic, semantic, or pragmatic-level descriptions of text.

These linguistic entities are identified in either the text of documents and other text-forms, or in knowledge resources (such as WordNet™ and repositories of Concepts), or both. When identified in the text of documents and other text-forms, linguistic entities may be found before Concept matching (for example, in producing a linguistically annotated text) or during Concept matching (i.e., the Concept matcher searches for linguistic entities on as as-needed basis). When a linguistic entity is identified from the aforementioned text of documents and other text-forms, then a record is made that the linguistic entity starts in one position within that text and ends in a second position.

Patterns can be of various types: Basic Patterns, Operator Patterns, Concept Calls, and Parameters (there is implicitly a grammar of Patterns). A Basic Pattern contains a description sufficiently constrained to be matchable to zero or more of the extents corresponding to that description.

An Operator Pattern contains an Operator and a list of zero or more Arguments where each of those Arguments is itself a Pattern. The Operator Pattern is matchable to extents that are the result of applying the Operator to those extents that are matchable by the Arguments.

Operators express information including, but not limited to, linguistic information and Concept match information. Linguistic information includes punctuation, morphology, syntax, semantics, logical (Boolean), and pragmatics information. Operators have from zero to an unlimited number of arguments. Common zero-Argument Operators expressing information include but are not limited to Comma, Beginning_of_Phrase, End_of_Phrase, Thing, and Person. Common one-Argument Operators include Show_Matches(X), Hide_Matches(X), Noun_Phrase(X), NOT(X), and Synonym(X). Common two-Argument Operators include Immediately_Precedes(X,Y), NonImmediately_Dominates(X,Y), Noun_Verb(X,Y), Subj_Verb(X,Y), AND(X,Y), OR(X,Y), Associated_With(X,Y), Related(X,Y), and Modifies(X,Y). An example three-Argument Operator is Subj_Verb_Obj(X,Y,Z).

A third type of Pattern is a Concept Call. A Concept Call can be of several types, including but not limited to, a Concept Call contains a reference to a Concept. In such a case, the Concept Call is matchable to the extents that are matchable by that Pattern. A second form of Concept Call contains a reference to a Concept, and also contains a list of zero or more Arguments, where each of those Arguments is a Pattern. In this case, a Concept Call is matchable to the extents that are matchable by the Pattern of the referenced Concept, where any Parameters in the referenced Concept are bound to the Patterns in the list of zero or more Arguments that were part of the Concept Call.

A fourth type of Pattern is a Parameter. A Parameter is matchable to the extents matched by any Pattern that is bound to that Parameter (any Pattern can be bound to a Parameter).

A more comprehensive and authoritative description of CSL can be found in Section 3.

TML is described in section 1.2. of Fass et al (2001) and elsewhere in that document.

This second method (using CSL and, optionally, TML) comprises the same basic elements, and relationships among elements, as the first method (using a concept specification language and, optionally, a text markup language). There are two differences between the two methods. The first difference is that where ever a concept specification language is used in the first method, CSL is used in the second. The second difference is that where ever a text markup language is referred to in the first method, TML is used in the second.

Hence, for example, in the generation method in this section, the concept specification language is CSL and comprises the generation of CSL Concepts using linguistic information—not generating the concepts of concept specification languages in general.

A preferred embodiment of this second method is given in section 2.3.

2. System

Two versions of a processing engine for concepts and Concepts, using a common computer architecture, are described in this section. One system (the concept processing engine) employs the method described in section 1.1; hence it uses concept specification languages in general and—though not necessarily—text markup languages in general. The other system (the Concept processing engine) employs the method described in section 1.2; hence it uses CSL and—though not necessarily—TML. The preferred embodiment of the present invention is the second system. First, however, the computer architecture common to both systems is described.

2.1. Computer Architecture

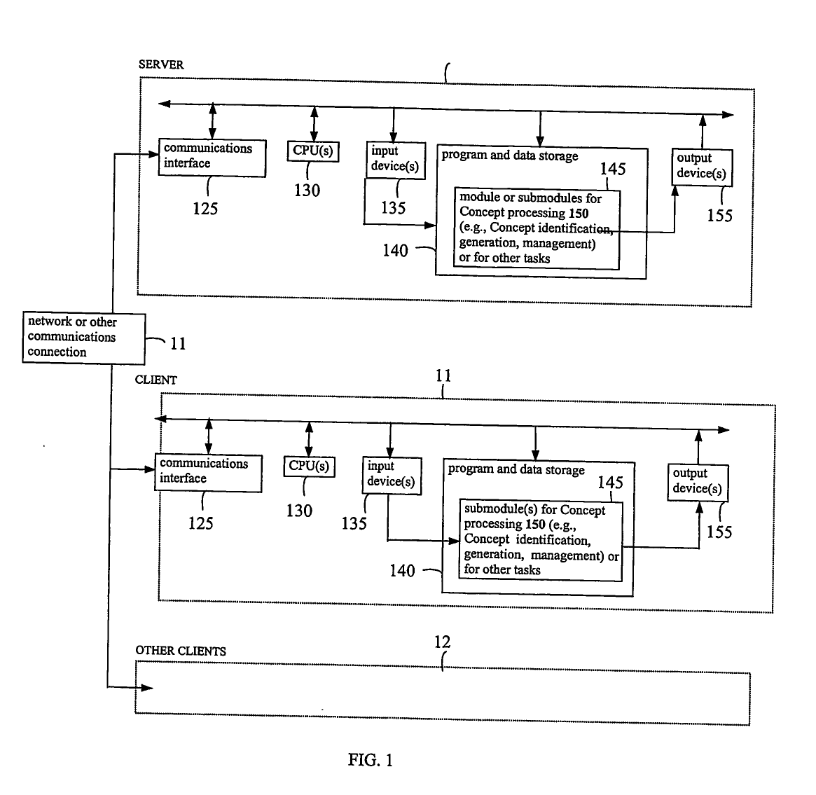

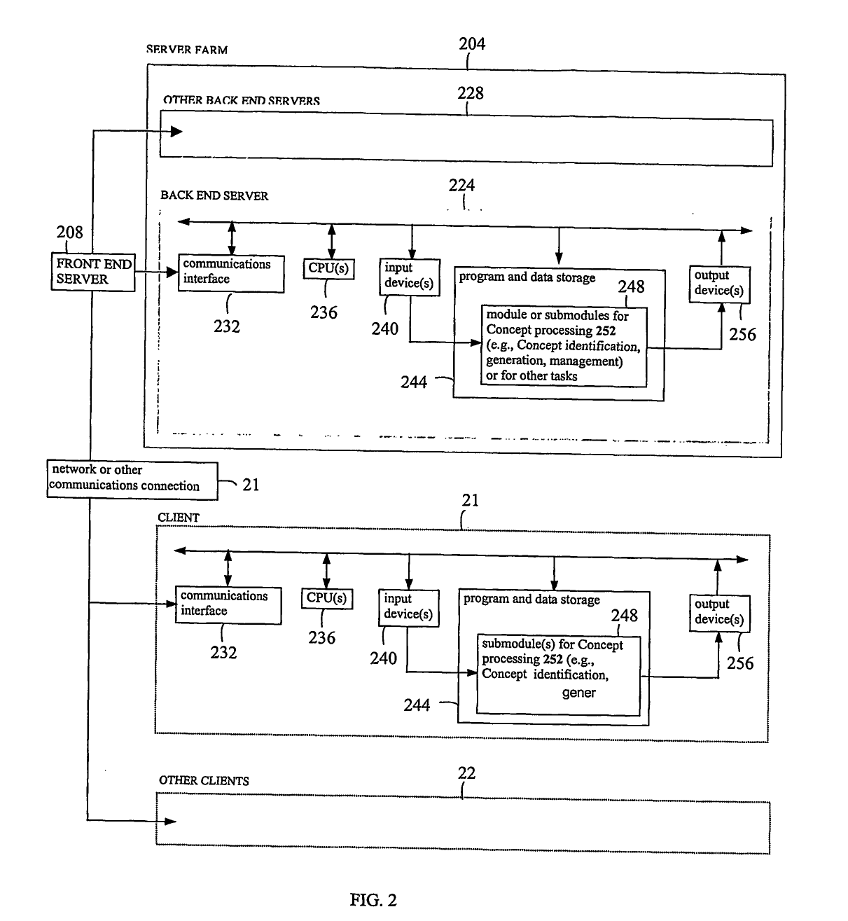

FIG. 1 is a simplified block diagram of a computer system embodying the Concept processing engine of the present invention. (“concept or Concept” does not appear in FIG. 1 and FIG. 2. Both figures and the description of the architecture in this section, however, should be understood as applying to both a concept processing engine and a Concept processing engine, etc.)

The block diagram shows a client-server configuration including a server 105 and numerous clients connected over a network or other communications connection 110. The detail of one client 115 is shown; other clients 120 are also depicted. The term “server” is used in the context of the invention, where the server receives queries from (typically remote) clients, does substantially all the processing necessary to formulate responses to the queries, and provides these responses to the clients. However, the server 105 may itself act in the capacity of a client when it accesses remote databases located on a database server. Furthermore, while a client-server configuration is one option, the invention may be implemented as a standalone facility, in which case client 115 and other clients 120 would be absent from the figure.

The server 105 comprises a communications interface 125a to one or more clients over a network or other communications connection 110, one or more central processing units (CPUs) 130a, one or more input devices 135a, one or more program and data storage areas 140a comprising a module and one or more submodules 145a for Concept (or concept) processing (e.g., Concept or concept generation, management, identification) 150 or processes for other purposes, and one or more output devices 155a.

The one or more clients comprise a communications interface 125b to a server 105 over a network or other communications connection 110, one or more central processing units (CPUs) 130b, one or more input devices 135b, one or more program and data storage areas 140b comprising one or more submodules 145b for Concept (or concept) processing (e.g., Concept or concept identification, generation, management) 150 or processes for other purposes, and one or more output devices 155b.

FIG. 2 is also a simplified block diagram of a computer system embodying the Concept processing engine of the present invention. The block diagram shows a client-server farm configuration including a server farm 204 of back end servers (224 and 228), a front end server 208, and numerous clients (216 and 220) connected over a network or other communications connection 212.

The front end server 208, in the context of the present invention, receives queries from (typically remote) clients and passes those queries on to the back end servers (224 and 228) in the server farm 204 which, after processing those queries, sends them to the front end server 208, which sends them on to the clients (216 and 220). The front end server may also, optionally, contain modules for Concept or concept processing 252 and may itself act in the capacity of a client when it accesses remote databases located on a database server.

A back end server 224, used in the context of the present invention, receives queries from clients via the front end server 208, does substantially all the processing necessary to formulate responses to the queries (though the front end server 208 may also do some Concept processing), and provides these responses to the front end server 208, which passes them on to the clients. However, the back end server 224 may itself act in the capacity of a client when it accesses remote databases located on a database server.

Note that the back end server 224 (and other back end servers 228) of FIG. 2 has the same components as the server 105 of FIG. 1. Note also that the client 216 (and other clients 220) of FIG. 2 has the same components as the client 115 (and other clients 120) of FIG. 1.

2.2. System Using Concept Specification Languages and (Optionally) Text Markup Languages

This first system uses the computer architecture described in section 2.1 and FIG. 1 and FIG. 2. It also uses the method described in section 1.1; hence it uses concept specification languages in general and text markup languages in general (though it can use concept specification languages on their own, without need for text markup languages). A description of this system can be assembled from sections 1.1. and 2.1. Although not described in detail within this section, this system constitutes part of the present invention.

2.3. System Using CSL and (Optionally) TML

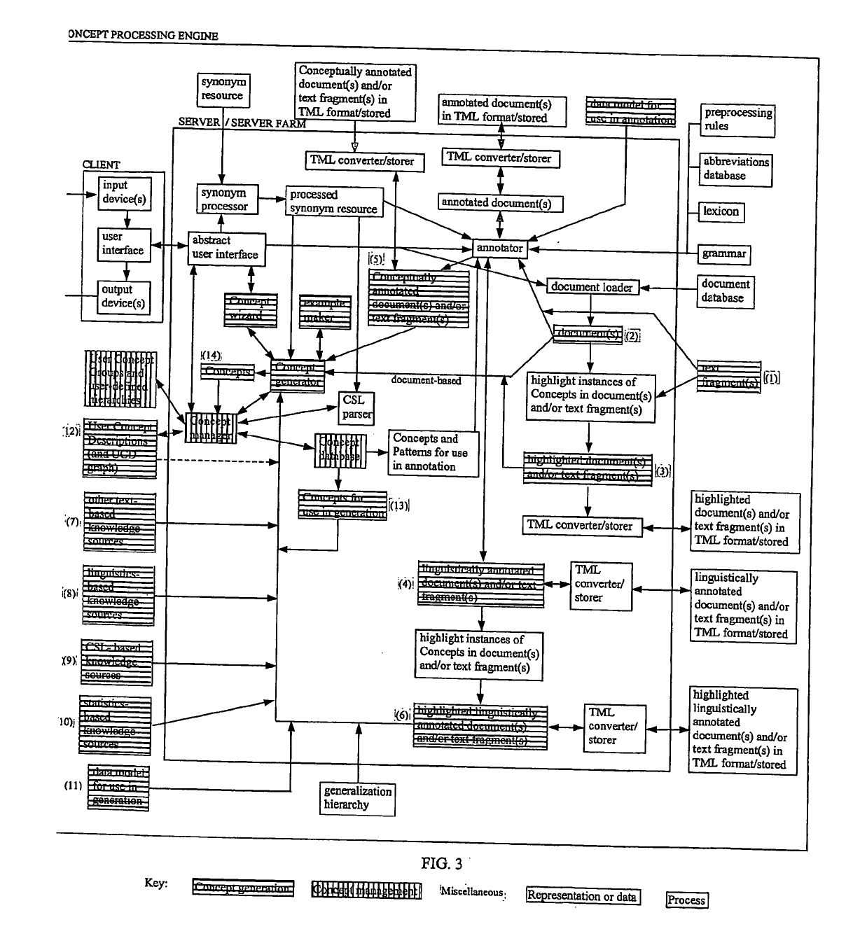

The second system also uses the computer architecture described in section 2.1 and FIG. 1 and FIG. 2. This system employs the method described in section 1.2; hence it uses CSL and a type of text markup language called TML, though it can use CSL on its own, without need for TML. The preferred embodiment of the present invention is the second system, which will now be described with reference to FIG. 3. The system is written in the C and C++ programming languages, but could be embodied in any programming language. The system is for, though is not limited to, Concept identification, Concept generation, and Concept management (and synonym processing) and is described in section 2.3.1.

2.3.1. Concept Processing Engine

FIG. 3 is a simplified block diagram of the Concept processing engine which is accessed by a user interface through an abstract user interface. The user interface is connected to one or more input devices and output devices. Note that the configuration depicted in FIG. 3 is a preferred embodiment, and that many other embodiments are possible. Appendix A gives some examples of different possible user interfaces.

The Concept Processing Engine of the present invention shares a number of elements with the Information Retriever described in section 2.3.1. of Fass et al. (2001). In FIG. 3, those elements that constitute the part of the present invention concerned with Concept generation have a background of horizontal grey lines; those elements concerned with Concept management have a background of vertical grey lines.

The Concept processing engine in FIG. 3 takes as input text in documents and other text-forms in the form of a signal from one or more input devices to the user interface, and carries out predetermined processing of Concepts to produce a collection of text in documents and other text-forms, which are output with the assistance of the user interface in the form of a signal to one or more output devices. Also produced are Concepts (and, possibly, UCDs, UCGs, and hierarchies of those three entities, including a UCD graph), which are stored in a Concept database.

More than one version of the Concept processing engine can be called at the same time, for example, if a user wanted to simultaneously employ alternative interfaces for accessing CSL and text files.

The predetermined processing of Concepts comprise an abstract user interface and the following main processes: synonym processor, annotator, Concept generation (including the Concept wizard, example maker, and Concept generator), Concept manager, and CSL parser. The following sections now describe these processes.

2.3.2. Abstract User Interface

The Concept processing engine is accessed by a user interface through an abstract user interface. The abstract user interface is a specification of instructions that is independent of different types of user interface such as command line interfaces, web browsers, and pop-up windows in Microsoft and other operating systems applications.

The instructions include those for the loading of text documents, the processing of synonyms, the identification of Concepts, the generation of Concepts, and the management of Concepts.

The abstract user interface receives both input and output from the user interface, Concept manager, and Concept wizard. (Concept generation and Concept management both use the abstract user interface.) The abstract user interface sends output to the synonym processor, annotator, and document loader.

2.3.3. Annotator

The annotator performs Concept identification and is comprised of a linguistic annotator which passes linguistically annotated documents to a Conceptual annotator. The linguistic annotator and its preferred main components (preprocessor, tagger, parser) and the Conceptual annotator and its preferred main component (the Concept identifier) are described in Section 2.3.2 of Fass et al. (2001). So is the Text Document Retriever, which has no corresponding part in the current disclosure.

Note that the text document annotator in FIG. 2 of Fass et al. (2001) consisted of the annotator plus document loader that are represented as distinct processes in FIG. 3 of the present disclosure (in other words, the status of the document loader has been elevated in the present disclosure.)

The annotator, accessed by the abstract user interface, takes as input various types of knowledge source and data model.

2.3.3.1. Knowledge Sources for Annotation (Including Concept Identification)

The annotator, accessed by the abstract user interface, takes as input various types of knowledge source. These sources include a processed synonym resource, preprocessing rules, abbreviations, lexicon, and grammar (see FIG. 3).

Further knowledge sources include text fragments and documents in various forms. A text fragment is a word, phrase, part-sentence, whole-sentence, or any larger piece of text that is smaller than a document. (A text fragment ends where a document begins.) The types of text fragment and document include:
one or more text fragments—(1) in FIG. 3—and/or
one or more text documents—(2) in FIG. 3—and/or
one or more documents and/or text fragments with instances of text fragments previously highlighted—(3) in FIG. 3 and/or
one or more documents and/or text fragments that have been already linguistically annotated—(4) in FIG. 3.

The annotator outputs either:
one or more linguistically annotated documents and/or text fragments—(4) in FIG. 3—and/or
one or more linguistically and Conceptually annotated documents and/or text fragments—(5) in FIG. 3.

The one or more linguistically annotated documents and/or text fragments—(4) in FIG. 3.—can in turn have Concepts in them highlighted to produce one or more highlighted linguistically annotated documents and/or text fragments—(6) in FIG. 3.

The following can be annotated in Text Markup Language (TML) by passing them through a TML converter (or converter for some other markup language), and may be stored:
one or more documents and/or text fragments with instances of Concepts previously highlighted—(3) in FIG. 3—and/or
one or more linguistically annotated documents—(4) in FIG. 3—and/or
one or more highlighted linguistically annotated documents and/or text fragments—(6) in FIG. 3.

(Note that a “highlighted linguistically annotated document”—(5) in FIG. 3—is equivalent in terms of marked-up information to a “Conceptually annotated document”—(6) in FIG. 3.)

TML is described in some detail in sections 1.2. and 2.3.3. of Fass et al. (2001).

2.3.3.2. Data Models for Annotation (Including Concept Identification)

The data models for annotation include statistical models, rule-based models, and hybrid statistical/rule-based models. Rule-based data models include linguistic and logical models.

A linguistic model for doing actual Concept identification is described in detail in Fass et al. (2001).

Various statistical models for Concept identification are possible. The model used in the preferred embodiment is presently, but need not be limited to, an implementation of the support vector machine method described in Joachims (1998), Kwok (1998), and Weston and Watkins (1999), among other publications.

Assume also in the following that the knowledge source is documents. Concepts are represented within this statistical model as support vector machines. To identify Concepts against the text in a document in this statistical model, the document is converted into a document vector, then each of the support vector machines (for Concepts) is used in turn to determine if the document contains the corresponding Concepts.

A document vector is created as follows. First, a dictionary is created comprising the stems of all words that occur in the system's training corpus. Stopwords and words that occur in fewer then m documents are removed from the dictionary. A given document may be converted to a vector representation in which each element, j, represents the number of times the jth word in the dictionary occurs in the document. Each element in the vector is scaled by the inverse document frequency of the corresponding word.

Document frequency is (1) the number of documents in which a particular word occurs divided by (2) the total number of documents. Conversely, inverse document frequency (IDF) is (1) the total number of documents divided by (2) the number of documents in which a particular word occurs.

A word is “significant” if it occurs in relatively few documents: it is therefore rare and more information is to be gained from it than from more frequently occurring words. Suppose we compute the IDF for the word fantastic which occurs 5 times in 100 documents, then the IDF for fantastic is (1) total number of documents (=100) divided by (2) the number of documents in which fantastic occurs (=5), so the IDF for fantastic=20.

Finally the vector is normalized to unit length, to remove bias towards larger documents. The result is a document vector.

Among these data models, the linguistic model generally provides the most in-depth analysis, but at a processing cost. Its algorithm generally uses key relevant words extracted from text and analyzes the syntactical relationships between words. A linguistic model outputs the Concept name, Concept location, and context string.

The statistical model generally provides rapid processing, but offers less in-depth analysis, as it does not analyze the syntactical relationships between words. A statistical model outputs the Concept name.

A hybrid statistical-linguistic model falls between the statistical model and the linguistic model in terms of processing speed and analysis. It uses some of the syntactical relationships in the text documents to differentiate between categories, hence providing more in-depth analysis than the statistical model, although less than the linguistic model. A hybrid model generally outputs the Concept name.

2.3.4. Synonym Processor

The Synonym processor takes as input a synonym resource and produces a processed synonym resource that contains the synonyms of the input resource, tailored to the domain in which the Concept processing engine operates. (The pruned synonym resource is referred to in some applications as a “synonym database.”) The synonym processor is described in Turcato et al. (2001). The pruned synonym resource is used as a knowledge source for annotation (Concept identification), Concept generation, and CSL parsing.

2.3.5. Concept/CSL Generation

This section comprises the following subsections: knowledge sources for Concept generation, data models for Concept generation, User Concept Definitions, Concept wizard, example maker, Concept generator, Concept/CSL management, and CSL parser (and compiler).

Concept generation uses as input various types of knowledge source and data model.

2.3.5.1. Knowledge Sources for Concept Generation

The knowledge sources include, but are not limited to, various forms of text, linguistic information, elements of CSL, and statistical information. The various forms of text include, but are not limited to, vocabulary, text fragments, and documents. The text fragments and documents can be annotated in various ways and these variously annotated text fragments and documents fed into Concept generation as knowledge sources. These knowledge sources include the following:
one or more text fragments—(1) in FIG. 3—and/or
one or more text documents—(2) in FIG. 3—and/or
one or more documents and/or text fragments with instances of Concepts previously highlighted—(3) in FIG. 3 and/or
one or more documents and/or text fragments that have been already linguistically annotated—(4) in FIG. 3 and/or
one or more Conceptually annotated documents and/or text fragments—(5) in FIG. 3 and/or
one or more highlighted linguistically annotated documents and/or text fragments—(6) in FIG. 3.

As noted in section 2.3.3.1. and referred to in the preceding list, there are many combinations of ways in which highlighting and linguistic annotations may be applied to documents and/or text fragments, all of which may be input to the Concept generator. The combinations increase when combined with the possibility of converting those documents and/or text fragments to TML (or some other format) and also perhaps storing them. Some of those storage possibilities are now described.

There may be highlighting of instances of Concepts in text fragments (1) or documents (2) in FIG. 3 to produce highlighted text documents (or text fragments) (3). Those highlighted text documents (3) may be converted to TML (or some other format) and may also be stored.

The linguistic annotator within the annotator processes text fragments (1) or documents (2) to produce linguistically annotated documents or text fragments (4) or highlighted linguistically annotated documents or text fragments (6). Both of these may be converted to TML (or some other format) and may also be stored. Conceptually annotated documents or text fragments (5) may also be stored.

(Text-based knowledge sources other than text fragments and documents—e.g., vocabulary—are depicted in FIG. 3. by box 7.)

The various linguistic information-based knowledge sources used in Concept generation include, but are not limited to, vocabulary specifications; lexical relations such as synonyms, hypernyms, and hyponyms; grammar items; and semantic entities. These various sources are depicted in FIG. 3 by box 8.

Note that a hypernym is a more general word, e.g., mammal is a hypernym of cat. A hyponym is a more specific word, e.g., cat is a hyponym of mammal. Users may be given the option of specifying the number of levels to show above (more general than) or below (more specific than) a given word. Users may be given the option of specifying the following level types (in the following, a synonym set or synset is a set of synonyms of some word):
Hyperlevels—the specified number of hypernym levels above (more general than) all synonym sets that contain the given word.
Hypolevels—the specified number of hyponym levels below (more specific than) all synonym sets that contain the given word.

For example, if a user chooses to reference the synset canis_familiaris, dog, domestic_dog, and specify hyperlevel=1, this returns one hypernym level above: canid, canine; hyperlevel=2 additionally returns another level above: carnivore; continuing up to the specified level. If a user specifies hypolevel=1 for the synset canis_familiaris, dog, domestic_dog, this returns all types of dogs, such as German Shepherd.

(The generalization hierarchy in FIG. 3. is used to find hypernyms and hyponyms.)

Semantic entities are common domain topics including, but not limited to, domains commonly found in document headers (such as From:, To:, Date:, and Subject:), names of people, names of places, names of companies and products, job titles, monetary expressions, percentages, measures, numbers, dates, time of day, and time elapsed/period of time during which something lasts.

The various elements of CSL used in Concept generation include, but are not limited to, grammars (i.e., grammar specifications), semantic entity specifications, CSL Operators, internal database Concepts, and external imported Concepts. These knowledge sources include, but are not limited to, the following:
one or more grammars (grammar specifications), and/or
one or more semantic entity specifications, and/or
one or more CSL Operators, and/or
one or more imported Concepts, and/or
one or more internal database Concepts to be used for generation.

These CSL-based knowledge sources are depicted in FIG. 3 by box 9.

Finally, the statistical information-based knowledge sources used in Concept generation include word frequency data derived from vocabulary items, text fragments, and documents—depicted as (10) in FIG. 3.

Definitions of the less obvious of these knowledge sources will be left to the relevant sections on Concept generation based on that knowledge source.

2.3.5.2. Data Models for Concept Generation

Data models for Concept generation put together information from knowledge sources to produce concepts or Concepts. The data models include, but are not limited to, statistical models and rule-based models. Rule-based data models include, but are not limited to, linguistic and logical models. Data models for Concept generation are depicted in FIG. 3 by box 11.

Definitions of these data models will be left to sections describing Concept generation that tend to employ that data model. Those knowledge sources and data models that commonly go together when Concepts are generated in the system are as follows (though all kinds of other associations between knowledge sources and data models are useful for Concept generation):
Text fragments—linguistic data model;
Documents—statistical data model; and
CSL Operators—logical data model.
   2.3.5.3. User Concept Definitions

User Concept Definitions (UCDs) are “templates” for Concept creation. They are specifications of Concepts in terms of different ways in which Concepts can be generated from different types of knowledge (knowledge sources) by way of different data models. Those knowledge sources and data models were reviewed in sections 2.3.5.1 and 2.3.5.2. respectively. UCDs also contain specifications of the properties of the generated Concept, including the name of the Concept and its “visibility” when used in matching text. (One does not generally want to see the text matches of Concepts, hence their visibility is set to No or Zero.)

Table 1 shows variants of the UCD idea. The basic UCD is a template form on which all other UCDs are based—including, but not limited to, types (2)-(5) in Table 1. The unpopulated knowledge-source based and data-model based UCDs are, in a sense, all populated versions of the basic UCD: they are populated with information about, but not limited to, particular knowledge sources and data models. When a reference is made in this document simply to say a document-based UCD, then the reader can assume, unless specified otherwise, that the UCD is an unpopulated one of type (2) rather than a populated one of type (4).

Populated UCDs can be saved in the Concept database and can be edited by users in the Concept editor if those users have appropriate privileges (the average user does not have permission to edit unpopulated UCDs).

Types of knowledge-source based UCD include, but are not limited to, vocabulary-based UCD, text-based UCD, document-based UCD, Operator-based UCD, imported Concept-based UCD, and internal Concept-based UCD.

Many of the knowledge-source based UCDs use as knowledge sources not just the one after which they are named. For example, the Operator-based UCD is based on operations including, but not limited to, AND and OR. However, AND and OR can in turn combine all kinds of knowledge sources including, but not limited to, words and Concepts.

Again, many of the knowledge-source based UCDs can be combined with various data models, and those data models have different requirements on the knowledge sources they use. For example, the text-based UCD can be used to generate Concepts with, among other models, linguistic or statistical data models.

The populated knowledge-source based and data-model based UCDs are versions of UCDs types (2)-(3) in Table 1 that have been “filled out” with information during the process of generating a Concept. Populated UCDs can be saved in the Concept database and can be edited by the Concept editor.

To convey the difference between the unpopulated and populated version of a UCD, consider the unpopulated and populated versions of a text-based UCD. The unpopulated text-based UCD specifies that a text-based Concept is derived from text fragments, from highlighted (relevant) and irrelevant words, and their locations.

In turn, a text-based UCD that has been filled-out with information during the creation of a Concept is known as a “populated text-based UCD” and contains the actual text fragments used to create the Concept, the actual highlighted (relevant) and irrelevant words, and their actual locations.

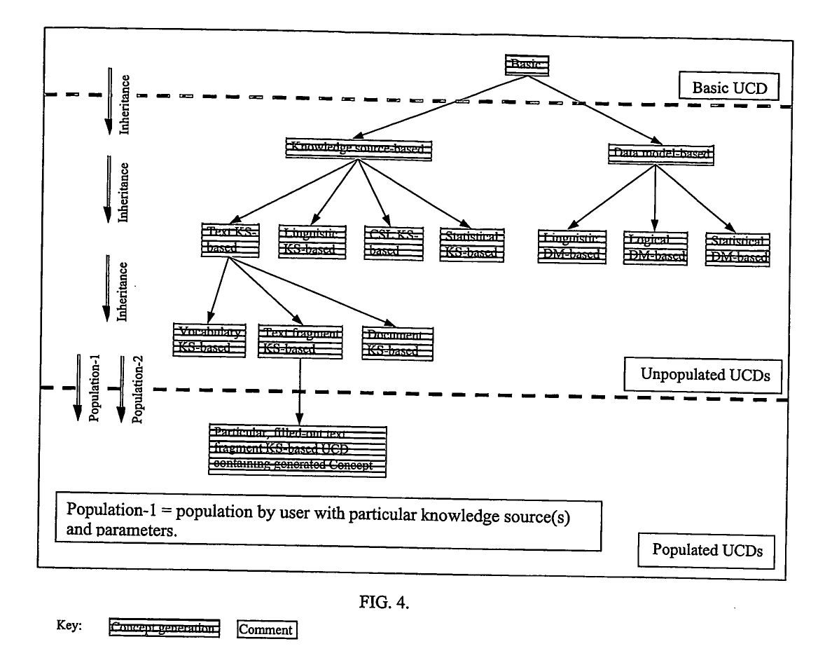

FIG. 4 shows a graph of UCDs (also known as a UCD graph). The UCDs in the graph are of the three types just mentioned: basic, unpopulated, and populated. The three types are organized hierarchically. The top level of the graph is occupied by the basic UCD. The next level is occupied by unpopulated UCDs including the knowledge-source based UCD and data-model based UCDs. Inherited information is optionally passed down from the basic UCD at the top level to the unpopulated UCDs at the next level.

The next one or more levels of the UCD graph are occupied by further unpopulated UCDs including subtypes of that knowledge-source based UCD (such as the vocabulary-based, text-based, and document-based UCDs) or subtypes of the data-model based UCD (such as the logical-based UCD). Inherited information is optionally passed down from the unpopulated UCDs at the higher level to the unpopulated UCDs at the next one or more levels, and the information is further optionally passed within those one of more levels.

The next level is occupied by populated UCDs. These UCDs are populated by
a) one or more particular knowledge sources and parameters, supplied by the user; and
b) a generated Concept, supplied by the Concept generation method.

The UCD graph is optionally stored in a Concept database, but could be stored in some knowledge repository by storage methods other than a database.

2.3.5.3.1. Data-Model Based UCDs

Data-model based UCDs include statistical model-based and rule-based model-based UCDs. The statistical model-based UCD is known as the statistical UCD for short. Rule-based model-based UCDs include linguistic model-based and logical model-based UCDs. These are referred to as the linguistic and logical UCDs, respectively.

As noted earlier, in the current preferred embodiment, certain knowledge-based UCDs tend to employ certain data models for Concept generation, though all kinds of other associations between knowledge sources and data models are also useful for Concept generation. Those knowledge-source based and data-model based UCDs that commonly go together in the system are as follows:
statistical UCD—documents—document UCD,
linguistic UCD—text fragments—text UCD, and
logical UCD—CSL Operators—Operator UCD.

Note that by providing both data-model based and knowledge-source based UCDs, users are provided with alternative ways to generate Concepts, depending on their own preferences.

2.3.5.3.2. Knowledge-Source Based UCDs

Knowledge-source based UCDs, like the knowledge sources on which they are based, include various forms of text, linguistic information, elements of CSL, and statistical information. The various forms of text include vocabulary, text fragments, and documents. The UCDs based on these forms of text are sometimes referred to as vocabulary UCDs, text UCDs, and document UCDs.

The various forms of linguistic information used in Concept generation include vocabulary specifications, lexical relations (e.g., synonyms, hypernyms, hyponyms), grammar items, and semantic entities. UCDs based on these knowledge sources use the names of the sources, e.g., vocabulary specification UCD and grammar item UCD.

The various elements of CSL used in Concept generation include grammars (i.e., grammar specifications), semantic entity specifications, CSL Operators, internal database Concepts, and external imported Concepts. Again, UCDs based on these knowledge sources use the names of the sources, e.g., Operator UCD and internal Concept UCD.

Finally, the statistical data used in Concept generation includes word frequency data derived from vocabulary items, text fragments, and documents. The UCD based on this latter knowledge source is known as the word frequency UCD.

Sections are now devoted to two of the four types of knowledge-source based UCDs—text-based and CSL-based ones—with most attention paid to the text and Operator types.

2.3.5.3.2.1. Text-Based UCDs

Vocabulary UCD

The vocabulary UCD uses the vocabulary (i.e., words and phrases) for some domain that has been prepared in some systematic fashion, and transforms that vocabulary into Concepts.

Text UCD

The text UCD uses text fragments and relevant key words to define a Concept. The unpopulated version of the text UCD provides the following capability to hold all of the following:
input text fragments.
selected relevant words.
synonyms, hypernyms, and hyponyms for those relevant words.
Concept generation Directives (e.g., Concept name, Concept file name).
the generated Concept.

A populated version of this UCD holds the actual content used to generate a particular Concept.

Document UCD

The document-based UCD uses a set of related text documents to which the user assigns Concept names. See section 2.5.3.6.3 for Concept generation methods associated with this UCD.

2.3.5.3.2.2. CSL-Based UCDs

Operator UCD

The Operator or Operator-based UCD uses logical combinations of existing Concepts and relevant words and phrases to create a Concept. That is, an Operator-based UCD combines existing Concepts and key words and phrases using Boolean/Logical Operators (e.g., AND or OR) and other Operators (such as Associated_With and Causes) to indicate the relationships between the Concepts and key words and phrases, thereby creating a new single Concept.

Imported Concept UCD

The imported Concept UCD uses what are referred to in some applications as “Replacement Concepts” which are imported into the system from outside of it. (Replacement Concepts may be obtained by various means including, but not limited to, e-mail and collection from a website. These Concepts are likely produced by a person with specialized knowledge of CSL, probably at the request of a particular user of the Concept processing engine.)

Internal Concept UCD

The internal Concept UCD is for use by people with knowledge of the internals of CSL. This UCD requires a copy of a source Concept plus instructions on how to adapt that Concept to create a new one. These specifications are fed to the Internal Concept Generator which generates a new Concept from the old one.

2.3.5.4. Concept Wizard

A Concept wizard is a navigation tool for users, providing them with instructions on entering data for the generation of a Concept, according to the knowledge sources, data model, and other generation Directives used. Different Concept wizards are used, depending on the UCD selected. Input from the abstract user interface is taken through the Concept wizard and is passed to the Concept generator for the creation of actual Concepts. Input from the Concept generator taken into the Concept wizard includes information about choices of knowledge sources and data models for generation, and Directives governing generation.

Section 2.3.8 describes how the Concept wizard interacts with the UCD graph (optionally stored in the Concept database) and Concept generator when a Concept is generated.

2.3.5.5. Example Maker

The example maker takes as input a Concept from the Concept generator and outputs a list of words and phrases that match that Concept. Users can mark the words and phrases in the list as relevant or irrelevant, and the marked-up list is returned to the Concept generator.

A further option is to redefine the Concept based on the marked-up list.

2.3.5.6. Concept Generator

The Concept generator, accessed by the abstract user interface via the Concept wizard, comprises various subtypes of Concept generator, depending on the UCD selected.

Output from the Concept generator is Concepts (box 14 in FIG. 3) which are sent to the Concept database via the Concept manager, and instructions to the Concept wizard.

There may be two-way interaction with the example maker. Concepts are passed to the example maker. Lists of word and phrases generated by the example maker, marked as appropriate or inappropriate by a user, are returned to the Concept generator.

The subtypes of Concept generator mirror the various types of UCD, so there are knowledge-source based Concept generators and data-model based Concept generator. The knowledge-source based Concept generators include the following types: text-based, linguistic information-based, CSL-based, and statistical information-based generators. Data-model based generators can be divided into statistical and rule-based generators, and so forth.

Sections are now devoted to two of the four types of knowledge-source based Concept generators—text information-based and CSL-based ones—with most attention paid to the text, document, and Operator-based generators.

2.3.5.6.1. Text Information-Based Concept Generators

2.3.5.6.1.1. Vocabulary-Based Concept Generator

The vocabulary-based Concept generator takes the vocabulary for some domain that has been prepared in some systematic fashion, and transforms that vocabulary into Concepts.

An example of such systematic vocabulary is a set of common noun phrases (noun compounds and adjective-noun combinations) where someone—likely, but not necessarily, a specialist for that domain—has prepared acceptable synonyms for each of the terms in those noun phrases. For example, consider the phrase equipment failure. The preparer might have deemed that mechanical and apparatus were acceptable synonyms for equipment in this phrase, and that crash was an acceptable synonym for failure. The vocabulary-based Concept generator can take a set of such phrases and use them to create one or more Concepts.

Further examples are shown in Table 2, where a person has mapped out in systematic fashion certain linguistic patterns associated with charges due to restructuring and with job cuts of professionals. The vocabulary-based Concept generator can take such patterns and use them to create one or more Concepts.

TABLE 2
Two Examples of Structured Vocabulary.
Charges due to restructuring

| Charges | Due to | Restructuring |
|---|---|---|
| | associated with | restructuring |
| | resulting from | Concept Job cuts |
| | as a result of | |
| | due to | |
| | caused by | |

Job cuts of professionals (as opposed to general comments such
as elimination of 800 employees, or reduced workforce by 10%)

| Job cuts | Professionals |
|---|---|
| | white collar |
| | well-educated (well |
| | educated) |
| | specialists |
| | head-office (head office) |
| | middle-management (middle |
| | management) |
| | scientists |
| | analysts |

2.3.5.6.2. Text-Based Concept Generator

Text-based Concept generation is frequently—though not necessarily—associated with the linguistic data model, so this combination of data model and knowledge source (text fragments) is now described. With it, users can create Concepts from text fragments without knowledge of CSL.

Assuming the linguistic data model is being used, the text-based Concept generator works in the following way, though it needs not be limited to working in this way:
1. Input of text fragments. The user is prompted for one or more text fragments. These fragments are input to the next step.
2. Fragments split into words. The fragments are split into individual words using standard Concept processing engine algorithms.
3. Selection of relevant words. The user selects relevant words in the text fragments. (Default selection is available.)
4. Optional operations on relevant words. For any selected relevant word, the user can find its synonyms, hypernyms, and hyponyms.
   a. Add synonyms.
   b. Add hypernyms.
   c. Add hyponyms.
      (The Concept generator is also capable of providing a list of default selections of key words, synonyms, and hypernyms.)
5. Concept matching. A predefined set of Concepts from the user are run over the fragments and all matches are returned. When matching, the part of speech of individual words is determined by standard Concept processing engine algorithms. The predefined set of Concepts is for (domain-independent) grammatical constructions such as Subj_Verb_Obj. The resulting matches are known as a “Concept matches”.
6. Removal of Concept matches. Certain Concept matches are removed, depending on (1) what words have been marked as “relevant” and (2) the interpretation placed on “relevant” by the user (the algorithm may optionally do one or both steps automatically). Words that are marked as “relevant” are interpreted in one of four ways.
   a. Interpretation 1: A Concept match is kept if all of the arguments of its match are marked as relevant, e.g., the match of the Concept Noun_Verb against dog eats is kept only if both dog and eats are marked as relevant.
   b. Interpretation 2: A Concept match is kept if one or more of the arguments of its match are marked as relevant, e.g., the match of the Concept noun_verb against dog eats is kept only if one or more of the arguments—dog, eats, or dog and eats—are marked as relevant.
   c. Interpretation 3: A Concept match is kept if all the words marked as relevant fall inside the extent of the match (up to and including the boundaries of that extent).

d. Interpretation 4: A Concept match is kept if one or more of the words marked as relevant fall inside the extent of the match (up to and including the boundaries of that extent).

TABLE 3
Four Interpretations of Relevance.

| | Extents unimportant | Extents important |
|---|---|---|
| Arguments | Relevance | Relevance |
| important | interpretation 1 | interpretation 3 |
| Arguments | Relevance | Relevance |
| unimportant | interpretation 2 | interpretation 4 |

A summary of the four relevance interpretations appears in Table 3. Using one of these four interpretations of “relevant,” the algorithm removes certain Concept matches.
7. Building of Concept chains (tiling). A list of “chains” is built from the Concept matches kept from the previous step, where a “chain” (also known as “tiles” and “generalizations”) is a sequence of Concept matches such that:
   a. No two matches in the chain overlap, and
   b. No match can be added to a particular chain without violating (a) (i.e., the chains are of maximum length).
      Using the subset of Concept matches, one of two tiler algorithms is used to construct a set of all possible chains. The two tilers use different definitions of “chain.”
   The standard, non-overlapping tiler assumes that a chain is a set of adjacent Concept matches (tiles) with no overlapping extents. The non-overlapping tiler assumes that no word can belong to two different Concepts in the same chain. This tiler produces a set of chains as few in number as one through to as many in number as there are different paths between words.
   The non-standard, overlapping tiler assumes that a chain is a set of adjacent Concept matches (tiles) with overlapping extents allowed. The overlapping tiler assumes that one word can belong to two different Concepts in the same chain. This tiler takes all connections between words and prefers to find shorter spans rather than larger ones. It produces a single optimal chain.
8. Ranking chains. When the standard, non-overlapping tiler is used, every chain from the previous step is ranked and only the chains with maximum rank are kept. The rank of a chain is calculated as follows:
   a. “Match Coverage” is the number of words in the match of that whole chain that overlap extent between the first and last relevant words.
   b. “Match Context” is the number of words in the match that are outside of the extent between the first and last relevant words.
   c. “Match Rank” is “Match Coverage” minus “Match Context.” The final rank is the sum of all Match Ranks for a given chain minus the length of the chain. (Subtracting the chain length is intended to boost ranking of shorter chains, which are likely the ones that consists of longer/more meaningful matches.)
9. Chains written as CSL Concept. Every chain that passed through the previous step is written out as CSL. The matches within a chain are written into CSL as a conjunction with an “ˆ” (AND) Operator. If there is more than one chain, then all chains are written into CSL as disjunctions (alternatives) with an “|” (OR) Operator. Chains are written out as follows:
   a. Take the first chain.
   b. Take the first match.
   c. Look up the match in the Rule Base (see next subsection) to get Concept.
   d. Write out Concept.
   e. If there is another match in the chain, write out a “ˆ” (AND) Operator and go to step c. with the next match.
f. (No more matches.) If there is another chain, then write out a “|” (OR) Operator and go to step b. with the next chain. Else, exit to next step (the defined Concept covers the text fragments).
10. Specification of Directives. The Concept generator writes the output into a CSL file containing a single Concept.
   a. The user gives a name to the CSL file produced in the previous step.
   b. The user gives a name to the Concept produced in the previous step.
   c. The user specifies whether the Concept is visible or hidden for matching purposes.
   d. The user specifies whether the CSL file is encrypted or not.

Table 4 shows some example user inputs and the steps in the preceding algorithm where inputs are made.

TABLE 4
Example User Inputs.

| Step | User Input | Input String Example |
|---|---|---|
| 1 | Text fragments | The dog barked loudly |
| 3 | Relevant words | dog, barked |
| 4b | Hypernyms (for dog) | companion animal, pet |
| | (for bark) | utter, emit, let out, let loose |
| 10a | CSL file name | animal |
| 10b | New Concept name | noisy_animal |
| 10c | Desired Concept visibility | Yes |
| 10d | Encrypted file? | No |

The Concept generator is organized as a small expert system, though other modes of organization are also possible. There is a Rule Base that stores general rules used for guiding Concept generation process and a Reasoning Engine that uses the Rule Base to create the resulting Concept. The Rule Base and Reasoning Engine are now described.

2.3.5.6.2.1. Rule Base of Text-Based Concept Generator

The Rule Base does have the meaning of the word “rule” in the CSL Rule sense of Fass et al. (2001). The Rule Base comprises:
General Concept definitions for the text-based Concept generation process.
Rules that transform general Concepts that matched the text fragments into Concepts of the resulting Concept. As an example of a rule, consider “Subj_Passive_Verb_Obj=>Subj_Verb_Obj”. This Concept tells the Reasoning Engine that if a text fragment contains a construct that matches the Subj_Passive_Verb_Obj Concept, then the resulting Concept should contain a slightly more general Concept Call Subj_Verb_Obj.
Optionally, generalization relationships are specified between the Concepts that transform between active and passive. For example, the Rule Base can contain information that the Subj_Passive_Verb_Obj Concept is more specific than the Noun_Verb_Noun Concept.
   2.3.5.6.2.2. Reasoning Engine of Text-Based Concept Generator

The Reasoning Engine matches input text fragments against all Concept definitions in the Rule Base. It makes sure that only the Concepts that cover the selected relevant key words are considered. In cases where there is more than one Concept covering the input fragment, it uses the tiling algorithm (from step 7 of the earlier ten-step algorithm) to pick the most important Concepts.

As an alternative, the Rule Base can be extended to provide additional information for the tiling algorithm to do the task. The Reasoning Engine then uses the most important Concepts and the Rule Base to generate the result. The permissible lexical relations (e.g., synonyms, hypernyms, hyponyms) are applied during this stage too.

TABLE 5
Example User Inputs.

| Step | User Input | Input String Example |
|---|---|---|
| 1 | Text fragments | Mary was adored by John since |
| | | high school |
| 3 | Relevant words | John, Mary, adore |
| 4a | Synonyms (for adore) | love intensely |
| 10a | CSL file name | love |
| 10b | New Concept name | Adoration |
| 10c | Desired Concept visibility | Yes |
| 10d | Encrypted file? | No |

For example, consider the inputs shown in Table 5. The Reasoning Engine finds that Concepts Subj_passive_Verb_Obj(john, adore, mary) and Noun_Noun(john, mary) match the input. The tiling algorithm picks Subj_Passive_Verb_Obj(john, adore, mary) as the most important one. The Rule Base from the previous example and the lexical relations are used to produce the result:

visible Concept Adoration {
Subj_Verb_Obj(john, @adore, mary)
}

2.3.5.6.2.3. More on the Non-Standard, Overlapping Tiler

The non-standard, overlapping tiler assumes constructs a series of paths through all of the relevant words via Concept matches that relate those words. Consequently, if a word is marked as relevant, then it will necessarily contribute to the generated CSL. This is not the case with the standard, overlapping tiler; there is no guarantee that a relevant word will show up in the generated CSL file.

As with the standard, overlapping tiler, the first step is to generate a set of Concept matches from an input text fragment. Once all of the Concept matches have been generated, only the minimum number of tiles required to connect all relevant words are kept. Preference is given to tiles spanning shorter extents, where possible. All match arguments must be marked as relevant for the match to be considered by the tiler. Matches that contain arguments that are not relevant will be discarded.

An example is now presented that uses the text fragment The dog barks loudly and a Concept called CloselyRelated to generate a new Concept. CloselyRelated only matches user-selected relevant key words if heads of chunks are found in the same clause. It also relates the head of a chunk to other words in the same chunk. “Chunk” here refers to a syntactic unit such as #NX (noun phrase) and #VX (verb phrase).

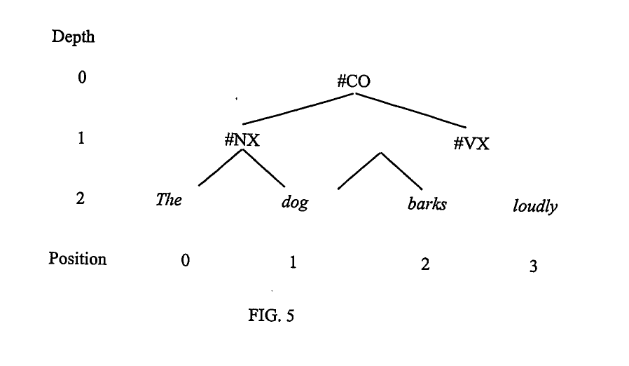

FIG. 5 shows the constituent structure for the text fragment The dog barks loudly. (#CO refers to a constituent, and does not have the same status as a syntactic unit and “chunk” as #NX and #VX.)

Table 6 shows the spans (intervals) for the words and constituents shown in FIG. 5.

TABLE 6
Words, Constituents, and Their Spans.

| Words and | |
|---|---|
| constituents | Spans of words and constituents |
| #CO | interval 0-3, depth 0 |
| #NX | interval 0-1, depth 1 |
| #VX | interval 2-3, depth 1 |
| the | interval 0-0, depth 2 |
| dog | interval 1-1, depth 2 |
| barks | interval 2-2, depth 2 |
| loudly | interval 3-3, depth 2 |

Assume all of the words are marked as relevant (step 3 of the algorithm given earlier in this section). Concept matching (step 5) will produce the Concept matches shown in Table 7.

TABLE 7
Concept Matches.

| Concept match | Spans of Concept match |
|---|---|
| (1) CloselyRelated(the, dog) | interval 0-1, depth 2 |
| (2) CloselyRelated(dog, barks) | interval 1-2, depth 2 |
| (3) CloselyRelated(barks, loudly) | interval 2-3, depth 2 |
| (4) CloselyRelated(dog, loudly) | interval 1-3, depth 2 |

In step 6 (removal of Concept matches), the non-standard, overlapping tiler will throw out (4) CloselyRelated(dog,loudly) because there is already a “path” between dog and loudly through (2) and (3).

It should be noted that CloselyRelated happens to match every word with itself. In this case, these one-word extents—whether matched by CloselyRelated or some other Concept—are only kept if the word matched is not also matched by a Concept also containing another word. Using the example above, we would also get the Concept matches shown in Table 8:

TABLE 8
Concept Matches.

| Concept match | Spans of Concept match |
|---|---|
| (5) CloselyRelated(the, the) | interval 0-0, depth 2 |
| (6) CloselyRelated(dog, dog) | interval 1-1, depth 2 |
| (7) CloselyRelated(barks, barks) | interval 2-2, depth 2 |
| (8) CloselyRelated(loudly, loudly) | interval 3-3, depth 2 |

All the Concept matches shown in Table 8 get discarded because each of the words is contained in a match with an extent that spans more than one word. For example, (5) CloselyRelated(the,the) has interval 0-0 and is discarded because (1) CloselyRelated(the,dog) has interval 0-1.

It is undefined which match is chosen if two or more matches cover the same extent. This is not a problem when only using only one general Concept (i.e., CloselyRelated) but may cause unpredictable and inconsistent results when multiple Concepts are used.

2.3.5.6.2.4. Variant Using Positive and Negative Text Fragments

A variant of the text-based Concept generator works with positive and negative text fragments. The relevant words in positive text fragments are words that should match the generated Concept. The relevant words in negative text fragments are words that should not match the generated Concept. When both positive and negative text fragments are used, the ten-step algorithm is expanded as follows:
1. Input of text positive and negative fragments. The user is prompted for one or more positive and negative text fragments.
3. Selection of relevant words. The user selects relevant words in the positive and negative text fragments.

A concept generated by the preceding method (and any Document UCD that employs the method) will match documents that are similar to the positive examples. The concept will not match documents that are similar to the negative examples.

2.3.5.6.3. Document-Based Concept Generator

Document-based Concept generation is frequently—though not necessarily—associated with the statistical data model, so this combination of data model and knowledge source (documents) is now described, though document-based Concept generation does not need to be limited to working in this way. With it, users can create Concepts from documents without knowledge of CSL.

The generator performs a statistical analysis of a given set of related text documents to which Concept names are assigned. Based on this analysis, the generator produces Concepts. (Those Concepts can then be used to identify previously unreferenced text documents.)

The generation method described in this section is the same as the one described for Concept identification using a statistical model (section 2.3.3.2.), where a support vector machine was generated for each Concept.

2.3.5.6.4. CSL-Based Concept Generators

2.3.5.6.4.1. Operator-Based Concept Generator

The Operator-based Concept generator allows users to create Concepts based on simple logical operations (such as AND or OR) and other, linguistically-oriented operations (such as Related and Cause).

Assuming the logic-based data model is used, input to the Operator-based Concept generator includes, but is not limited to:
Names of the Concepts that need to be combined into a new Concept.
Names of the files that contain the given Concepts.
Operations that should be performed (including, though not necessarily limited to):
   OR, AND, and ANDNOT.
   Immediately Precedes and Precedes.
   Precedes within less than N words and Precedes outside of (greater than) N words.
   Immediately Dominates and Dominates.
   Related and Cause.
Document level tags (types of semantic entity), e.g., #subject, #from, #to, #date.
Desired name of Concept file produced.
Desired name of Concept produced.
Desired Concept visibility.
Whether or not a Concept file should be encrypted.

The operations that can be performed include the following Operators:

The logical Operators OR, AND, and ANDNOT.

Immediately Precedes is defined in CSL as follows. A Immediately Precedes B, where A matches any extent; B matches any extent, and the result is an extent that covers the extent matched by B and an extent matched by A if the extent matched by A is immediately before the extent matched by B with no intervening items.

Precedes is defined in CSL as follows. A (Non-Immediately) Precedes B, where A matches any extent; B matches any extent, and the result is an extent that covers the extent matched by B and an extent matched by A if the extent matched by A is before the extent matched by B.

Immediately Dominates is defined in CSL as follows. A Immediately Dominates B, where A matches any extent, B matches any extent, and the result is the extent matched by B if all the linguistic entities of B's extent are subconstituents of all the linguistic entities of A's extent with no intervening items.

Dominates is defined in CSL as follows. A (Non-Immediately) Dominates B, where A matches any extent, B matches any extent, and the result is the extent matched by B if all the linguistic entities of B's extent are subconstituents of all the linguistic entities of A's extent.

Related is defined as follows. A Related B, where A matches any extent; B matches any extent, and the result is an extent that covers the extent matched by B and an extent matched by A if the extent matched by A is related to the extent matched by B through, though not limited to, any of the following syntactic relationships:
A is the subject in a sentence where B is the object, or vice versa.
   Examples: The Bush administration plans to disarm Iraq. Iraq is reusing the Bush Administration's terms. The Bush Administration is A and Iraq is B.
A is the subject of the verb B.
   Examples: WorldCom will file for bankruptcy. WorldCom will file its quarterly report with the SEC. WorldCom is the subject, and file is the verb.
A is a verb and B is its object, or B is a verb and A is its object.
   Examples: Investigators surveyed the excavation site. Surveyed is a verb, the object of which is the excavation site.
A is an adverb modifying the verb B.
   Examples: Last July, the management team knowingly filed inaccurate reports. Knowingly is the adverb, and filed is the verb.
A is an adjective modifying the noun B, or B is an adjective modifying the noun A.
   Examples: Insufficient evidence was turned up. The evidence was insufficient. Insufficient is the adjective, and evidence is the noun.
A and B are nouns in a compound noun relationship.
   Examples: Security teams surrounded the area. Security and teams are two nouns forming a compound noun.
A is modified by a prepositional phrase containing B.
   Examples: Documents from the US Department of Energy were submitted last April. Documents is a noun, with the added information of location, the US Department of Energy.

Cause is defined as follows. A Cause B, where A matches any extent, B matches any extent, and the result is an extent that covers the extent matched by B and an extent matched by A if the extent matched by A causes or is the cause of extent matched by B. Thus possible patterns include, but are not limited to: B due to A, B owing to A, B as a result of A, B resulting from A, B on account of A, B was caused by A, A caused B, and A lead to B.

Within Operator-based Concept generation, a user may be prompted for one or more text fragments, which the system then splits into words. The user manually selects relevant words in the text fragments (default selection is available), then manually adds synonyms, hypernyms, and hyponyms for any selected relevant word (default selections of key words, synonyms, and hypernyms are available).

Thus within Operator-based Concept generation, not only can words be used together with Operators as the basis of a generated Concept, but also their synonyms, hypernyms (more general words), or hyponyms (more specific words), a text fragment (such as a phrase), and also a negative thing, or negative action. The generation of synonyms can, but does not necessarily need to, use the method and system described in Turcato et al. (2001).

The user is then asked for names of Concepts that need to be combined into a new Concept, and selects Operators from a set of available Operators including, but not limited to those listed and described above.

Operator-based Concept generation then performs an integrity check on every candidate comprising an Operator and zero or more Arguments, and converts into a chain every acceptable candidate comprising an Operator and zero or more Arguments. Chains are written out as a Concept. The Concept is output into a file with certain Directives attached, including but not limited to:
a) naming the Concept produced when chains are written out,
b) naming the CSL file for said Concept,
c) selecting whether said Concept is visible or hidden for matching purposes, and
d) selecting whether said CSL file is encrypted or not.
   2.3.5.6.4.2. External Concept-Based Concept Generator

The external Concept-based Concept generator uses Concepts that are imported into the system from outside of it. These Concepts can either supplement existing internal Concepts or replace them. They may be obtained by various means including e-mail and collection from a website. These Concepts are likely produced by a person with specialized knowledge of CSL, probably at the request of the user of the Concept processing engine.

2.3.5.6.4.3. Internal Concept-Based Concept Generator

The internal Concept-based Concept generator is for use by people with knowledge of the internals of CSL. This generator takes a copy of one or more source Concepts plus instructions on how to adapt those Concepts and generates a new Concept from the source Concept(s).

2.3.6. Concept/CSL Management

This section on Concept/CSL Management comprises the following subsections: User Concept Groups and user-defined hierarchies, Concept database, and Concept manager (including Concept database administrator and Concept editor).

2.3.6.1. User Concept Groups and User-Defined Hierarchies

User Concept Groups (UCGs) are a control structure that can group and name a set of Concepts. UCGs allow users to create Concepts that refer to named groups of Concepts or Patterns or other groups without knowledge of the internals of CSL.

The following constructs are permissible in CSL:

```
group <GroupName> {
    %<ConceptName1>
    %<ConceptName2>
    ...
    %<GroupName1>
    %<GroupName2>
}
```

User-defined hierarchies are taxonomies or hierarchies of Concepts, grouped by various criteria. These criteria include type of UCD, use of a particular Concept or Pattern, and membership of a particular subject domain.

(A set of UCGs can be extracted from any set of Concepts or Patterns. The structure of UCGs reflects the structure of “includes” statements in the file containing those Concepts.)

2.3.6.2. Concept Database

The Concept database is a repository for storing Concepts and data structures for generating Concepts including user Concept descriptions (UCDs), user Concept groups (UCGs), and user-defined hierarchies. Both uncompiled and compiled Concepts are stored within the Concept database. The database can flag compiled Concepts that are ready for annotation, that is, ready for use by the annotator to Conceptually annotate documents or text fragments. Inputs to and outputs from the Concept database are controlled (and mediated) by the Concept database administrator component of the Concept manager.

2.3.6.3. Concept Manager

The Concept manager comprises a Concept database administrator and Concept editor.

2.3.6.3.1. Concept Database Administrator

The Concept database administrator is responsible for loading, storing, and managing uncompiled and compiled Concepts, UCDs and UCGs in the Concept database. The administrator manages any UCD graphs. It is responsible for loading, storing, and managing compiled Concepts ready for annotation and for generation.

The administrator also allows users to view relationships among UCDs, UCGs, and Concepts in the database.

The administrator allows users to search for Concepts, UCDs, and UCGs. It also allows users to search for the presence of Concepts in UCDs and UCGs. And it allows users to search for dependencies of UCDs and UCGs on Concepts. Through the administrator, UCDs can be queried for dependencies on other Concepts.

The administrator is capable of managing a set of CSL files that correspond to UCGs and UCDs stored in it. (That is, the database keeps an up-to-date set of CSL files and knows what CSL files correspond to what UCDs and UCGs.) The CSL files are kept up to date with the changing definitions of Concepts, UCDs, and UCGs. The database also guarantees the consistency of stored UCDs and UCGs.

The database administrator checks the integrity of Concepts, UCDs, and UCGs (such that if A depends on B, then B can not be deleted. The administrator handles dependencies within and between Concepts, UCDs, and UCGs.

The administrator makes sure the Concept database always contains a set of Concepts, UCDs, and UCG that are logically consistent and consistent such that those sets can be compiled.

The administrator allows functions performed by the Concept editor to add, remove, and modify Concepts, UCDs, and UCGs in the Database without fear of breaking other Concepts, UCDs, or UCGs in the same database.

2.3.6.3.2. Concept Editor

The Concept editor allows users to view relationships among Concepts, UCDs, and UCGs in the Concept database.

The Concept editor allows users to search for Concepts, UCDs, and UCGs. The editor allows users to search for the presence of Concepts in UCDs and UCGs. The editor also allows users to search for dependencies of UCDs and UCGs on Concepts.

The Concept editor allows users to add, remove, and modify all types of Concept (if users have appropriate permissions). The editor allows users to add, remove, and modify all the types of UCD shown in Table 1, except the basic UCD. Permissions are pre-set so that only certain privileged users can edit unpopulated UCDs.

The Concept editor allows users to users save a UCD under a different name, and can also change any other properties they like.

The Concept editor allows users to add, remove, and modify User Concept Groups (UCGs). The editor allows users to save a UCG under a different name. Users can also change a Concept Group name, description, and any other properties they like in UCGs.

Because of the Concept database administrator, users can add, remove, and modify UCDs and UCGs in the database without fear of breaking other Concepts, UCDs, or UCGs in the same database. Suppose a user attempts to remove Concept B from “Concept A {B|C}” (i.e., Concept A consists of Concept B or Concept C). The user is warned that the Concept A will stop working when Concept B is deleted.

The Concept editor allows users to add, remove, and modify user-defined hierarchies.

2.3.7. CSL Parser (and Compiler)

The CSL parser takes as input synonyms from a processed synonym resource (if available) and Concepts from the Concept database through the Concept manager. (It can also take as input Patterns and CSL queries.) The parser includes a CSL compiler and engages in word compilation, Concept compilation, downward synonym propagation, and upward synonym propagation. Both Concepts and UCGs can be compiled.

The parser outputs compiled or uncompiled Concepts, UCGs, and UCDs to the Concept manager which are then stored in the Concept database. (It also outputs Patterns.) Those Concepts may be used as input for generation (depicted as box 13 in FIG. 3) or annotation. The CSL parser is described in Fass et al. (2001).

2.3.8. Interaction Between Concept Wizard Display and UCD Graph

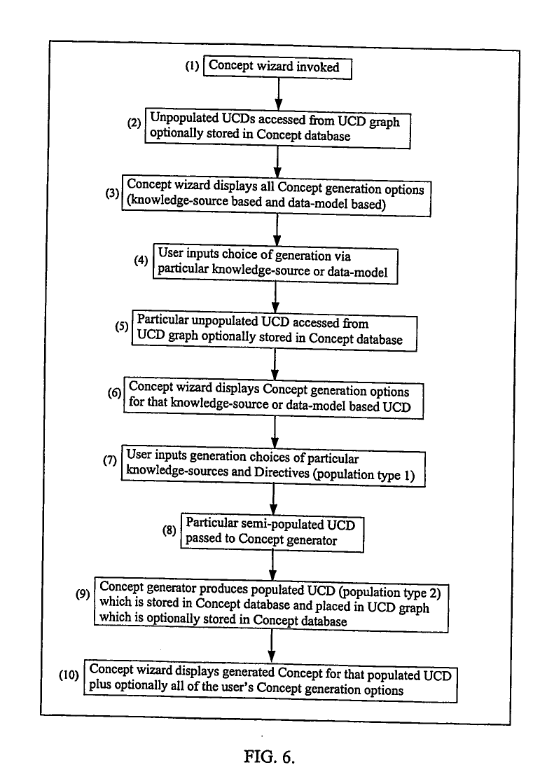

FIG. 6 shows the interaction between the Concept wizard display and graph of UCDs optionally stored in the Concept database. The interaction is depicted as series of method steps. Initially, the Concept wizard is invoked (step 1), which calls upon the unpopulated UCDs that are hierarchically represented in a UCD graph which is optionally stored in the Concept database (see FIG. 4) (step 2). The Concept wizard then displays to the user all the (knowledge-source based and data-model based) Concept generation options, extracted from those unpopulated UCDs (step 3). The user inputs into the Concept wizard his or her choice of Concept generation by selecting a particular knowledge-source or data-model as the basis for generation (step 4). The unpopulated UCD corresponding to the user's choice is then accessed from the UCD graph optionally stored in the Concept database (step 5). For example, if the user opted for a text fragment (knowledge source) based approach to Concept generation, then the UCD for that approach is accessed from the UCD graph.

The Concept wizard then displays to the user the Concept generation options for that knowledge-source or data-model based UCD (step 6). The user inputs generation choices of particular knowledge-sources and Directives (population type 1 in FIG. 4) (step 7). The particular semi-populated UCD is then passed to the Concept generator (step 8), which generates a Concept as part of producing a populated UCD (population type 2 in FIG. 4) which is stored in the Concept database. The populated UCD is also placed in the UCD graph which is optionally stored in the Concept database (step 9). The Concept wizard then displays to the user the generated Concept for that populated UCD plus optionally all of the user's Concept generation options that led to the generation of that particular Concept (step 10).

3. Concept Specification Language

This section contains a description of the key elements of the Concept Specification Language (or CSL) and how those elements are combined to define Concepts. CSL is a language for expressing linguistically-based patterns. Besides Concepts, CSL is comprised of two other main elements: Patterns and Directives.

3.1. Concepts

A Concept in CSL is used to represent any idea, or physical or abstract entity, or relationship between ideas and entities, or property of ideas or entities.

A Concept is fully recursive; in other words, Concepts can (and do) call other Concepts. Concepts can either be global or internal to other Concepts.

A Concept comprises a Concept Name, a Pattern, and one or more optional Directives.

3.2. Patterns

Patterns are fully recursive, subject to Patterns satisfying the Arguments of their Operators. In other words, patterns can (and do) recursively call Patterns. Patterns are comprised of an optional Pattern Name internal to a Concept followed by another Pattern. A Pattern Name assigns a name to the extents that are produced by a Pattern.

Patterns are of various types. These types include, but are not limited to, Basic patterns, Operator Patterns, Concept Calls, and Parameters. (There is implicitly a grammar of such Patterns). These types are now described.

3.2.1. Basic Patterns

A Basic Pattern contains a description sufficiently constrained to match zero or more “extents.” Each of these extents in turn comprises a set of zero or more items in which each of those items is an instance of a “linguistic entity.”

Each of those instances of a linguistic entity is identified in either
a) the text of documents and other text-forms, or
b) knowledge resources (such as WordNet™ or repositories of Concepts); or
c) both a) and b).

The Basic Pattern is matchable to zero or more of the extents corresponding to the description.

A description that is “sufficiently constrained” is one that contains linguistic constraints adequate to match just those extents (and thus linguistic entities) that are sought. For example, if the linguistic entity sought was a word, then the constrained description d*g would match various words such as dog, drug, and doing (assuming asterisk connoted a string of alphanumeric characters of any length).

Each linguistic entity can comprise:
a) a morpheme such as an affix or suffix (hence strings such as pre-, post-, -s, -'s, or -ing can all be linguistic entities);
b) a word or phrase;
c) one or more lexically-related terms in the form of synonyms, hypernyms, or hyponyms (for example, a linguistic entity could be synonyms of dog such as hound, or hypernyms of dog such as mammal and animal);
d) a syntactic constituent or subconstituent;
e) any expression in a linguistic notation used to represent phonological, morphological, syntactic, semantic, or pragmatic-level descriptions of text (for instance, syntactic trees or syntactic labelled bracketing such as part of speech, lexical, and phrasal tags); or
f) any combination of one or more of the preceding linguistic entities.

Note that “instances” of a linguistic entity could include, though not be limited to
a) multiple instances of the same linguistic entity (e.g., two instances of the word dog) as well as
b) multiple instances of different linguistic entities (e.g., an instance of the word cat and an instance of the word dog).

The identification of linguistic entities in text of documents and other text-forms may be performed before Concept matching (for example, in producing a linguistically annotated text) or during Concept matching (i.e., the Concept matcher searches for linguistic entities on as as-needed basis).

When a linguistic entity is identified from the aforementioned text of documents and other text-forms, then a record is made that the linguistic entity starts in one position within that text and ends in a second position.

Recording the start and end of extents is important for telling apart cases where the same linguistic entity occurs twice in a text. For example, suppose the extent to be identified in the following sentence was a set of one or more linguistic entities comprised of the words the and dog.

The small dog bit the large dog.

It is necessary to identify the following entities and their start and end positions (here in terms of the number of characters from the start of the sentence)—The(1,3), dog(11,13), the(19,21), dog(29,31)—in order to uniquely identify each identified instance of the and dog.

Start and end positions can also be used to identify the other types of linguistic entities. For example, if the linguistic entity was synonyms of the noun hound, and such synonyms were sought in the preceding sentence, then the start and end points would be (11,13) and (29,31), the same as those for the two instances of dog.

To give another example, if the preceding sentence was linguistically annotated with syntactic tags such as the phrasal tag #NX (noun phrase), then #NX would be associated with start and end points (1,13) and (19,31), the same as those for the constituents (and noun phrases) The small dog and the large dog. Note that additional useful positional information to be recorded about extents is position in a parse tree (such as depth in the tree), hence in the example linguistically annotated version of The small dog bit the large dog, such additional information is that, assuming the part-of-speech tag /NX is for a noun, then dog (/NX) (11,13) is part of The small dog (#NX) (1,13).

Linguistic entities can also be identified in knowledge resources such as WordNet™ and other language resources such as other machine-readable dictionaries and thesauri; repositories of Concepts; and any other resources from which linguistic entities, as just defined, might be identified. In this way, useful information can be extracted that aids in matching the text of documents and other text-forms.

3.2.2. Operator Patterns

A second type of Pattern is an Operator Pattern, which contains an Operator and a list of zero or more Arguments where each of those Arguments is itself a Pattern. The Operator Pattern is matchable to the extents that are the result of applying the Operator to those extents that are matchable by the Arguments of the Operator.

Operators express information including, but not limited to, linguistic information and Concept match information. Linguistic information includes punctuation, morphology, syntax, semantics, logical (Boolean), and pragmatics information.

The Operators can have from zero to an unlimited number of Arguments. Zero-Argument Operators express information including, but not limited to:
a) match information such as NIL;
b) syntax information such as Punctuation, Comma, Beginning_of_Phrase, End_of_Phrase; and
c) semantic information such as Thing, Person, Organization, Number, Currency.

One-Argument Operators express information including, but not limited to:
a) match information such as Smallest_Extent(X), Largest_Extent(X), Show_Matches(X), Hide_Matches(X), Num_Matches_Reqd(X);
b) tense such as Past(X), Present(X), Future(X);
c) syntactic categories such as Adverb(X) and Noun_Phrase(X);
d) Boolean relations such as NOT(X);
e) lexical relations such as Synonym(X), Hyponym(X), Hypernym(x); and
f) semantic categories such as Thing(X), Currency(X), Object(X), Does_Not_Contain(X).

Two-Argument Operators express information including, but not limited to:
a) relationships within and across sentences such as In_Same_Sentence_With(X,Y);
b) syntactic relationships such as Immediately_Precedes(X,Y), Immediately_Dominates(X,Y), NonImmediately_Precedes(X,Y), NonImmediately_Dominates(X,Y);
c) syntactic relationships such as Noun_Verb(X,Y), Subj_Verb(X,Y), Verb_Obj(X,Y);
d) Boolean relations such as AND(X,Y), OR(X,Y); and
e) semantic relationships such as Associated_With(X,Y), Related(X,Y), Modifies(X,Y), Cause_And_Effect(X,Y), Commences(X,Y), Terminates(X,Y), Obtains(X,Y), Thinks_Or_Says(X,Y).

Example three-argument Operators include, but are not limited to, Noun_Verb_Noun(X,Y,Z), Subj_Verb_Obj(X,Y,Z), Subj_Passive_Verb_Obj(X,Y,Z).

Definitions of the two-Argument Operators NonImmediately_Dominates(X,Y), Dominates (X,Y), NonImmediately_Precedes(X,Y), Precedes(X,Y), Related(X,Y), and Cause(X,Y) were given in section 2.3.5.6.2.1.

The two-Argument Operator NonImmediately_Dominates(X,Y) can be “wide-matched.” In that wide-matching
a) X matches any extent;
b) Y matches any extent; and
c) the result is the extent matched by X if all the linguistic entities of Y's extent are subconstituents of all the linguistic entities of X's extent.
   3.2.3. Concept Calls

A third type of Pattern is a Concept Call. One form of Concept Call contains a reference to a Concept (referred to below as a “Referenced Concept”) that in turn contains a Pattern. In such a case, the Concept Call is matchable to the extents that are matchable by that Pattern.

A second form of Concept Call contains a reference to a Concept (again a “Referenced Concept”) and also contains a list of zero or more Arguments, where each of those Arguments is a Pattern. In this case, also known as a Parameterized Concept Call, a Concept Call is matchable to the extents that are matchable by the Pattern of the Referenced Concept, where any Parameters in the Referenced. Concept are bound to the Patterns in the list of zero or more Arguments that were part of the Concept Call. (The notion of a “Parameter” is explained in the next section.)

3.2.4. Parameters

A fourth type of Pattern is a Parameter. A Parameter is matchable to the extents matched by any Pattern that is bound to that Parameter. (Any Pattern can be bound to a Parameter.)

Parameters give rise to the notion of a Parameterized Concept which contains one or more Patterns of the example form:

concept Concept_Name {
2Arg_Operator1 ( $<Number1> 2Arg_Operator2 $<Number2> )
}

Examples of $<Number> are “$1” and “$2”—these are the Parameters. (There are also Non-Parameterized Concepts.)

3.3. Directives

A Directive is a property of a Concept. Directives of Concepts include, but are not limited to:
a) whether successful matches of the Concept against text are “visible”;
b) the number of matches of a Concept required in a document for that document to be returned;
c) the name of the Concept (that is, the Concept Name) that is being generated;
d) the name of the file into which that Concept is written; or
e) whether or not that file is encrypted.

Combinations of Directives are also possible.

Being able to control the “visibility” of successful matches of a Concept is useful in a number of applications, including but not limited to, he types of Concept matches shown
a) in the annotated output of matched text, and
b) during run-time examination of the Concept matching algorithm when it is identifying Concepts in text.

The number of matches of a Concept required in a document for a document to be returned is useful in, for example, information retrieval applications.

Appendix A. Example User Interfaces

The user interfaces below are presented to users by way of the abstract user interface (see FIG. 3). The abstract user interface, when used for Concept generation, is “populated” by a Concept wizard which is in turn “populated” by with information from UCDs. One such population method is that described in section 2.3.8, whereby the Concept wizard obtains display information from the graph of UCDs optionally stored in the Concept database.

The abstract user interface, when used for Concept management and editing, is “populated” by the Concept manager.

Note that each of these examples differs in small ways from the preferred embodiment described in section 2, but illustrate the present invention. Appendix A.2.2.2 contains an illustration of the example maker, for instance.

Appendix A.1. Concept Wizard as Command Line Interface (Featuring Text-Based Generation with Linguistic Data Model)

The following Concept wizard first offers the user a set of high-level choices about how to generate Concepts, then uses the Concept wizard for text-based generation to guide the user through Concept generation from a text fragment. The interface is a command line that is called up at the DOS prompt (though any operating system with a command line interface could use this interface).

This Concept wizard is useful for illustrating the interaction of the Concept wizard display with the UCD graph optionally stored in the Concept database. Those ten steps of interaction are added below as annotations within square brackets.

[Step (1) of Concept wizard-UCD graph interaction: the Concept wizard is invoked.]
C:\Apps\ConGen\debug> ConceptGenerator

[Step (2): Concept wizard calls upon unpopulated UCDs in UCD graph.]
Opening engine . . .

[Step (3): The Concept wizard displays to the user all the (knowledge-source based and data-model based) Concept generation options.]
Enter CSL file (or nothing if done): <Return>
Select the way to make a Concept:
   1) Using a particular knowledge source
      11) Text-based knowledge source
         111) Vocabulary
         112) Text
         113) Documents
      12) Linguistics-based knowledge source
         121) Vocabulary specifications
         122) Lexical relations (e.g., synonyms, hypernyms, hyponyms)
         123) Grammar items
         124) Semantic entities
      13) CSL-based knowledge source
         131) Grammar specifications
         132) Semantic entity specifications
         133) CSL Operators
         134) Internal database Concepts
         135) External imported Concepts
      14) Statistics-based knowledge source
         141) Word frequency data
   2) Using a particular data-model
      21) Statistical model
      22) Rule-based model
         221) Linguistic model
         222) Logical model
   0) Quit

[Step (4): The user inputs his or her choice of Concept generation by selecting a particular knowledge-source or data-model as the basis for generation.]
Enter your selection and press Enter: 112
Concept name: <Return>

[Steps (5-7): The unpopulated UCD corresponding to the user's choice is accessed from the UCD graph. The Concept wizard displays the Concept generation options for that knowledge-source or data-model based UCD. The user inputs generation choices of particular knowledge-sources and Directives.]
Concept name: nuclear-capability
Concept description (or blank):
Concept visible for annotation? (Y/N) N
Enter text fragment (or nothing):
nuclear capability
Relevant words in text fragment:
   0) nuclear
   1) capability
Enter your selections and press Enter: 0 1
Use literal ‘nuclear’? (Y/N) Y
Use synonyms of ‘nuclear’? (Y/N) Y
Synsets to use:
   0) ((physics) “nuclear physics”; “nuclear fission”; “nuclear forces”)
   1) ((biology) “nuclear membrane”)
   2) (constituting or like a nucleus; “annexation of the suburban fringe by the nuclear metropolis”; “the nuclear core of the congregation”)
   3) ((of power and warfare and weaponry) using atomic energy; “nuclear (or atomic) submarines”; “nuclear war”; “nuclear weapons”; “atomic bombs”)
Enter your selections and press Enter: 3
Information for synset ((of power and warfare and weaponry) using atomic energy; “nuclear (or atomic) submarines”; “nuclear war”; “nuclear weapons”; “atomic bombs”)
No of hyper levels (0=blank=do not use, −1=use all): 0
No of hypo levels (0=blank=do not use, −1=use all): 0
Use literal ‘capability’? (Y/N) Y
Use synonyms of ‘capability’? (Y/N) Y
Synsets to use:
   0) (the susceptibility of something to a particular treatment; “the capability of a metal to be fused”)
   1) (the quality of being capable—physically or intellectually or legally, “he worked to the limits of his capability”)
   2) (an aptitude that may be developed)
Enter your selections and press Enter: 2
Information for synset (an aptitude that may be developed)
No of hyper levels (0=blank=do not use, −1=use all): 0
No of hypo levels (0=blank=do not use, −1=use all): 0
Enter text fragment (or nothing):
Include file (or nothing):
Select the data model with which to create Concept:
   1) Statistical model
   2) Rule-based model
      21) Linguistic model
      22) Logical model
   0) Quit
Enter your selection and press Enter: 21

[Steps (8-10): The particular semi-populated UCD is passed to the Concept generator, which generates a Concept as part of producing a populated UCD. The Concept wizard displays to the user the generated Concept for that populated UCD.]

Concept created.

/*
* The following Concept [Definition] has been auto-generated
by Concept processing engine.
* Description: Not available
*/
#include “header_light.csl”
hidden Concept nuclear-capability {
(
/*
* Contribution from text fragment
* nuclear capability
*
* Word indexes, relevancy, and parts of speech:
* nuclear (0+JJ) capability (1+NN)
*
* Concept matches:
* [0-1] adj_noun_args(nuclear, capability)
* [0-0] adjective_args(nuclear)
* [1-1] noun_args(capability)
*
*/
$adj_noun((@@″[linguistic resource]:a:576833″)/* ((of power
and warfare and weaponry) using atomic energy; “nuclear (or atomic)
submarines”; “nuclear war”; “nuclear weapons”; “atomic bombs”) *//ADJ,
(@@″[linguistic resource]:n:4354522″)/* (an aptitude that may be
developed) *//NOMINAL)
)
}

Appendix A.2. Example Graphical User Interface for Concept Management and Generation
Appendix A.2.1. Example Graphical User Interface for Concept Management

One page of this example user interface is for Concept management. The page provides a list of Concepts, UCDs, UCGs, and links to make searches, and edit and delete them.

Concepts, UCDs, and UCGs

| Name | Description | Refers to . . . | Compiled |
|---|---|---|---|
| Concept 1 | Description 1 . . . | □ | N |
| Concept 2 | Description 2 . . . | □ | Y |
| Concept 3 | Description 3 . . . | □ | N |
| Concept 4 | Description 4 . . . | □ | Y |
| . . . | | | |
| UCD 1 | Description 1 . . . | □ | |
| UCD 2 | Description 2 . . . | □ | |
| UCD 3 | Description 3 . . . | □ | |
| UCD 4 | Description 4 . . . | □ | |
| . . . | | | |
| UCG 1 | Description 1 . . . | □ | N |
| UCG 2 | Description 2 . . . | □ | N |
| UCG 3 | Description 3 . . . | □ | N |
| UCG 4 | Description 4 . . . | □ | Y |
| . . . | | | |

[ShowConceptHierarchy button] [ShowUCDGraph button]
[SearchForSelectedConcepts button] [SearchForSelectedUCDs button] [SearchForSelectedUCGs button]
[CompileSelectedConcepts button] [CompileSelectedUCGs button]
[UncompileSelectedConcepts button] [UncompileSelectedUCGs button]
[EditSelectedConcepts button] [EditSelectedUCDs button] [EditSelectedUCGs button]
[RemoveSelectedConcepts button] [RemoveSelectedUCDs button] [RemoveSelectedUCGs button]
[ResetConcepts button] [ResetUCDs button] [ResetUCGs button]
   Clicking on any of the Concept names in the table brings up the Concept wizard populated with the specified Concept.
   ShowConceptHierarchy button displays a pop-up window with a graphical tree representation of a Concept where only OR operations of expandable Concepts are expanded. Other Concepts (non-expandable or those not created using OR) are shown as “compound Concepts.”
   SearchForSelectedConcepts button verifies that the existing Concept definitions are consistent (e.g., a Concept doesn't use another Concept that was deleted). If the definitions are OK, the system returns search results.
   RemoveSelectedConcepts button removes Concepts that are checked and reloads the page.
   ResetConcepts button removes all existing Concepts, replaces them with the original list of Concepts, and reloads the page.
      Appendix A.2.2. Example Concept Wizard Graphical User Interface

Add new Concept
Knowledge-source based
   Text-based knowledge source
      Vocabulary
      Text
      Documents
   Linguistics-based knowledge source
      Vocabulary specifications
      Lexical relations (e.g., synonyms, hypernyms, hyponyms)
      Grammar items
      Semantic entities
   CSL-based knowledge source
      Grammar specifications
      Semantic entity specifications
         CSL Operators
         Internal database Concepts
         External imported Concepts
      Statistics-based knowledge source
         Word frequency data
   Data-model based
      Statistical model
      Rule-based model
         Linguistic model
         Logical model
            [Create button]
* The Create button takes the user to a Concept wizard interface populated with default values for the knowledge source or data model selected, taken from the UCD for that knowledge source or data model in the UCD graph.
   Appendix A.2.2.1. Example Concept Wizard for Operator-Based Concept Generation

This Operator-based Concept wizard allows for inclusions and exclusion of a number of Concepts and operations on or between included Concepts.

| Include | Exclude | Ignore | Name | Description |
|---|---|---|---|---|
| 0 | 0 | 0 | Concept 1 | Description 1 |
| 0 | 0 | 0 | Concept 2 | Description 2 |
| 0 | 0 | 0 | Concept 3 | Description 3 |
| 0 | 0 | 0 | Concept 4 | Description 4 |

Choose operation
   AND
   OR
   ANDNOT
   Immediately Precedes
   Precedes
   Immediately Dominates
   Dominates
   Related
   Cause
Choose document level tags
   #subject
   #from
   #to
   #date
[Back button] [Finish button]
   Further user interface pages guide the user through further steps of Concept generation, depending on the Operator(s) chosen by the user.
      Appendix A.2.2.2. Example Concept Wizard for Text-Based Concept Generation (and Example Maker)

The following example user interface for text-based Concept generation allows for the following task flow:
The user inputs one or more text fragments.
The user selects relevant words and phrases.
The user selects relevant synonyms, hypernyms, and hyponyms for each of the relevant words.
The definition of the Concept is generated.
The Concept definition is displayed.
The example maker is called to display a list of examples that can be matched by the given Concept.

FIG. 7 shows the entry of one or more text fragments that contain the desired Concept. This window is equivalent to step 1 of the algorithm for text-based Concept generation (with the linguistic model) shown in section 2.3.5.6.2.

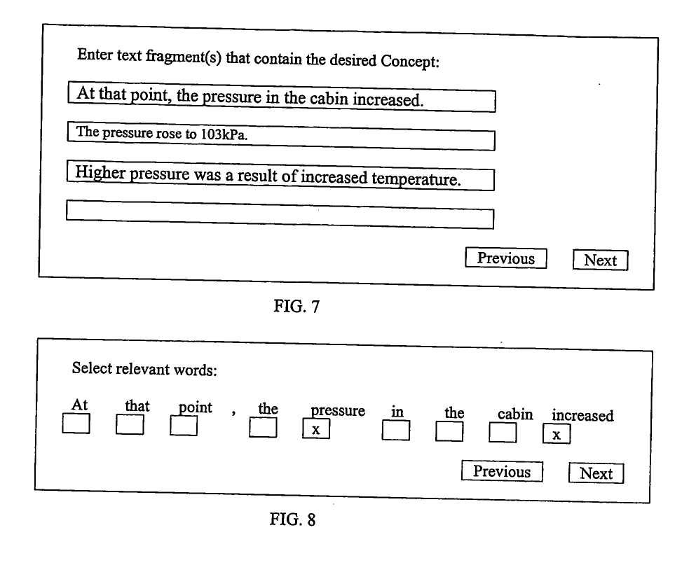

Those text fragments are split into words. In FIG. 8, the sentence At that point, the pressure in the cabin increased has been broken into words and the user has selected two relevant words, pressure and increased. This window is equivalent to steps 2 and 3 of the earlier algorithm for text-based Concept generation.

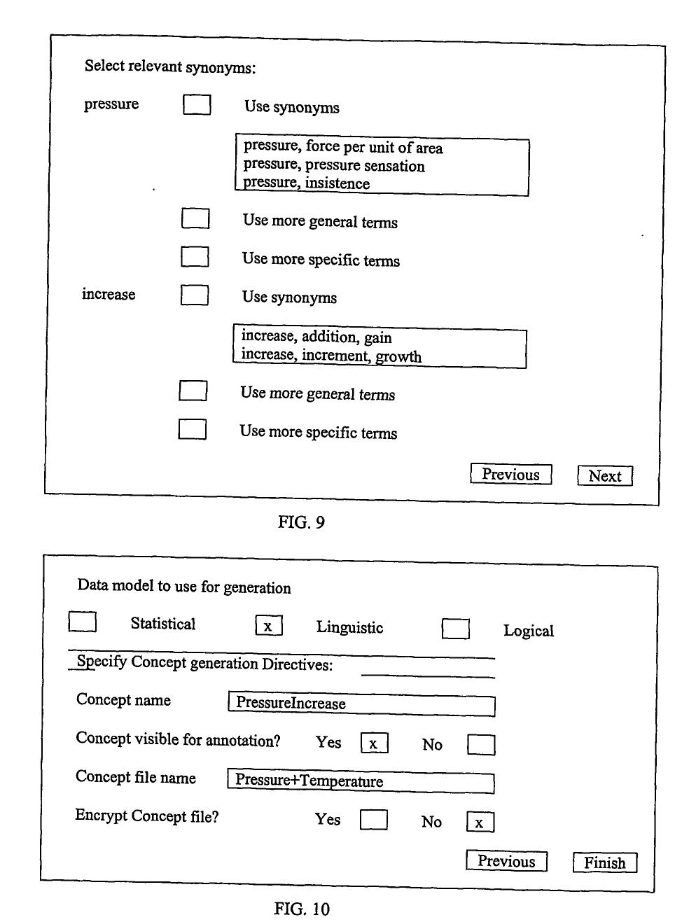

In FIG. 9, the user is asked to select synonyms, hypernyms, and hyponyms for lemma forms of the two relevant words, pressure and increased. This window is equivalent to step 4 of the text-based Concept generation algorithm.

In FIG. 10, the user is asked to select the data model to be used for generation (the user has chosen the linguistic model), name of the Concept to be generated (the user has opted for PressureIncrease), whether or not the Concept is to be visible for annotation (identification) purposes (the user has marked Yes), the name of the file that will contain the Concept (Pressure+Temperature), and whether or not to encrypt that file (No). This window is largely equivalent to step 10 of the text-based Concept generation algorithm.

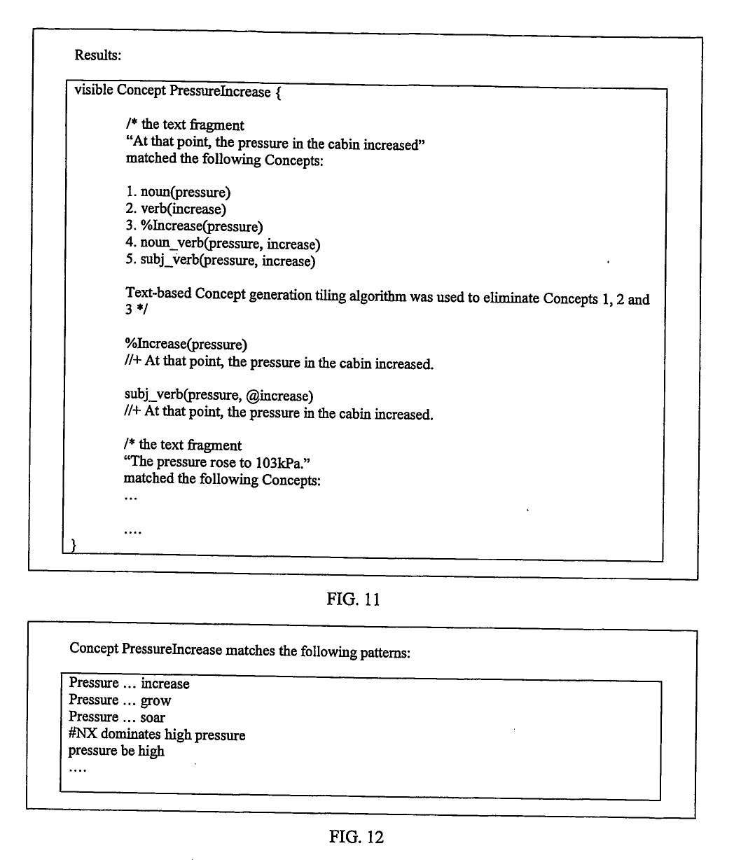

FIG. 11 shows the resulting PressureIncrease Concept. FIG. 12 shows the results returned by the example maker when run against the PressureIncrease Concept.

Appendix A.2.3. Concept Wizard as Pop-Up Windows for Concept Generation

In this section, two different user interface designs for a Concept wizard are described, consisting of pop-up windows within some application. In these interfaces, the word “Rule” or phrase “Concept Rule” is equivalent to a “Pattern” as described in Section 3 and elsewhere in this disclosure.

Appendix A.2.3.1. Concept Wizard as Pop-Up Windows for Multiple Types of Concept Generation

In this first application, pop-up windows are shown for Operator-based, text-based, semantic entity-based, and internal Concept-based Concept generation,

Appendix A.2.3.1.1. Concept Wizard as Pop-Up Windows for Operator-Based Concept Generation

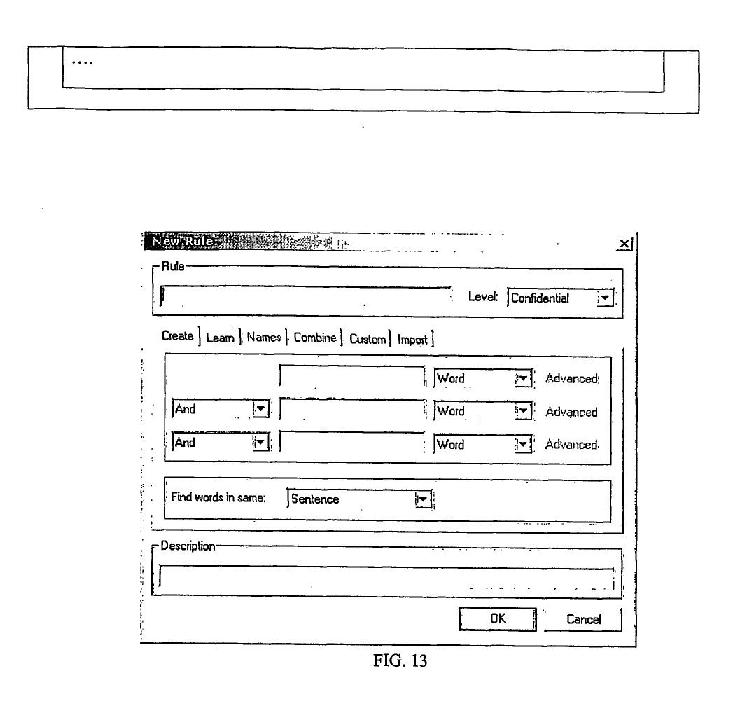

FIG. 13 shows the “New Rule” [Pattern] pop-up window. This window is equivalent to a Concept wizard for Concept generation in general. The Create panel of this window has an upper and lower part. The upper part has four columns in the system. The lower part specifies whether words should be found together in the same sentence or the same document. Note that if the “Find words in the same: Document” option is chosen, then the whole document is shown as having matched a Concept.

The first column of the upper part contains scroll-down menus listing the following Operators: And, Or, Not, Precedes, Immediately Precedes, Related, and Cause. These Operators link together items from the key word boxes in the second column.

The Operators And, Or, and Not are the standard Boolean Operators. The remaining Operators are defined the same as the Operators in section 2.3.5.6.2.1.

The second column of the upper part contains key word boxes which can be used to specify one or more relevant key words. Words separated by a comma indicate an OR (so for example “A B, C D” means match “A B” or “C D”). Words separated by spaces are assumed to Immediately Precede each other.

The third column of the upper part contains scroll-down menus listing the following options: Word, Synonyms, More General (i.e., a hypernym), More Specific (i.e., a hyponym), Phrase, and Advanced. These options allow the user to define Concepts using not only words, but also their synonyms. The user can further specify whether synonyms are more specific (e.g., taxicab is more specific than car, poodle is more specific than dog), or more general (e.g., vehicle is more general than car; mammal is more general than dog). Selecting Phrase tells the system to consider the words surrounding the targeted word. The list options Word, Synonyms, and so on apply to each word in the corresponding key word box individually.

The Synonyms option lets the user specify sets of synonyms for each word in the corresponding key word box in the second column. Advanced lets the user specify a combination of the features Word, Synonyms, More General, More Specific, and Phrase.

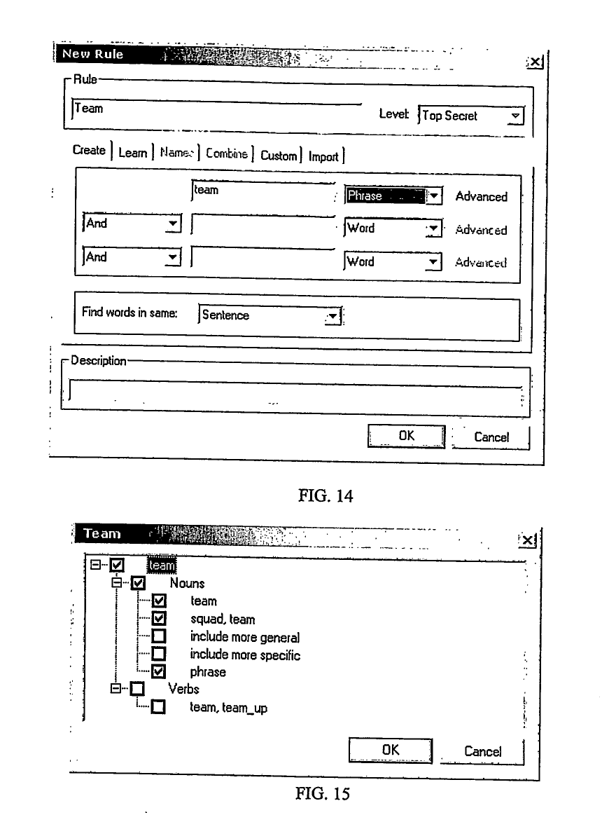

For example, suppose a user wanted to create a Rule (Pattern) for checking on various teams that were involved in a particular project. FIG. 14 shows the basic elements of the Rule. It has been given the name Team and assigned the security level Top Secret. It is built around the word team as part of a Phrase.

If nothing further is done, then the Team Rule will look for the word team as part of a phrase. The user can also choose synonyms for team by clicking on Advanced in the fourth column.

FIG. 15 shows the Advanced pop-up window for synonyms of team (which appears when Advanced in the fourth column of FIG. 14 is clicked). Suppose the user is only interested in team as a noun, so s/he deselects all the verb synonym sets. The user also checks the box beside Phrase and clicks OK.

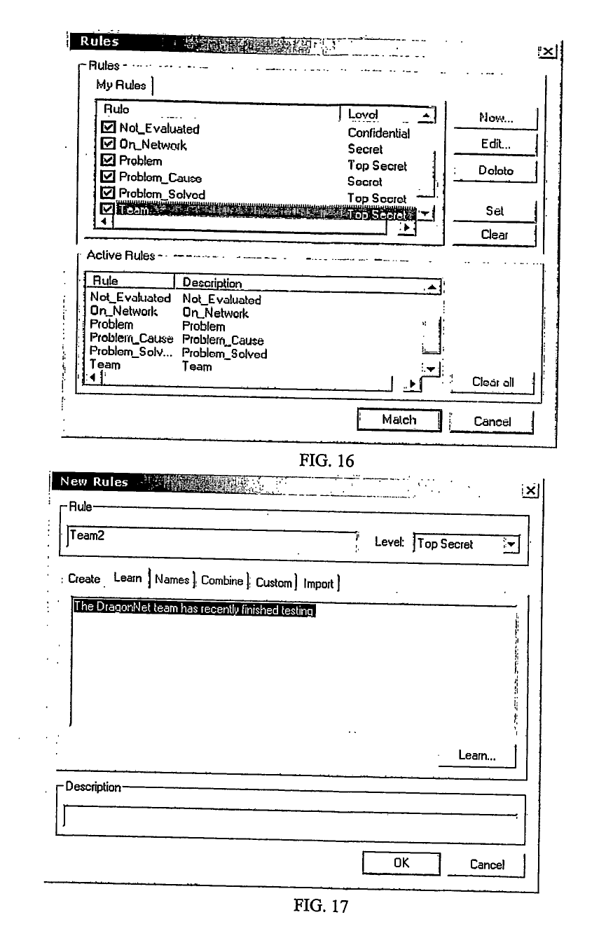

Next, the user clicks OK on the “New Rule” [Pattern] window. The Team rule has now been created and is available for matching (see FIG. 16).

To edit the Team Rule [Pattern], the user highlights the rule in FIG. 16 and clicks on the Edit button.

Appendix A.2.3.1.2. Concept Wizard as Pop-Up Windows for Text-Based Concept Generation

The Learn tab (of FIG. 13, FIG. 14, and FIG. 17) permits a user to define a Concept based on a user-selected fragment of text.

The user can employ the Learn tab to automatically create a Rule (Pattern) called Team2 from a text fragment highlighted in some document. Team2 will match the same text as Team. (The Team2 example is presented here to show that this Rule can be created automatically.)

To create the Team2 rule, the user highlights the text fragment The DragonNet team has recently finished testing, clicks on the Edit Rules icon, clicks on the New button, and selects the Learn tab. The highlighted phrase has already been loaded in FIG. 17. The user gives the new rule (Pattern) the name Team2 and assigns it the security level Top Secret.

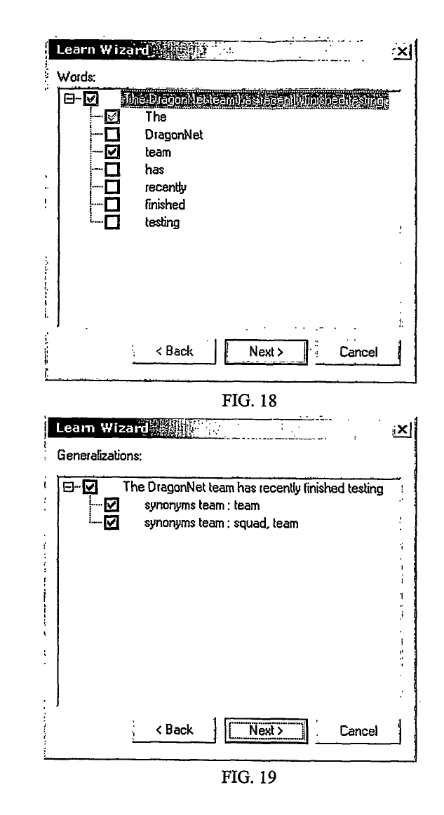

The system presents a Learn Wizard pop-up window which allows the user to choose the words in the text fragment most relevant to their rule (see FIG. 18). The user checks the boxes for the and team (this allows the user to generalize from the specific phrase DragonNet team); then clicks on the Next button.

The system presents a new Learn Wizard pop-up window for the synonyms of selected nouns and verbs (see FIG. 19). Both sets of synonyms for team are applicable, so the user must ensure that they are both checked, then click on the Next button.

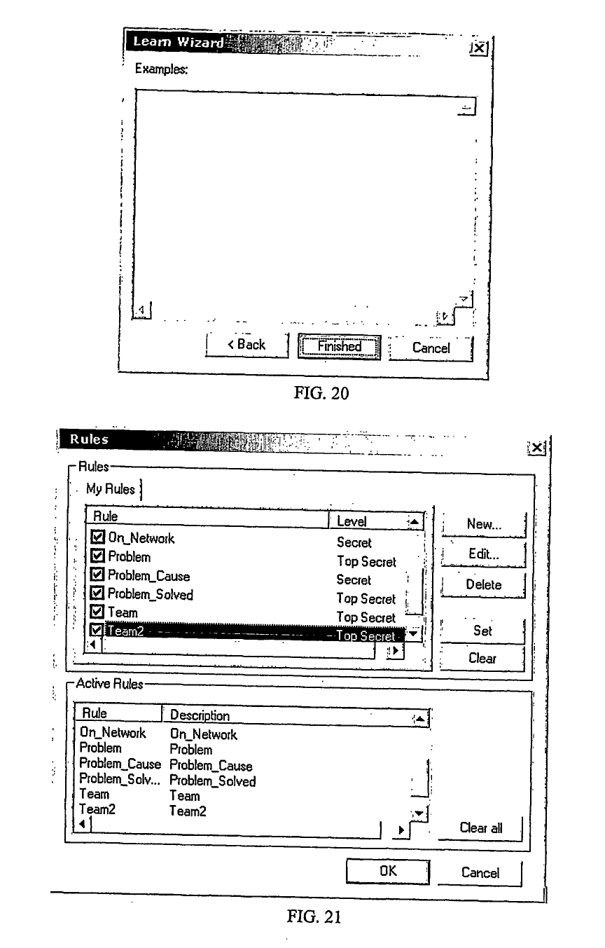

The system presents a third Learn Wizard pop-up window (see FIG. 20). This window displays a selection of text fragments similar in meaning and structure to the sample given by the user (see FIG. 20). The user completes this type of Concept generation by clicking on the Finished button.

The user clicks OK on the “New Rules” (Patterns) window (FIG. 17) and the “Rules” window re-appears, with Team2 now added as a new Rule (see FIG. 21).

Appendix A.2.3.1.3. Concept Wizard as Pop-Up Windows for Semantic Entity-Based Concept Generation

The Names tab (in FIG. 13, FIG. 14, and FIG. 17) permits users to define a Concept by selecting from a variety of items commonly found in documents such as Names, Job Titles, Dates, and Places.

Appendix A.2.3.1.4. Concept Wizard as Pop-Up Windows for Internal Concept-Based Concept Generation

The Combine tab (in FIG. 13, FIG. 14, and FIG. 17) permits users to define a new Rule (Pattern) by combining previously defined Rules (i.e., to generate Concepts from combinations of prior internal Concepts).

Appendix A.2.3.2. Concept Wizard as Pop-Up Windows for Multiple Types of Concept Generation

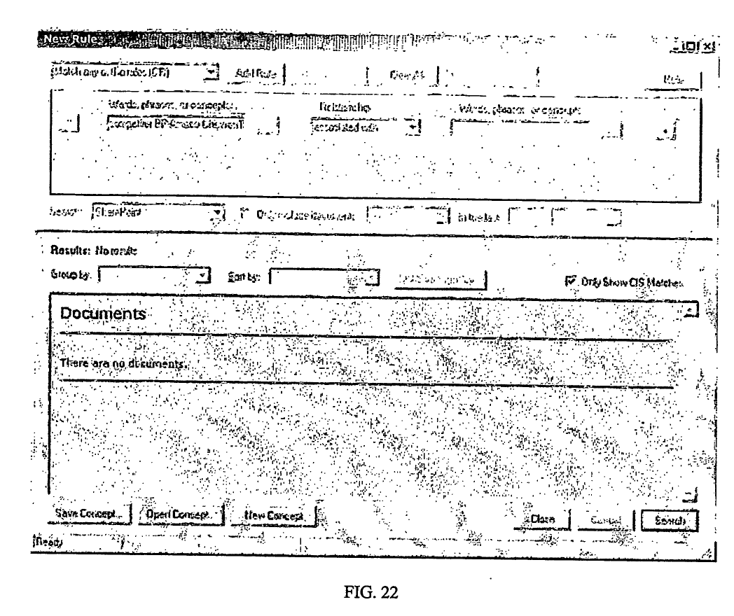

FIG. 22 shows another pop-up Concept wizard that provides an Operator-based approach to Concept generation. The upper part of the window (above the break line) and the horizontal list of buttons at the bottom of the window (Save Concept . . . , Open Concept . . . , etc.) handle Concept generation.

A Concept consists of a number of elements: one or more Patterns (referred to as “Rules” or “Concept Rules” in this application), combined and applied in certain ways. The Concept wizard in FIG. 22 allows users to create Concepts made up of the following elements: one or more words, phrases, Concepts, templates, synonyms, negation, tenses, and in this application, the Directive of the number of Concept matches required for a document to be returned. The primary way that the various elements are bound together is via Operators, which are input through the Relationship: pull-down menu in the upper part of the window. In the boxes to the left and right of the Relationship: menu, users can specify the words, phrases, and Concepts they want to combine.

The Concept wizard in FIG. 22 also allows users to specify the location and recency of documents to be searched.

Appendix A.2.3.2.1. Rules

As mentioned, Patterns are referred to as “Rules” or “Concept Rules” in this application. In the New Rule (i.e., New Pattern) window in FIG. 22, a Concept Rule (Pattern) is represented as a line consisting of a left-hand side box (for words, phrases, or Concepts), a relationship (Operator), and right-hand-side box (for words, phrases, or Concepts).

If a user clicks on the [symbol] button to the right of a Rule (Pattern), an additional relationship (Operator) and right-hand-side box appear, and the [symbol] becomes a [symbol] . (Click on the [symbol] button and the additional Operator (relationship) and right-hand-side box disappear, and the [symbol] becomes a [symbol] . Clicking the [symbol] restores the additional Operator and right-hand-side box.)

Bracketing also appears, to show the default precedence for the application of Operators, which is (A Operator B) Operator C. The precedence can be changed to A Operator (B Operator C) by clicking on the Change Bracketing button.

Clicking on the Add Rule button adds an entirely new CSL Concept Rule (Pattern). Clicking on the Remove Rule button removes the last new Concept Rule (Pattern) added. The Clear All button removes all rules (Patterns).

Appendix A.2.3.2.1.1. Words, Phrases, and Concepts

When inputting phrases into the New Rule pop-up window in FIG. 22, a phrase is regarded as a group of words that form a syntactic constituent and have a single grammatical function, for example, musical instrument and be excited about.

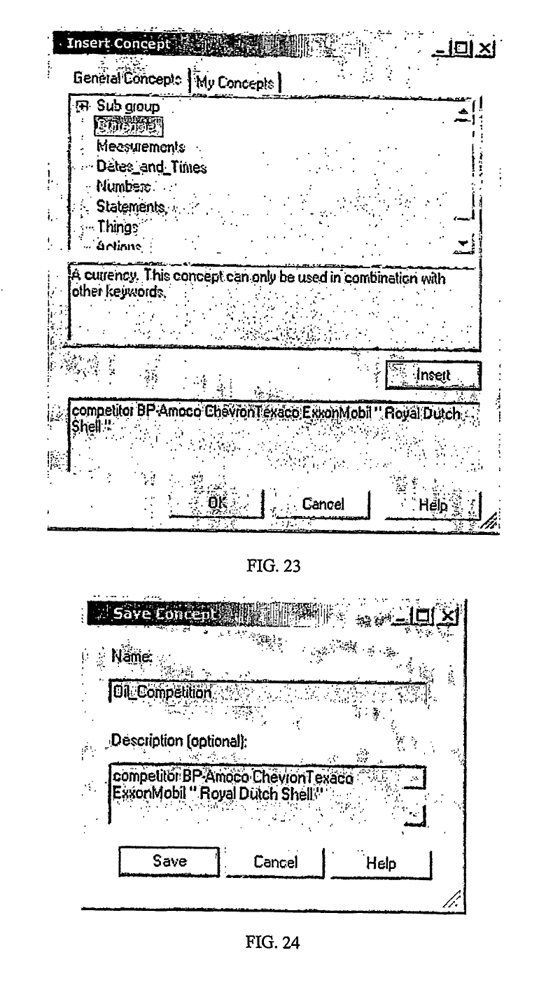

Concepts can be either pre-existing ones or ones created by users. Some General Concepts are supplied with this application as pre-existing Concepts. To access pre-existing Concepts, the user clicks a [symbol] button in the New Rule window (FIG. 22), which invokes the Insert Concept window (see FIG. 23). The tabs in this window are for General Concepts and My Concepts.

The General Concepts supplied with this particular application are Currencies, Measurements, Dates_and_Times, Numbers, Statements, Things, and Actions.

When a user selects a Concept, a description of the Concept appears in the middle panel of the window. (The lower panel contains what ever is in the box for words, phrases, or Concepts to the left of the [symbol] button that was clicked. The contents of this box can be edited, and any changes made will also appear in the main New Rule window shown in FIG. 22.)

Appendix A.2.3.2.1.2. Saving Concepts

User-created Concepts are ones that a user has created and saved by clicking the Save Concept button in the lower left-hand corner of the New Rule window (FIG. 22), which invokes the Save Concept window (FIG. 24). Users can write a description of the Concept if wanted. Once a Concept is saved, it appears under the My Concepts tab of the Insert Concept window.

Appendix A.2.3.2.1.3. Opening Concepts

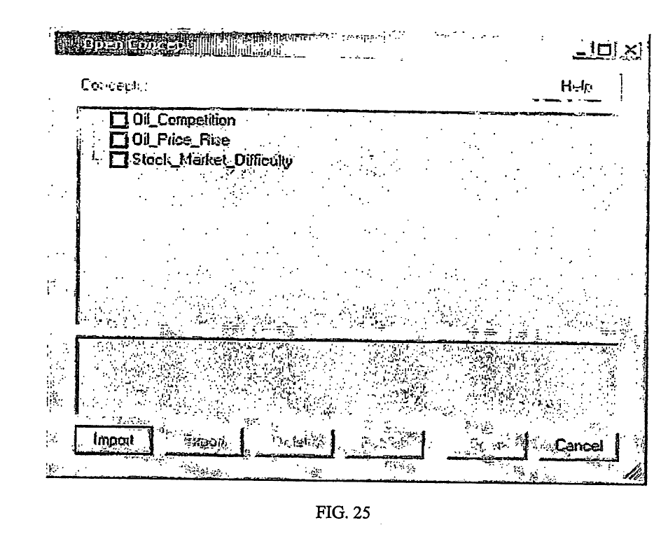

Clicking on the Open Concept button in the New Rule window (FIG. 22) brings up the Open Concept window (FIG. 25), which allows a user to open a Concept that s/he has already created, and also to import, publish, and export Concepts.

Importing Concepts.

Clicking on the Import button in the Open Concept window (FIG. 25) allows users to add Concepts that are in files outside the application.

Exporting Concepts.

Clicking on the Export button in the Open Concept window (FIG. 25) allows users to export Concepts (that have been screened as acceptable for export) to files outside the application.

Publishing Concepts.

Clicking on the Publish button in the Open Concept window (FIG. 25) allows users to publish Concepts (that have been screened as acceptable for publication) to a public web service area.

Appendix A.2.3.2.1.4. Expansion and Restriction of Words and Concepts

Both words and Concepts can be expanded and restricted. Words can be expanded and restricted in this application by adding synonyms, negation, tense, and the number of Concept matches required for a document to be returned. All these options are available by clicking on the [symbol] button to the left of the box into which words, phrases, or Concepts are entered.

Expansion with Synonyms.

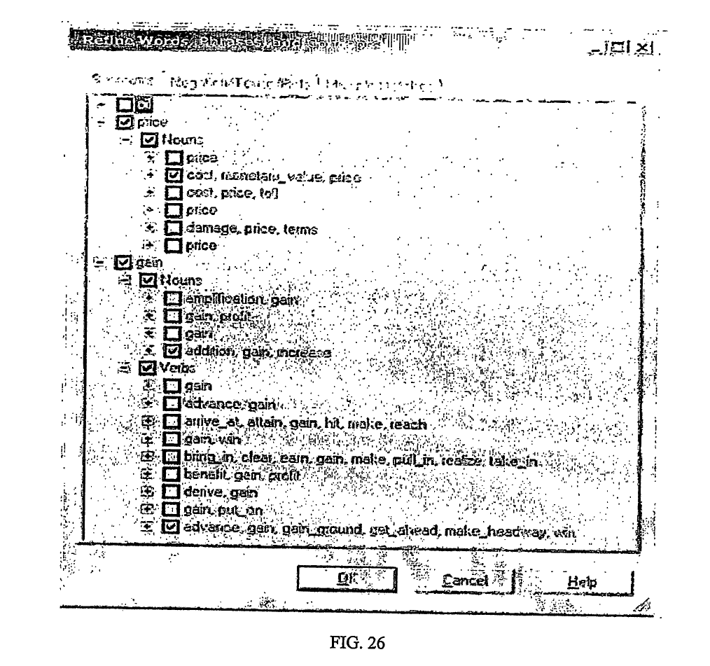

To control the addition of synonyms, users select the items under the Synonyms tab in the Refine Search Words, Phrases, and Concepts window (FIG. 26) by checking the appropriate terms.

Restriction with Negation, Tense, and Role.

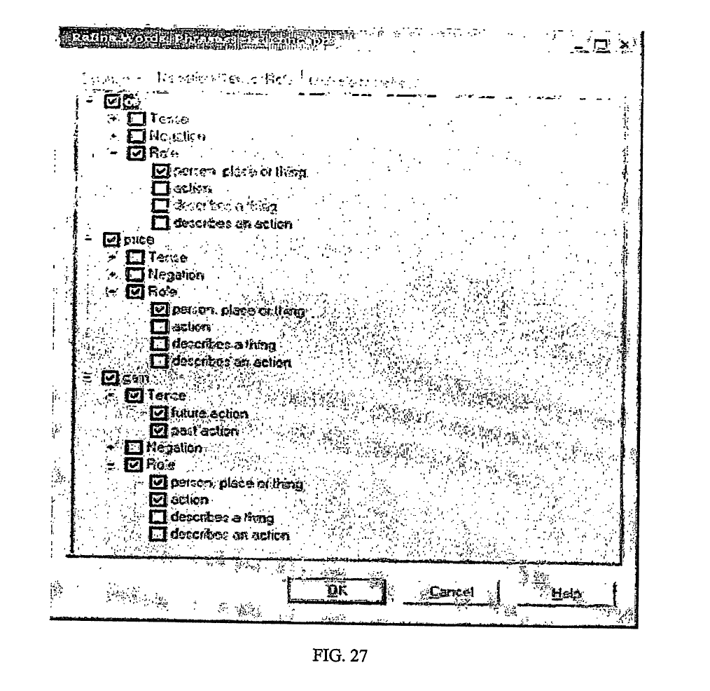

Users specify tense and negation by selecting the Negation/Tense/Role tab, found in the Refine Words, Phrases, and Concepts window (FIG. 27). In this implementation, users are offered two tenses (future and past), the choice of negation or not negation, and one of four roles. The roles are person, place or thing (corresponding roughly to a noun); action (roughly a verb); describes a thing (an adjective); and describes an action (adverb).

Restriction of Number of Concept Matches.

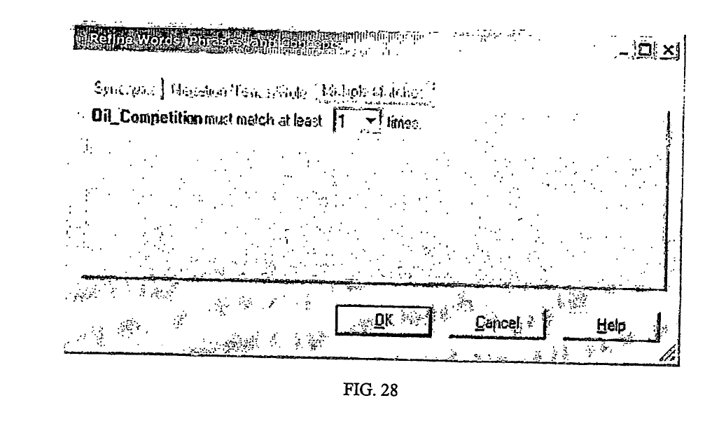

Users can specify how many matches of a Concept are required in a document for that document to be returned. To use this option, a user must have inserted a Concept. The choices offered in this embodiment are: 1 or more, more than 2, more than 3, or more than 5 Concept matches found in a document (see FIG. 28).

Concepts can be expanded and restricted through the Refine Words, Phrases, and Concepts window (FIG. 28) by creating new, expanded or restricted versions of existing Concepts, then saving those new versions, loading them, and using them.

Appendix A.23.2.1.5. Combination of Concept Elements

The application provides two ways to combine Concept elements (words, phrases, and other Concepts): within Rule boxes and across Rule boxes.

Concept elements can be combined within left-hand or right-hand Rule boxes in one of two ways:
Match all of the Concept elements (logical AND) by putting spaces between them
Match any of the Concept elements (logical OR) by putting commas between them.

Concept elements can be combined between left-hand and right-hand Rule boxes by using one of the Relationships (Operators): and, or, and not, precedes, immediately precedes, does not contain, in same sentence with, associated with, modifies, cause and effect, commences, terminates, obtains, thinks or says.

Appendix A.2.3.2.2. Combinations of CSL Rules (Patterns)

Rules (Patterns) can be combined by adding new Rules or by using one of
Match all of the rules (AND)
Match any of the rules (OR).

These match options are available in the menu at the top left hand side of the New Rule window (FIG. 22).

What is claimed is:

1. A method for defining and generating a set of concepts and identifying said concepts in text, comprising:
a) defining said set of concepts wherein:
i) each of said concepts comprises a pattern;
ii) each of said patterns comprising one of the following:
1) a description sufficiently constrained to be matchable to zero or more extents;
each of said extents comprising a set of zero or more items wherein
each of said items is an instance of a linguistic entity;
each of said instances of said linguistic entity is identified in
a) text, or
b) a knowledge resource; or
c) both a) and b); and
said pattern is matchable to zero or more of said extents corresponding to said description; or
2) an operator and a list of zero or more arguments wherein
each of said arguments is a further pattern; and
said pattern comprising said operator and said list of arguments is matchable to extents that are the result of applying said operator to further extents that are matchable by said arguments; or
3) a reference to a further concept comprising a further pattern; and
said pattern comprising said reference to said further concept is matchable to extents that are matchable by said further pattern; and
iii) any said further pattern is a pattern; and
b) generating said concepts from text or one or more sources of knowledge; and
c) identifying said concepts in text.

2. The method of claim 1 wherein each said linguistic entity comprises:
a) a morpheme; or
b) a word or phrase; or
c) a lexically-related term; or
d) a constituent or subconstituent; or
e) an expression in a linguistic notation representing a phonological, morphological, syntactic, semantic, or pragmatic-level description of text; or
f) a combination of one or more of linguistic entities.

3. The method of claim 1 wherein said linguistic entity is identified in a text and the start position and end position of said linguistic entity in said text is recorded.

4. The method of claim 1 wherein each said operator may comprise:
a) a zero-argument operator that expresses information including:
i) match information, or
ii) syntax information, or
iii) semantic information; or
b) a one-argument operator that expresses information including:
i) match information, or
ii) tense, or
iii) syntactic categories, or
iv) Boolean relations, or
v) lexical relations, or
vi) semantic categories; or
c) a two-argument operator that expresses information including:
i) relationships within and across sentences, or
ii) syntactic relationships, or
iii) Boolean relations; or
iv) semantic relationships.

5. The method of claim 4 wherein one of said two-argument operators comprises nonimmediately_dominates(X,Y) wherein:
a) X matches any extent;
b) Y matches any extent; and
c) the result is the extent matched by Y if each of the linguistic entities of Y's extent are a subconstituent of all linguistic entities of X's extent.

6. The method of claim 4 wherein one of said two-argument operators is nonimmediately_dominates(X,Y) when it is “wide-matched”, wherein
a) X matches any extent;
b) Y matches any extent; and
c) the result is said extent matched by X if each of the linguistic entities of Y's extent are a subconstituent of all linguistic entities of X's extent.

7. The method of claim 4 wherein for one of said two-argument operators is nonimmediately_precedes(X,Y) wherein:
a) X matches any extent;
b) Y matches any extent, and
c) the result is an extent that covers the extent matched by Y and an extent matched by X if the extent matched by X precedes the extent matched by Y.

8. The method of claim 1 wherein each of said patterns may further comprise
a) a parameter that is matchable to extents matched by any pattern that is bound to said parameter, and wherein
b) any pattern may be bound to a parameter.

9. The method of claim 8 wherein each of said patterns may further comprise
a) a reference to a further concept comprising a further pattern and
b) a list of zero or more arguments wherein each of said arguments comprise a further pattern; and
said pattern comprising said reference to said further concept is matchable to extents that are matchable by said further pattern in said further concept, where any parameters in said further concept are bound to said further patterns in said list of zero or more arguments.

10. The method of claim 1 wherein each of said concepts may further comprise
a) a name for said concept and
b) a set of one or more instructions selected from the following:
i) whether successful matches of said concept against text are “visible”;
ii) the number of matches of a concept required in a document for said document to be returned;
iii) the name for said concept that is being generated;
iv) the name of a file into which that concept is written; or
v) whether or not said file is encrypted.

11. The method of claim 1 wherein a User concept Description (UcD) is used to generate a concept, specifying ways in which concepts can be generated from different types of knowledge (knowledge sources) by way of different data models, governed by various instructions, said UcD comprising:
a) one or more knowledge sources that provide raw content used to generate concepts,
b) one or more data models used to combine said knowledge sources used to generate concepts, and
c) one or more instructions governing said generation of said concepts.

12. The method of claim 11 wherein said knowledge sources are selected from one of:
a) text-based knowledge sources;
b) linguistic knowledge sources;
c) knowledge sources based on concept specification languages;
d) statistical knowledge sources; or
e) a combination of knowledge sources a)-d).

13. The method of claim 11 wherein said data models are selected from one of:
a) linguistic data models;
b) logical data models;
c) statistical data models; or
d) a combination of data models a)-c).

14. The method of claim 11 wherein said instructions are selected from one of:
a) whether successful matches of the concept against text are “visible” in annotated output of the matched text;
b) the number of matches of a concept required in a document for said document to be returned;
c) the name of the concept (that is, the concept name) that is being generated;
d) the name of the file into which that concept is written;
e) whether or not said file is encrypted;
f) a combination of instructions a)-e).

15. The method of claim 11 wherein a UcD is one of three types:
a) a basic UcD is a data structure in template form that is used to define types b) and c);
b) an unpopulated UcD, which is a version of a), specifies the knowledge sources, data models, and instructions used in a knowledge-source based UcD (or one of its subtypes such as a text-based UcD) or a data-model based UcD (or one of its subtypes);
c) a populated UcD, which is a version of b) with filled-in information about particular knowledge sources, data models, and instructions used in a particular instance of knowledge-source based UcD (or one of its subtypes) or a data-model based UcD (or one of its subtypes), that is, it is “filled out” with information during the generation of an actual concept.

16. The method of claim 15 wherein said UcDs of three types (basic, unpopulated, populated) are organized hierarchically into a graph of UcDs wherein:
a) the top level of said graph is occupied by said basic UcD;
b) the next level is occupied by said unpopulated UcDs including, but not limited to, said knowledge-source based UcD and data-model based UcDs;
c) inherited information is optionally passed down from said basic UcD at said top level to said unpopulated UcDs at said next level;
d) the next one or more levels are occupied by further unpopulated UcDs including, but not limited to, subtypes of said knowledge-source based UcD (such as a text-based UcD) or subtypes of said data-model based UcD (such as the logical-based UcD);
e) inherited information is optionally passed down from said unpopulated UcDs at the higher level to said unpopulated UcDs at said next one or more levels, and further optionally passed within said one of more levels;
f) the next level is occupied by said populated UcDs, wherein said UcDs are populated by
i) one or more particular knowledge sources and instructions, supplied by the user, and
ii) a generated concept, supplied by said concept generation method,
g) said graph is optionally stored in a concept database.

17. The method of claim 1 wherein said generating step comprises:
a) inputting of text fragments wherein a user is prompted for one or more text fragments;
b) splitting fragments into words;
c) manually selecting relevant words in the text fragments (default selection is available);
d) manually adding synonyms, hypernyms, and hyponyms for any selected relevant word (default selections of key words, synonyms, and hypernyms is available);
e) matching of concepts wherein
i) a predefined set of concepts from the user are run over the fragments and all matches are returned,
ii) when matching, the part of speech of individual words is determined by standard concept processing engine algorithms, and
iii) the resulting matches are known as a “concept matches”;
f) removing certain concept matches, said removal depending on
i) what words have been marked as “relevant”,
ii) the interpretation placed on “relevant” by the user (the algorithm may optionally do one or both steps automatically),
iii) wherein using the interpretation of “relevant” selected, the algorithm removes certain concept matches;
g) building concept chains (tiling) from the concept matches kept from the previous step, where a “chain” is a sequence of concept matches;
h) ranking chains;
i) writing out chains as a concept; and
j) outputting the concept into a file with certain instructions attached:
i) naming the concept produced when chains are written out,
ii) naming the file for storing said concept,
iii) selecting whether said concept is visible or hidden for matching purposes, and
iv) selecting whether said file is encrypted or not.

18. The method of claim 17 wherein a User concept Description (UcD) is used to generate a concept.

19. The method of claim 1 wherein said concept wizard is used to navigate a user through the method of generating a concept, said concept wizard:
a) providing users with instructions on entering data for the generation of a concept, according to the knowledge sources, data model, and other generation instructions used;
b) different concept wizards are used, depending on the UcD selected;
c) Input from the abstract user interface is taken through the concept wizard is passed to the concept generator for the creation of actual concepts;
d) Input from the concept generator taken into the concept wizard includes information about choices of knowledge sources and data models for generation, and instructions governing generation.

20. The method of claim 21 wherein said concept wizard interacts with a hierarchically organized graph of UcDs optionally stored in a concept database, wherein:
a) said concept wizard is invoked;
b) said concept wizard calls upon the unpopulated UcDs in said UcD graph;
c) said concept wizard displays to the user all the knowledge-source based and data-model based concept generation options, extracted from said unpopulated UcDs;
d) said user inputs into said concept wizard his or her choice of concept generation by selecting a particular knowledge-source or data-model as the basis for generation;
e) the unpopulated UcD corresponding to said user's choice is accessed from the UcD graph;
f) said concept wizard displays to the user the concept generation options for that knowledge-source or data-model based UcD;
g) The user inputs generation choices of particular knowledge-sources and instructions;
h) The particular semi-populated UcD is then passed to the concept generator;
i) The concept generator generates a concept as part of producing a populated UcD which is.
i) stored in the concept database, and
ii) also placed in the UcD graph which is optionally stored in the concept database.
g) The concept wizard then displays to the user the generated concept for that populated UcD plus optionally all of the user's concept generation options that led to the generation of that particular concept.

21. The method of claim 1 further comprising managing said concepts.

22. The method of claim 21 wherein a User concept Group (UcG) is used to group and name a set of concepts, said UcG comprising:
a) a named concept that refers to named groups of concepts or Patterns, or other groups;
b) said UcGs can be extracted from any set of concepts.

23. The method of claim 21 wherein a concept database is used to store concepts, said database:
a) keeps an up-to-date set of CSL files;
b) keeps a record of what CSL files correspond to what UcDs and UcGs; and
c) guarantees consistency of stored UcDs and UcGs (such that said UcDs and UcGs in said database can be compiled).

24. The method of claim 21 wherein managing said concepts is performed by a concept manager that comprises a concept database administrator and a concept editor.

25. The method of claim 24 wherein said concept database administrator
a) is responsible for loading, storing, and managing uncompiled and compiled concepts, UcDs and UcGs in the concept database;
b) is responsible for loading, storing, and managing compiled concepts ready for annotation and for generation;
c) is responsible for managing a UcD graph;
d) allows users to view relationships among concepts, UcDs, and UcGs in the concept database;
e) allows users to search for concepts, UcDs, and UcGs;
f) allows users to search for the presence of concepts in UcDs and UcGs;
g) allows users to search for dependencies of UcDs and UcGs on concepts;
h) makes sure the concept database always contains a set of concepts, UcDs, and UcG that are logically consistent and consistent such that said sets in can be compiled;
i) keeps CSL files up to date with the changing definitions of concepts, UcDs, and UcGs;
j) checks the integrity of concepts, UcDs, and UcGs (such that if A depends on B, then B can not be deleted);
k) handles dependencies within and between concepts, UcDs, and UcGs;
l) allows functions performed by concept editor to add, remove, and modify concepts, UcDs, and UcGs in the Database without fear of breaking other concepts, UcDs, or UcGs in the same database.

26. The method of claim 24 wherein said concept editor
a) allows users to view relationships among concepts, UcDs, and UcGs in the concept database;
b) allows users to search for concepts, UcDs, and UcGs;
c) allows users to search for the presence of concepts in UcDs and UcGs;
d) allows users to search for dependencies of UcDs and UcGs on concepts;
e) allows users to add, remove, and modify all types of concept (if users have appropriate permissions);
f) allows users to add, remove, and modify all types of UcD except Basic UcDs;
g) pre-sets permissions so that only certain privileged users can edit unpopulated UcDs;
h) allows users to users save a UcD under a different name, and can also change any other properties they like;
i) allows users to add, remove, and modify User concept Groups (UcGs);
j) allows users to save a UcG under a different name;
k) allows users to change a concept Group name, description, and any other properties they like in UcGs;
l) allows users to add, remove, and modify user-defined hierarchies.

27. A method for defining and generating a set of concepts and identifying said concepts in text, comprising:
a) identifying linguistic entities in the text of documents and other text-forms;
b) annotating said identified linguistic entities in a text markup language to produce linguistically annotated documents and other text-forms;
c) storing said linguistically annotated documents and other text-forms;
d) defining concepts that also makes use of patterns wherein:
i) each of said concepts comprises a pattern;
ii) each of said patterns comprising one of the following:
1) a description sufficiently constrained to be matchable to zero or more extents;
each of said extents comprising a set of zero or more items wherein
each of said items is an instance of a linguistic entity,
each of said instances of said linguistic entity is identified in
a) text, or
b) a knowledge resource; or
c) both a) and b); and
said pattern is matchable to zero or more of said extents corresponding to said description; or
2) an operator and a list of zero or more arguments wherein
each of said arguments is a further pattern; and
said pattern comprising said operator and said list of arguments is matchable to extents that are the result of applying said operator to further extents that are matchable by said arguments; or
3) a reference to a further concept comprising a further pattern; and
said pattern comprising said reference to said further concept is matchable to extents that are matchable by said further pattern; and
iii) any said further pattern is a pattern; and
e) generating said concepts from text of documents and other text-forms, and other sources of knowledge;
f) managing said concepts, both generated and non-generated;
g) identifying concepts using linguistic information, where said concepts occur in one of:
i) said text of documents and other text-forms in which linguistic entities have been identified in step a); or
ii) said linguistically annotated documents and other text-forms of step b); or
iii) stored linguistically annotated documents and other text-forms of step c);
h) annotation of said identified concepts in said text markup language to produce conceptually annotated documents and other text-forms;
i) storage of said conceptually annotated documents and other text-forms.

28. A system for implementing said method according to claim 27 consisting of one of:
a) a client server configuration comprising
i) a server, wherein said server comprises
1) a communications interface to one or more clients over a network or other communication connection,
2) one or more central processing units (CPUs),
3) one or more input devices,
4) one or more program and data storage areas comprising a module or submodules for a concept processing engine, and
5) one or more output devices; and
ii) one or more clients, wherein each client comprises
1) a communications interface to a server over a network or other communication connection,
2) one or more central processing units (CPUs),
3) one or more input devices,
4) one or more program and data storage areas comprising one or more submodules for a concept processing engine, and
5) one or more output devices; or
b) a client server farm configuration comprising
i) a front end server which
1) optionally contains modules for concept or concept processing and may itself act in the capacity of a client when it accesses remote databases located on a database server,
2) receives queries over a network or other communication connection from one or more clients,
3) passes said queries over said network or other communication connection to the back end servers in the server farm which
4) processes said queries, and
5) sends said queries to said front end server, which sends said queries on to said clients;
ii) a server farm of one or more back end servers, where each back end server comprises
1) a communications interface to the front end server over a network or other communication connection,
2) one or more central processing units (CPUs),
3) one or more input devices,
4) one or more program and data storage areas comprising one or more submodules for a concept processing engine, and
5) one or more output devices, and
6) receives queries from clients via the front end server over said network or other communication connection;
7) does substantially all the processing necessary to formulate responses to said queries (though said front end server may also do some concept processing), and provides said responses to said front end server, which passes said responses on to said clients,
8) said back end server may itself act in the capacity of a client when said back end server accesses remote databases located on a database server; and
iii) one or more clients, wherein each client comprises
1) a communications interface to the front end server over a network or other communication connection,
2) one or more central processing units (CPUs),
3) one or more input devices,
4) one or more program and data storage areas comprising one or more submodules for a concept processing engine, and
5) one or more output devices.

29. The system according to claim 28 wherein the concept processor takes as input text in documents and other text-forms in the form of a signal from one or more input devices to a user interface, and carries out predetermined processes (including, but not limited to, processes for information retrieval and information extraction) to produce
a) a collection of text in documents and other text-forms, which are output from the user interface in the form of a signal to one or more output devices, and
b) concepts (and, possibly, UcDs, UcGs, and hierarchies of those three entities), which are stored in a concept database.

30. The system according to claim 29 wherein predetermined processes (including, but not limited to, processes for information retrieval and information extraction), accessed by said user interface, comprise the following main processes: synonym processor, annotator, concept generation (including the concept wizard, example maker, and concept generator), concept database, concept manager, and CSL parser.

31. The system according to claim 30 wherein said concept generation comprise:
a) concept wizard;
b) example maker;
c) concept generator;
d) knowledge repositories as input including, but not limited to
i) text-based knowledge sources (text documents or text fragments);
ii) linguistic knowledge sources including vocabulary specifications; lexical relations (synonyms, hypernyms, hyponyms), syntactic categories, semantic entities (one or more tags for names of people, names of places, measures, dates; document level tags such as #subject, #from, #to, #date);
iii) knowledge sources based on concept specification languages (concepts, operators, patterns, grammar specifications in terms of concepts, imported concepts, one or more internal database concepts to be used for generation); and
iv) statistical knowledge sources frequencies of words (derived from text documents, text fragments, vocabulary items, and other data sources) and frequencies of tags (such as syntactic tags like noun phrase, document structure tags from HTML, and semantic tags from XML);
e) knowledge repositories as output comprising generated concepts.

32. A method for defining and generating a set of Concepts and identifying said Concepts in text, comprising:
a) defining said set of Concepts wherein:
i) each of said Concepts comprises a Pattern;
ii) each of said Patterns comprising one of the following:
1) a Basic Pattern comprising a description sufficiently constrained to be matchable to zero or more extents;
each of said extents comprising a set of zero or more items wherein
each of said items is an instance of a linguistic entity;
each of said instances of said linguistic entity is identified in
b) text, or
b) a knowledge resource; or
c) both a) and b); and
said Basic Pattern is matchable to zero or more of said extents corresponding to said description; or
2) an Operator Pattern comprising an Operator and a list of zero or more Arguments wherein
each of said Arguments is a further Pattern; and
said Operator Pattern is matchable to extents that are the result of applying said Operator to further extents that are matchable by said Arguments; or
3) a Concept Call comprising a reference to a further Concept comprising a further Pattern; and
said Concept Call is matchable to extents that are matchable by said further Pattern; and
iii) any said further Pattern is a Pattern; and
b) generating said Concepts from text or one or more sources of knowledge; and
c) identifying said Concepts in text.

33. The method of claim 32 wherein each said linguistic entity comprises:
a) a morpheme; or
b) a word or phrase; or
c) a lexically-related term; or
d) a constituent or subconstituent; or
e) an expression in a linguistic notation representing a phonological, morphological, syntactic, semantic, or pragmatic-level description of text; or
f) any combination of one or more linguistic entities.

34. The method of claim 32 wherein said linguistic entity is identified in text and a record is made that said linguistic entity starts in one position within said text and ends in a second position.

35. The method of claim 32 wherein each said Operator may comprise:
a) a zero-argument Operator that expresses information including:
i) match information, or
ii) syntax information, or
iii) semantic information; or
b) a one-argument Operator that expresses information including:
i) match information, or
ii) tense, or
iii) syntactic categories, or
iv) Boolean relations, or
v) lexical relations, or
vi) semantic categories; or
c) a two-argument Operator that expresses information including:
i) relationships within and across sentences, or
ii) syntactic relationships, or
iii) Boolean relations; or
iv) semantic relationships.

36. The method of claim 35 wherein one of said two-argument Operators comprises NonImmediately_Dominates(X,Y) wherein:
a) X matches any extent;
b) Y matches any extent; and
c) the result is the extent matched by Y if all the linguistic entities of Y's extent are subconstituents of all linguistic entities of X's extent.

37. The method of claim 35 wherein one of said two-argument Operators comprises NonImmediately_Dominates(X,Y) when it is is “wide-matched”, wherein
a) X matches any extent;
b) Y matches any extent; and
c) the result is said extent matched by X if all the linguistic entities of Y's extent are subconstituents of all linguistic entities of X's extent.

38. The method of claim 35 wherein one of said two-argument Operators comprises NonImmediately_Precedes(X,Y) wherein:
a) X matches any extent;
b) Y matches any extent, and
c) the result is an extent that covers the extent matched by Y and an extent matched by X if the extent matched by X precedes the extent matched by Y.

39. The method of claim 32 wherein each of said Patterns may further comprise
a) a Parameter that is matchable to the extents matched by any Pattern that is bound to said Parameter, and wherein
b) any Pattern may be bound to a Parameter.

40. The method of claim 39 wherein said Patterns further comprise a
Concept Call comprising
a) a reference to a further Concept comprising a further Pattern and
b) a list of zero or more Arguments wherein each of said Arguments comprise a further Pattern; and
said Concept Call is matchable to extents that are matchable by said further Pattern in said further Concept, where
any Parameters in said further Concept are bound to said further Patterns in said list of zero or more Arguments.

41. The method of claim 32 wherein each of said Concepts may further comprise
a) a name for said Concept and
b) a set of one or more Directives selected from the following:
i) whether successful matches of said Concept against text are “visible”;
ii) the number of matches of a Concept required in a document for said document to be returned;
iii) the name for said Concept that is being generated;
vi) the name of a file into which that Concept is written;
v) whether or not said file is encrypted.

42. The method of claim 32 wherein a User Concept Description (UCD) is used to generate a Concept, specifying ways in which Concepts can be generated from different types of knowledge (knowledge sources) by way of different data models, governed by various Directives, said UCD comprising:
a) one or more knowledge sources that provide raw content used to generate Concepts,
b) one or more data models used to combine said knowledge sources used to generate Concepts, and
c) one or more Directives governing said generation of said Concepts.

43. The method of claim 32 wherein said knowledge sources are selected from one of:
a) text-based knowledge sources;
b) linguistic knowledge sources;
c) CSL-based knowledge sources;
d) statistical knowledge sources; or
e) a combination of knowledge sources a)-d).

44. The method of claim 43 wherein said text-based knowledge sources are selected from one of:
a) one or more vocabulary items;
b) one or more text fragments;
c) one or more text documents; or
d) some combination of a)-c).

45. The method of claim 43 wherein said linguistic knowledge sources are selected from one or more of:
a) one or more lexical relations comprising
i) one or more synonyms;
ii) one or more superordinate terms (hypernyms); and
iii) one or more subordinate terms (hyponyms);
b) one or more syntactic categories;
c) one or more semantic entities comprising
i) one or more tags for names of people, names of places, names of companies and products, job titles, monetary expressions, percentages, measures, numbers, dates, time of day, and time elapsed/period of time during which something lasts;
ii) one or more document level tags such as #subject, #from, #to, #date;
d) some combination of a)-c).

46. The method of claim 43 wherein said CSL-based knowledge sources are selected from one of:
a) one or more Concepts;
b) one or more Concept Calls;
c) one or more Operators;
d) one or more Patterns;
e) grammar specifications (in terms of Concepts);
f) some combination of a)-e).

47. The method of claim 43 wherein said statistical knowledge sources are selected from one of:
a) frequencies of words derived from text documents, text fragments, vocabulary items, and other data sources;
b) frequencies of tags such as syntactic tags like noun phrase, document structure tags from HTML, and semantic tags from XML;
c) some combination of a) and b).

48. T he method of claim 42 wherein a knowledge source-based UCD is a UCD in which:
a) options about knowledge sources are presented to users before options about data models or Directives;
b) the selection of certain knowledge sources prioritizes the subsequent choices of data models and Directives presented to users (text fragments are most closely associated with the linguistic data model, documents with the statistical data model, and CSL Operators with the logical data model).

49. The method of claim 46 wherein a knowledge source-based UCD has subtypes that include, but are not limited to, a vocabulary-based UCD, text-based UCD, document-based UCD, Operator-based UCD, imported Concept-based UCD, and internal Concept-based UCD.

50. The method of claim 42 wherein said data models are selected from one of:
a) linguistic data models;
b) logical data models;
c) statistical data models; or
d) a combination of data models a)-c).

51. The method of claim 50 wherein said linguistic data model comprises:
a) identification of linguistic entities in the text of documents and other text-forms;
b) annotation of said identified linguistic entities in a text markup language to produce linguistically annotated documents and other text-forms;
c) storage of said linguistically annotated documents and other text-forms;
d) identification of concepts using linguistic information, where said concepts are represented in a concept specification language and said concepts occur in one of:
i) said text of documents and other text-forms in which linguistic entities have been identified in step a); or
ii) said linguistically annotated documents and other text-forms of step b); or
iii) stored linguistically annotated documents and other text-forms of step c);
e) annotation of said identified concepts in said text markup language to produce conceptually annotated documents and other text-forms;
f) storage of said conceptually annotated documents and other text-forms;
g) defining and learning concept representations of said concept specification language;
h) checking user-defined descriptions of concepts represented in said concept specification language; and
i) retrieval by matching said user-defined descriptions of concepts against said conceptually annotated documents and other text-forms.

52. The method of claim 50 wherein said logical data model includes, but is not limited to, the Boolean Operators AND, OR, NOT, and ANDNOT.

53. The method of claim 50 wherein said statistical data model includes, but is not limited to, support vector machines.

54. The method of claim 42 wherein a data model-based UCD is a UCD in which:
a) options about data models are presented to users before options about knowledge sources or Directives;
b) the selection of certain data models prioritizes the subsequent choices of knowledge sources and Directives presented to users (the linguistic data model is most closely associated with text fragments, the statistical data model with documents, and the logical data model with CSL Operators.

55. The method of claim 42 wherein said Directives are selected from one of:
a) whether successful matches of the Concept against text are “visible” in annotated output of the matched text;
b) the number of matches of a Concept required in a document for said document to be returned;
c) the name of the Concept (that is, the Concept name) that is being generated;
d) the name of the file into which that Concept is written;
e) whether or not said file is encrypted;
f) a combination of Directives a)-e).

56. The method of claim 42 wherein a UCD is one of three types:
a) a basic UCD is a data structure in template form that is used to define types b) and c);
b) an unpopulated UCD, which is a version of a), specifies the knowledge sources, data models, and Directives used in a knowledge-source based UCD (or one of its subtypes such as a text-based UCD) or a data-model based UCD (or one of its subtypes);
c) a populated UCD, which is a version of b) with filled-in information about particular knowledge sources, data models, and Directives used in a particular instance of knowledge-source based UCD (or one of its subtypes) or a data-model based UCD (or one of its subtypes), that is, it is “filled out” with information during the generation of an actual Concept.

57. The method of claim 56 wherein said UCDs of three types (basic, unpopulated, populated) are organized hierarchically into a graph of UCDs wherein:
a) the top level of said graph is occupied by said basic UCD;
b) the next level is occupied by said unpopulated UCDs including, but not limited to, said knowledge-source based UCD and data-model based UCDs;
c) inherited information is optionally passed down from said basic UCD at said top level to said unpopulated UCDs at said next level;
d) the next one or more levels are occupied by further unpopulated UCDs including, but not limited to, subtypes of said knowledge-source based UCD (such as a text-based UCD) or subtypes of said data-model based UCD (such as the logical-based UCD);
e) inherited information is optionally passed down from said unpopulated UCDs at the higher level to said unpopulated UCDs at said next one or more levels, and further optionally passed within said one of more levels;
f) the next level is occupied by said populated UCDs, wherein said UCDs are populated by
i) one or more particular knowledge sources and Directives, supplied by the user, and
ii) a generated Concept, supplied by said Concept generation method,
g) said graph is optionally stored in a Concept database.

58. The method of claim 56 wherein an unpopulated text-based UCD comprises:
a) holding input text fragments,
b) holding selected relevant words,
c) holding synonyms, hypernyms, and hyponyms for said selected relevant words,
d) holding Directives for Concept generation, and
e) holding generated Concept that has been written to a file.

59. The method of claim 32 wherein said generating step comprises:
a) inputting of text fragments wherein a user is prompted for one or more text fragments;
b) splitting fragments into words;
c) manually selecting relevant words in the text fragments (default selection is available);
d) manually adding synonyms, hypernyms, and hyponyms for any selected relevant word (default selections of key words, synonyms, and hypernyms is available);
e) matching of Concepts wherein
i) a predefined set of Concepts from the user are run over the fragments and all matches are returned,
ii) when matching, the part of speech of individual words is determined by standard Concept processing engine algorithms, and
iii) the resulting matches are known as a “Concept matches”;
f) removing certain Concept matches, said removal depending on
i) what words have been marked as “relevant”,
ii) the interpretation placed on “relevant” by the user (the algorithm may optionally do one or both steps automatically),
iii) wherein using the interpretation of “relevant” selected, the algorithm removes certain Concept matches;
g) building Concept chains (tiling) from the Concept matches kept from the previous step, where a “chain” is a sequence of Concept matches;
h) ranking chains;
i) writing out chains as a Concept; and
j) outputting the Concept into a file with certain Directives attached:
i) naming the Concept produced when chains are written out,
ii) naming the CSL file for said Concept,
iii) selecting whether said Concept is visible or hidden for matching purposes, and
iv) selecting whether said CSL file is encrypted or not.

60. The method of claim 59 wherein what is “relevant” when removing certain Concept matches is selected from one of four interpretations:
a) a Concept match is kept if all of the Arguments of its match are marked as relevant, e.g., the match of the Concept noun verb against dog eats is kept only if both dog and eats are marked as relevant;
b) a Concept match is kept if one or more of the Arguments of its match are marked as relevant, e.g., the match of the Concept noun verb against dog eats is kept only if one or more of the Arguments—dog, eats, or dog and eats—are marked as relevant;
c) a Concept match is kept if all the words marked as relevant fall inside the extent of the match (up to and including the boundaries of that extent);
d) a Concept match is kept if one or more of the words marked as relevant fall inside the extent of the match (up to and including the boundaries of that extent).

61. The method of claim 59 wherein:
a) a “chain” is a sequence of Concept matches such that no two matches in the chain overlap (i.e., a chain is a set of adjacent Concept matches (tiles) with no overlapping extents);
b) no match can be added to a particular chain without violating a) (i.e., the chains are of maximum length);
c) no word can belong to two different Concepts in the same chain;
d) the tiler produces a set of chains as few in number as one through to as many in number as there are different paths between words.

62. The method of claim 59 wherein:
a) a “chain” is a sequence of Concept matches such that a set of adjacent Concept matches (tiles) with overlapping extents is allowed;
b) one word can belong to two different Concepts in the same chain;
c) the tiler takes all connections between words, preferring to find shorter spans rather than larger ones, and produces a single optimal chain.

63. The method of claim 59 wherein, when a “chain” is a sequence of Concept matches such that no two matches in the chain overlap, every chain from the tiling (Concept chain building) step is ranked and only the chains with maximum rank are kept, where the rank of a chain is calculated as follows:
a) “match Coverage” is the number of words in the match of that whole chain that overlap extent between the first and last relevant words;
b) “match Context” is the number of words in the match that are outside of the extent between the first and last relevant words;
c) “match Rank” is “Match Coverage” minus “Match Context”; and
d) the final rank is the sum of all Match Ranks for a given chain minus the length of the chain (wherein subtracting the chain length is intended to boost ranking of shorter chains, which are likely the ones that consists of longer/more meaningful matches).

64. The method of claim 59 wherein chains are written out as a Concept as follows:
a) take the first chain;
b) take the first Concept match;
c) look up said match in a knowledge base of Concepts to get Concept;
d) write out said Concept;
e) if there is another match in said chain, write out an AND Operator and go to step c) with the next Concept match;
f) if there are no more matches and if there is another chain, then write out an OR Operator and go to step b) with the next chain; else exit with completed chain (the defined Concept covers the text fragments).

65. The method of claim 59 wherein:
a) inputting of text fragments is replaced by inputting of positive and negative text fragments (the user is prompted for one or more each of these); and
b) selecting relevant words is replaced by selecting relevant words in said positive and negative text fragments (the relevant words in positive text fragments are words that should match the generated Concept, while the relevant words in negative text fragments are words that should not match the generated Concept).

66. The method of claim 59 wherein a User Concept Description (UCD) is used to generate a Concept.

67. The method of claim 32 wherein said Concept wizard is used to navigate a user through the method of generating a Concept, said Concept wizard:
a) providing users with instructions on entering data for the generation of a Concept, according to the knowledge sources, data model, and other generation Directives used;
b) different Concept wizards are used, depending on the UCD selected;
c) Input from the abstract user interface is taken through the Concept wizard is passed to the Concept generator for the creation of actual Concepts;
d) Input from the Concept generator taken into the Concept wizard includes information about choices of knowledge sources and data models for generation, and Directives governing generation.

68. The method of claim 67 wherein said Concept wizard interacts with a hierarchically organized graph of UCDs optionally stored in a Concept database, wherein:
a) said Concept wizard is invoked;
b) said Concept wizard calls upon the unpopulated UCDs in said UCD graph;
c) said Concept wizard displays to the user all the knowledge-source based and data-model based Concept generation options, extracted from said unpopulated UCDs;
d) said user inputs into said Concept wizard his or her choice of Concept generation by selecting a particular knowledge-source or data-model as the basis for generation;
e) the unpopulated UCD corresponding to said user's choice is accessed from the UCD graph;
f) said Concept wizard displays to the user the Concept generation options for that knowledge-source or data-model based UCD;
g) The user inputs generation choices of particular knowledge-sources and Directives;
h) The particular semi-populated UCD is then passed to the Concept generator;
i) The Concept generator generates a Concept as part of producing a populated UCD which is.
i) stored in the Concept database, and
ii) also placed in the UCD graph which is optionally stored in the Concept database.
g) The Concept wizard then displays to the user the generated Concept for that populated UCD plus optionally all of the user's Concept generation options that led to the generation of that particular Concept.

69. The method of claim 32 wherein said generating step comprises:
a) inputting of text fragments wherein a user is prompted for one or more text fragments;
b) splitting fragments into words;
c) manually selecting relevant words in the text fragments (default selection is available);
d) manually adding synonyms, hypernyms, and hyponyms for any selected relevant word (default selections of key words, synonyms, and hypernyms are available);
e) inputting names of Concepts that need to be combined into a new Concept;
f) selecting Operators from a set of available Operators including, but not limited to:
i) OR, AND, and ANDNOT,
ii) Immediately Precedes and Precedes,
iii) Precedes within less than N words and Precedes outside of (greater than) N words,
iv) Immediately Dominates and Dominates, and
v) Related and Cause; and
g) performing an integrity check on every candidate comprising an Operator and zero or more Arguments;
h) converting into a chain every acceptable candidate comprising an Operator and zero or more Arguments;
i) writing out chains as a Concept; and
j) outputting the Concept into a file with certain Directives attached:
i) naming the Concept produced when chains are written out,
ii) naming the CSL file for said Concept,
iii) selecting whether said Concept is visible or hidden for matching purposes, and
iv) selecting whether said CSL file is encrypted or not.

70. The method of claim 69 wherein a User Concept Description (UCD) is used to generate a Concept.

71. The method of claim 32 further comprising managing said Concepts.

72. The method of claim 72 wherein a User Concept Group (UCG) is used to group and name a set of Concepts, said UCG comprising:
a) a named Concept that refers to named groups of Concepts or Patterns, or other groups;
b) said UCGs can be extracted from any set of Concepts.

73. The method of claim 71 wherein a Concept database is used to store Concepts, said database:
a) keeps an up-to-date set of CSL files;
b) keeps a record of what CSL files correspond to what UCDs and UCGs; and
c) guarantees consistency of stored UCDs and UCGs (such that said UCDs and UCGs in said database can be compiled).

74. The method of claim 71 wherein managing said Concepts is performed by a Concept manager that comprises a Concept database administrator and a Concept editor.

75. The method of claim 74 wherein said Concept database administrator
a) is responsible for loading, storing, and managing uncompiled and compiled Concepts, UCDs and UCGs in the Concept database;
b) is responsible for loading, storing, and managing compiled Concepts ready for annotation and for generation;
c) is responsible for managing a UCD graph;
d) allows users to view relationships among Concepts, UCDs, and UCGs in the Concept database;
e) allows users to search for Concepts, UCDs, and UCGs;
f) allows users to search for the presence of Concepts in UCDs and UCGs;
g) allows users to search for dependencies of UCDs and UCGs on Concepts;
h) makes sure the Concept database always contains a set of Concepts, UCDs, and UCG that are logically consistent and consistent such that said sets in can be compiled;
i) keeps CSL files up to date with the changing definitions of Concepts, UCDs, and UCGs;
j) checks the integrity of Concepts, UCDs, and UCGs (such that if A depends on B, then B can not be deleted);
k) handles dependencies within and between Concepts, UCDs, and UCGs;
l) allows functions performed by Concept editor to add, remove, and modify Concepts, UCDs, and UCGs in the Database without fear of breaking other Concepts, UCDs, or UCGs in the same database.

76. The method of claim 74 wherein said Concept editor
a) allows users to view relationships among Concepts, UCDs, and UCGs in the Concept database;
b) allows users to search for Concepts, UCDs, and UCGs;
c) allows users to search for the presence of Concepts in UCDs and UCGs;
d) allows users to search for dependencies of UCDs and UCGs on Concepts;
e) allows users to add, remove, and modify all types of Concept (if users have appropriate permissions);
f) allows users to add, remove, and modify all types of UCD except Basic UCDs;
g) pre-sets permissions so that only certain privileged users can edit unpopulated UCDs;
h) allows users to users save a UCD under a different name, and can also change any other properties they like;
i) allows users to add, remove, and modify User Concept Groups (UCGs);
j) allows users to save a UCG under a different name;
k) allows users to change a Concept Group name, description, and any other properties they like in UCGs;
l) allows users to add, remove, and modify user-defined hierarchies.

77. A method for defining and generating a set of concepts and identifying said concepts in text, comprising:
a) identifying linguistic entities in the text of documents and other text-forms;
b) annotating said identified linguistic entities in a text markup language to produce linguistically annotated documents and other text-forms;
c) storing said linguistically annotated documents and other text-forms;
d) defining Concepts that also makes use of Patterns wherein:
i) each of said Concepts comprises a Pattern;
ii) each of said Patterns comprising one of the following:
1) a Basic Pattern comprising a description sufficiently constrained to be matchable to zero or more extents;
each of said extents comprising a set of zero or more items wherein
each of said items is an instance of a linguistic entity;
each of said instances of said linguistic entity is identified in
c) text, or
b) a knowledge resource; or
c) both a) and b); and
said Basic Pattern is matchable to zero or more of said extents corresponding to said description; or
2) an Operator Pattern comprising an Operator and a list of zero or more Arguments wherein
each of said Arguments is a further Pattern; and
said Operator Pattern is matchable to extents that are the result of applying said Operator to further extents that are matchable by said Arguments; or
3) a Concept Call comprising a reference to a further Concept comprising a further Pattern; and
said Concept Call is matchable to extents that are matchable by said further Pattern; and
iii) any said further Pattern is a Pattern; and
e) generating said Concepts from text of documents and other text-forms, and other sources of knowledge;
f) managing said Concepts, both generated and non-generated;
g) identifying Concepts using linguistic information, where said Concepts occur in one of:
i) said text of documents and other text-forms in which linguistic entities have been identified in step a); or
iv) said linguistically annotated documents and other text-forms of step b); or
v) stored linguistically annotated documents and other text-forms of step c);
h) annotation of said identified Concepts in said text markup language to produce conceptually annotated documents and other text-forms;
i) storage of said conceptually annotated documents and other text-forms.

78. A system for implementing said method according to claim 77 consisting of one of:
a) a client server configuration comprising
i) a server, wherein said server comprises
1) a communications interface to one or more clients over a network or other communication connection,
2) one or more central processing units (CPUs),
3) one or more input devices,
4) one or more program and data storage areas comprising a module or submodules for a Concept processing engine, and
5) one or more output devices; and
ii) one or more clients, wherein each client comprises
1) a communications interface to a server over a network or other communication connection,
2) one or more central processing units (CPUs),
3) one or more input devices,
4) one or more program and data storage areas comprising one or more submodules for a Concept processing engine, and
5) one or more output devices; or
b) a client server farm configuration comprising
i) a front end server which
1) optionally contains modules for Concept or concept processing and may itself act in the capacity of a client when it accesses remote databases located on a database server,
2) receives queries over a network or other communication connection from one or more clients,
3) passes said queries over said network or other communication connection to the back end servers in the server farm which
4) processes said queries, and
5) sends said queries to said front end server, which sends said queries on to said clients;
ii) a server farm of one or more back end servers, where each back end server comprises
1) a communications interface to the front end server over a network or other communication connection,
2) one or more central processing units (CPUs),
3) one or more input devices,
4) one or more program and data storage areas comprising one or more submodules for a Concept processing engine, and
5) one or more output devices, and
6) receives queries from clients via the front end server over said network or other communication connection;
7) does substantially all the processing necessary to formulate responses to said queries (though said front end server may also do some Concept processing), and provides said responses to said front end server, which passes said responses on to said clients,
8) said back end server may itself act in the capacity of a client when said back end server accesses remote databases located on a database server; and
iii) one or more clients, wherein each client comprises
1) a communications interface to the front end server over a network or other communication connection,
2) one or more central processing units (CPUs),
3) one or more input devices,
4) one or more program and data storage areas comprising one or more submodules for a Concept processing engine, and
5) one or more output devices.

79. The system of claim 78 wherein the Concept processor takes as input text in documents and other text-forms in the form of a signal from one or more input devices to a user interface, and carries out predetermined processes (including, but not limited to, processes for information retrieval and information extraction) to produce
a) a collection of text in documents and other text-forms, which are output from the user interface in the form of a signal to one or more output devices, and
b) Concepts (and, possibly, UCDs, UCGs, and hierarchies of those three entities), which are stored in a Concept database.

80. The system according to claim 79 wherein predetermined processes (including, but not limited to, processes for information retrieval and information extraction), accessed by said user interface, comprise the following main processes: synonym processor, annotator, Concept generation (including the Concept wizard, example maker, and Concept generator), Concept database, Concept manager, and CSL parser.

81. The system according to claim 80 wherein said abstract user interface is a specification of instructions that is independent of different types of user interface such as command line interfaces, web browsers, and pop-up windows in Microsoft and other operating systems applications, said abstract user interface:
a) receives both input and output from the user interface, Concept manager, and Concept wizard,
b) sends output to the synonym processor, annotator, and document loader,
c) instructions received include, but are not limited to, those for the loading of text documents, the processing of synonyms, the identification of Concepts, the generation of Concepts, and the management of Concepts.

82. The system according to claim 80 wherein said synonym processor
a) takes as input a synonym resource,
b) tailors the synonyms to the domain in which the Concept processing engine operates,
c) produces outputs wherein the pruned synonym resource is used as a knowledge source,
d) produces a processed synonym resource that contains the synonyms of the input resource, tailored to the domain in which the Concept processing engine operates,
e) said pruned synonym resource is used as a knowledge source for annotation (Concept identification), Concept generation, and CSL parsing.

83. The system according to claim 80 wherein said annotator, accessed by said abstract user interface, uses said document loader which passes text documents from a document database to the annotator, and outputs one or more linguistically or conceptually annotated documents.

84. The system according to claim 83 wherein said annotator takes as input one or more text documents, outputs one or more annotated documents, and is comprised of a linguistic annotator which passes linguistically annotated documents to a conceptual annotator.

85. The system according to claim 84 wherein said linguistically annotated documents, are annotated with a representation in a Text Markup Language.

86. The system according to claim 85 wherein said Text Markup Language (TML) has the syntax of XML, and conversion to and from TML is accomplished with an XML converter.

87. The system according to claim 85 wherein said linguistic annotator, taking as input one or more text documents, and outputting one or more linguistically annotated documents, comprises one or more of the following:
a) a preprocessor;
b) a tagger; and
c) a parser.

88. The system according to claim 87 wherein said preprocessor, taking as input one or more text documents or the documents output by any other appropriate linguistic identification process, and producing as output one or more preprocessed documents, comprises means for one or more of the following:
a) breaking text into words;
b) marking phrase boundaries;
c) identifying numbers, symbols, and other punctuation;
d) expanding abbreviations; and
e) splitting apart contractions.

89. The system according to claim 87 wherein said tagger takes as input a set of tags, one or more preprocessed documents or the documents output by any other appropriate linguistic identification process and produces as output one or more documents tagged with the appropriate part of speech from a given tagset.

90. The system according to claim 87 wherein said parser takes as input one or more tagged documents or the documents output by any other appropriate linguistic identification process and produces as output one or more parsed documents.

91. The system according to claim 84 wherein said conceptual annotator takes as input one or more linguistically annotated documents, a list of CSL Concepts and Concept Rules for annotation, and optionally data from a synonym resource, and outputs one or more conceptually annotated documents.

92. The system according to claim 84 wherein said input of one or more linguistically annotated documents to said conceptual annotator comprises at least one of the following sources:
a) the linguistic annotator directly;
b) storage in some linguistically annotated form such as the representation produced by the final linguistic identification process of the linguistic annotator; and
c) storage in TML followed by conversion from TML to the representation produced by the final linguistic identification process of the linguistic annotator.

93. The system according to claim 84 wherein said conceptually annotated documents are
a) annotated with a representation in TML; or
b) stored; or
c) both a) and b).

94. The system according to claim 80 wherein said Concept generation comprise:
a) Concept wizard;
b) example maker;
c) Concept generator;
d) knowledge repositories as input including, but not limited to
i) text-based knowledge sources (text documents or text fragments);
ii) linguistic knowledge sources including vocabulary specifications; lexical relations (synonyms, hypernyms, hyponyms), syntactic categories, semantic entities (one or more tags for names of people, names of places, measures, dates; document level tags such as #subject, #from, #to, #date);
iii) CSL-based knowledge sources (Concepts, Concept Calls, Operators, Patterns, grammar specifications in terms of Concepts, imported Concepts, one or more internal database Concepts to be used for generation); and
iv) statistical knowledge sources frequencies of words (derived from text documents, text fragments, vocabulary items, and other data sources) and frequencies of tags (such as syntactic tags like noun_phrase, document structure tags from HTML, and semantic tags from XML);
e) knowledge repositories as output comprising generated Concepts.

95. The system according to claim 94 wherein said Concept wizard has the following properties:
a) provides users with instructions on entering data for the generation of a Concept, according to the knowledge sources, data model, and other generation Directives used;
b) different Concept wizards are used, depending on the UCD selected;
c) the Concept wizard receives input from the abstract user interface that includes instructions and text documents;
d) the Concept wizard receives input from the Concept generator that includes information about choices of knowledge sources and data models for generation, and Directives governing generation;
e) output from the Concept wizard is passed to the Concept generator for the creation of actual Concepts.

96. The system according to claim 95 wherein said Concept wizard interacts with a hierarchically organized graph of UCDs optionally stored in a Concept database, wherein:
a) said Concept wizard is invoked;
b) said Concept wizard calls upon the unpopulated UCDs in said UCD graph;
c) said Concept wizard displays to the user all the knowledge-source based and data-model based Concept generation options, extracted from said unpopulated UCDs;
d) said user inputs into said Concept wizard his or her choice of Concept generation by selecting a particular knowledge-source or data-model as the basis for generation;
e) the unpopulated UCD corresponding to said user's choice is accessed from the UCD graph;
f) said Concept wizard displays to the user the Concept generation options for that knowledge-source or data-model based UCD;
g) The user inputs generation choices of particular knowledge-sources and Directives;
h) The particular semi-populated UCD is then passed to the Concept generator;
i) The Concept generator generates a Concept as part of producing a populated UCD which is.
i) stored in the Concept database, and
ii) also placed in the UCD graph which is optionally stored in the Concept database.
g) The Concept wizard then displays to the user the generated Concept for that populated UCD plus optionally all of the user's Concept generation options that led to the generation of that particular Concept.

97. The system according to claim 94 wherein said example maker:
a) takes as input a Concept from the Concept generator and generates a list of words and phrases that match that Concept;
b) users can mark the words and phrases in the list as appropriate or inappropriate;
c) said marked-up list is returned to said Concept generator.

98. The system according to claim 94 wherein said Concept generator:
a) is accessed by the abstract user interface through the Concept wizard;
b) engages in two-way interaction with the example maker wherein Concepts are passed to the example maker, and lists of word and phrases generated by the example maker, marked as appropriate or inappropriate by a user, are returned to the Concept generator;
c) take as input knowledge repositories including, but not limited to
i) documents, text fragments, and other text-forms;
ii) “highlighted documents and text fragments” produced by highlighting instances of Concepts in the text of said documents, text fragments, and other text-forms, said highlighted documents and text fragments having been
1) produced on-the-fly or
2) produced earlier and stored either
a) as is, or
b) converted to TML (to produce “highlighted documents and text fragments in TML format”), stored, and converted from TML for use by the Concept generator;
iii) linguistically annotated documents and text fragments that have been
1) produced on-the-fly or
2) produced earlier and stored either
a) as is, or
b) converted to TML (to produce “linguistically annotated documents and text fragments in TML format”), stored, and converted from TML for use by the Concept generator;
iv) conceptually annotated documents and text fragments that have been
1) produced on-the-fly or
2) produced earlier and stored either
a) as is, or
b) converted to TML (to produce “conceptually annotated documents and text fragments in TML format”), stored, and converted from ML for use by the Concept generator;
v) “highlighted linguistically annotated documents and text fragments” produced by highlighting instances of Concepts in the text of said linguistically annotated documents, text fragments, and other text-forms, said highlighted linguistically annotated documents and text fragments having been
1) produced on-the-fly or
2) produced earlier and stored either
a) as is, or
b) converted to TML (to produce “highlighted linguistically annotated documents and text fragments in TML format”), stored, and converted from TML for use by the Concept generator;
vi) other text-based knowledge sources;
vii) linguistic knowledge sources including vocabulary specifications; lexical relations (synonyms, hypernyms, hyponyms), syntactic categories, semantic entities (one or more tags for names of people, names of places, measures, dates; document level tags such as #subject, #from, #to, #date);
viii) CSL-based knowledge sources (Concepts, Concept Calls, Operators, Patterns, grammar specifications in terms of Concepts, imported Concepts, one or more internal database Concepts to be used for generation); and
ix) statistical knowledge sources frequencies of words (derived from text documents, text fragments, vocabulary items, and other data sources) and frequencies of tags (such as syntactic tags like noun phrase, document structure tags from HTML, and semantic tags from XML);
x) data models;
xi) user Concept definitions (UCDs), possibly in a UCD graph;
xii) Concepts from the Concept database for use in generation;
xiii) Concepts, user Concept groups (UCGs), and user-defined hierarchies mediated through the Concept manager;
d) comprises various subtypes of Concept generator, depending on the UCD selected;
e) outputs Concepts which are sent to the Concept database via the Concept manager, and
f) outputs instructions to the Concept wizard.

99. The system according to claim 98 wherein a User Concept Description (UCD) is used to generate a Concept, specifying ways in which Concepts can be generated from different types of knowledge (knowledge sources) by way of different data models, governed by various Directives, said UCD comprising:
a) one or more knowledge sources that provide raw content used to generate Concepts,
b) one or more data models used to combine said knowledge sources used to generate Concepts, and
c) one or more Directives governing said generation of said Concepts.

100. The system according to claim 99 wherein said knowledge sources are selected from one of:
a) text-based knowledge sources;
b) linguistic knowledge sources;
c) CSL-based knowledge sources;
d) statistical knowledge sources; or
e) a combination of knowledge sources a)-d).

101. The system according to claim 99 wherein a knowledge source-based UCD is a UCD in which:
a) options about knowledge sources are presented to users before options about data models or Directives;
b) the selection of certain knowledge sources prioritizes the subsequent choices of data models and Directives presented to users (text fragments are most closely associated with the linguistic data model, documents with the statistical data model, and CSL Operators with the logical data model).

102. The system according to claim 99 wherein said data models are selected from one of:
a) linguistic data models;
b) logical data models;
c) statistical data models; or
d) a combination of data models a)-c).

103. The system according to claim 99 wherein a data model-based UCD is a UCD in which:
a) options about data models are presented to users before options about knowledge sources or Directives;
b) the selection of certain data models prioritizes the subsequent choices of knowledge sources and Directives presented to users (the linguistic data model is most closely associated with text fragments, the statistical data model with documents, and the logical data model with CSL Operators.

104. The system according to claim 99 wherein a UCD is one of three types:
a) a basic UCD is a data structure in template form that is used to define types b) and c);
b) an unpopulated UCD, which is a version of a), specifies the knowledge sources, data models, and Directives used in a knowledge-source based UCD (or one of its subtypes such as a text-based UCD) or a data-model based UCD (or one of its subtypes);
c) a populated UCD, which is a version of b) with filled-in information about particular knowledge sources, data models, and Directives used in a particular instance of knowledge-source based UCD (or one of its subtypes) or a data-model based UCD (or one of its subtypes), that is, it is “filled out” with information during the generation of an actual Concept.

105. The system according to claim 104 wherein said UCDs of three types (basic, unpopulated, populated) are organized hierarchically into a graph of UCDs wherein:
a) the top level of said graph is occupied by said basic UCD;
b) the next level is occupied by said unpopulated UCDs including, but not limited to, said knowledge-source based UCD and data-model based UCDs;
c) inherited information is optionally passed down from said basic UCD at said top level to said unpopulated UCDs at said next level;
d) the next one or more levels are occupied by further unpopulated UCDs including, but not limited to, subtypes of said knowledge-source based UCD (such as a text-based UCD) or subtypes of said data-model based UCD (such as the logical-based UCD);
e) inherited information is optionally passed down from said unpopulated UCDs at the higher level to said unpopulated UCDs at said next one or more levels, and further optionally passed within said one of more levels;
f) the next level is occupied by said populated UCDs, wherein said UCDs are populated by
i) one or more particular knowledge sources and Directives, supplied by the user, and
ii) a generated Concept, supplied by said Concept generation method,
g) said graph is optionally stored in a Concept database.

106. The system according to claim 98 wherein said types of Concept generator mirror the various types of UCD, hence there are:
a) knowledge-source based Concept generators which can be divided into, though are not limited to, text-based, linguistic-based, CSL-based, and statistical-based Concept generators; and
b) data-model based Concept generators which can be divided into linguistic, logical, and statistical Concept generators.

107. The system according to claim 80 wherein said Concept database is used to store Concepts, said database:
a) keeps an up-to-date set of CSL files;
b) keeps a record of what CSL files correspond to what UCDs and UCGs; and
c) guarantees consistency of stored UCDs and UCGs (such that said UCDs and UCGs in said database can be compiled).

108. The system according to claim 98 wherein said UCD graph contains UCDs of three types (basic, unpopulated, populated) organized hierarchically into a graph of UCDs wherein:
a) the top level of said graph is occupied by said basic UCD;
b) the next level is occupied by said unpopulated UCDs including, but not limited to, said knowledge-source based UCD and data-model based UCDs;
c) inherited information is optionally passed down from said basic UCD at said top level to said unpopulated UCDs at said next level;
d) the next one or more levels are occupied by further unpopulated UCDs including, but not limited to, subtypes of said knowledge-source based UCD (such as a text-based UCD) or subtypes of said data-model based UCD (such as the logical-based UCD);
e) inherited information is optionally passed down from said unpopulated UCDs at the higher level to said unpopulated UCDs at said next one or more levels, and further optionally passed within said one of more levels;
f) the next level is occupied by said populated UCDs, wherein said UCDs are populated by
i) one or more particular knowledge sources and Directives, supplied by the user, and
ii) a generated Concept, supplied by said Concept generation method,
g) said graph is optionally stored in a Concept database.

109. The system according to claim 80 wherein said Concept manager comprises a Concept database administrator and a Concept editor.

110. The system according to claim 109 wherein said Concept database administrator
a) is responsible for loading, storing, and managing uncompiled and compiled Concepts, UCDs and UCGs in the Concept database;
b) is responsible for loading, storing, and managing compiled Concepts ready for annotation and for generation;
c) is responsible for managing a UCD graph;
d) allows users to view relationships among Concepts, UCDs, and UCGs in the Concept database;
e) allows users to search for Concepts, UCDs, and UCGs;
f) allows users to search for the presence of Concepts in UCDs and UCGs;
g) allows users to search for dependencies of UCDs and UCGs on Concepts;
h) makes sure the Concept database always contains a set of Concepts, UCDs, and UCG that are logically consistent and consistent such that said sets in can be compiled;
i) keeps CSL files up to date with the changing definitions of Concepts, UCDs, and UCGs;
j) checks the integrity of Concepts, UCDs, and UCGs (such that if A depends on B, then B can not be deleted);
k) handles dependencies within and between Concepts, UCDs, and UCGs;
l) allows functions performed by Concept editor to add, remove, and modify Concepts, UCDs, and UCGs in the Database without fear of breaking other Concepts, UCDs, or UCGs in the same database.

111. The system according to claim 109 wherein said Concept editor
a) allows users to view relationships among Concepts, UCDs, and UCGs in the Concept database;
b) allows users to search for Concepts, UCDs, and UCGs;
c) allows users to search for the presence of Concepts in UCDs and UCGs;
d) allows users to search for dependencies of UCDs and UCGs on Concepts;
e) allows users to add, remove, and modify all types of Concept (if users have appropriate permissions);
f) allows users to add, remove, and modify all types of UCD except Basic UCDs,
g) pre-sets permissions so that only certain privileged users can edit unpopulated UCDs;
h) allows users to users save a UCD under a different name, and can also change any other properties they like;
i) allows users to add, remove, and modify User Concept Groups (UCGs);
j) allows users to save a UCG under a different name;
k) allows users to change a Concept Group name, description, and any other properties they like in UCGs;
l) allows users to add, remove, and modify user-defined hierarchies.

112. The system according to claim 80 wherein said CSL parser
a) takes as input a synonym database, CSL query, and CSL Concepts and Patterns;
b) engages in;
i) word compilation;
ii) Concept compilation;
iii) downward synonym propagation; and
iv) upward synonym propagation; and
c) outputs CSL Concepts and Patterns for annotation.
